(19) United States
(12) Patent Application Publication
(10) Pub. No.: US 2002/0040475 A1
(43) Pub. Date: Apr. 4, 2002

(54) DVR system

(76) Inventors: Adrian Yap, Gaithersburg, MD (US); Michael Ficco, Silver Spring, MD (US); Robert Davis, Woodbine, MD (US); Paul Gaske, Rockville, MD (US); Walter R. Kepley, Gaithersburg, MD (US); Scott Casavant, Germantown, MD (US); Kuriacose Joseph, Gaithersburg, MD (US)

Correspondence Address: Hughes Electronics Corporation, Patent Docket Administration, P.O. Box 956, Bldg. 1, Mail Stop A109, El Segundo, CA, 90245-0956, US

(21) Appl. No.: 09/836,378

(22) Filed: Apr. 17, 2001

Related U.S. Application Data
(63) Continuation-in-part of application No. 09/766,252, filed on Jan. 19, 2001.
Application No. 09/766,252 is a continuation-in-part of application No. 09/533,843, filed on Mar. 23, 2000.
(60) Provisional application No. 60/199,438, filed on Apr. 25, 2000.

(51) Int. Cl. G06F 3/00; H04N 5/445

(52) U.S. Cl. 725/39

(57) ABSTRACT

A digital video recorder (DVR) and method of recording including a tuner for receiving available content, a memory for storing selectable status parameters indicating functionality of the digital video recorder, a telephone answering device for receiving voice signals and caller ID signals representing a telephone message from a caller and converting the voice signals and caller ID signals into digital signals, and a processor, which performs operations on the available content from the tuner, which directs storage of the digital signals to a storage device and controls playback of the storage signals of the telephone message to be output at a display device and controls a display of a plurality of status parameters based on received commands to access a memory so as to display one or more of the plurality of status parameters. The DVR of the present invention may include one or more tuners and one or more processors. The DVR method and apparatus also performs a wide variety of functions, which enhance the viewing ability of a user.

### CROSS REFERENCE TO A RELATED APPLICATION

This application is a continuation-in-part and claims benefit under 35 U.S.C. §120 of U.S. Non-Provisional application of Doug Dillon, et al entitled “Personal Video On-Demand System and Method”, Ser. No. 09/766,252, filed on, Jan. 19, 2001, which is a continuation-in-Part and claims benefit under 35 U.S.C. §120 of U.S. Non-Provisional application of Michael Ficco et al entitled “Personal Video On-Demand System and Method”, Ser. No. 09/533,843 filed on Mar. 23, 2000, the entire contents of both are incorporated by reference herein. This application also claims benefit under 35 U.S.C. §119(e) of U.S. Provisional application of Adrian Yap, et al entitled “Digital Video Recorder”, Ser. No.: 60/199,438 filed on Apr. 25, 2000, the entire contents of which is incorporated by reference herein.

### BACKGROUND OF THE INVENTION

1. Field of the Invention

The present invention generally relates to audio and video devices. The present invention more specifically relates to the field of video-on-demand equipment and services.

2. Background of the Prior Art

Providing video-on-demand has been a elusive goal sought after by a variety of companies. Many of the efforts to date have been stymied by the enormous bandwidth consumed when a large number of movies or other content are requested by individuals. This problem is exacerbated when an insufficient number of consumers request a particular movie such that it is not economically justified to consume the available bandwidth for such a small number of requests. In order to be profitable, conventional video-on-demand services offer only the most popular movies. The result is that the most attractive feature of video-on-demand is destroyed. This most attractive feature is the availability of a wide variety of movies or other content on demand of a consumer.

Conventional communications systems may include a receiver for receiving and processing transmitted waveforms. For example, in a satellite communications system, the receiver may include a small satellite dish connected by a cable to a set-top box (STB) or an integrated receiver-decoder (IRD), which are used as interchangeable terms in the art. The satellite dish is aimed toward the satellites, and the STB is connected to the user's television in a similar fashion to a conventional cable-IV decoder.

A micro-controller controls the overall operation of the STB, including the selection of parameters, the set-up and control of components, channel selection, viewer access to different programming packages, blocking certain channels, and many other functions. The compression and decompression of packetized video signals may be accomplished according to the Motion Picture Expert Group (MPEG) standards and the compression and decompression of audio signals may be accomplished according to the Motion Picture Expert Group (MPEG) standards, DOLBY DIGITAL (or AC-3) standards, DTS or other known standards. The conventional STB also typically includes video and audio decoders in order to decompress the received compressed video and audio. The STB may output video and audio data to a number of destinations, including audio and video decoders, ports, memories, and interface devices, such as a digital VHS (DVHS) interface. The STB may send the same audio and video data to different destinations.

More recently, due to the advances in digital technology and with a goal of creating greater personalized television for viewers, the STB has become embodied as part of a digital VCR (DVCR) and/or digital VHS (DVHS) receiver for example, in the continuing development of digital video recording devices used within the wireless television system described above. These devices incorporate a host of both traditional and powerful new features. For example, these features may include high quality digital A/V, the ability to pause/rewind live video and/or audio programs as they are broadcast, multi-speed fast forward and fast rewind, instant replay, slow motion and frame by frame advance. Additionally, the viewer may have access to, and have the ability to manipulate or develop an electronic program guide of listings.

Such digital video recording devices allow sports fans and movie buffs alike to have full control of live television programs and sporting events in full digital-quality. Viewers may also be able to create customized programming by searching for, and recording, programs that match their preferences by actor, director, keyword or any combination of content searches. Combined with the wide variety of program selections, viewers may find exactly what they are looking for and even create their own “TV channels” based on their favorite programming.

The electronic program guides generally are displayed as a menu on a screen of a TV for example. Operation of push buttons or keys of a remote control may display a series of menu screens having an array of cells corresponding to particular programming events, channels, TV programs, etc. The viewer may scroll through the cells to choose a particular program, pull up another sub menu to find out more information on a particular program, or pull up a sub menu with additional options.

These functions are controlled by a single processor or micro-controller, such as a CPU of a computer that is connected to a TV, DVCR or DVHS, or by a single microprocessor or micro-controller embedded within the DVCR or DVHS. However, the costs of modern microprocessors are now falling due in part by fast-moving advances in micro-technologies. Accordingly, it is fast becoming feasible to dedicate individual processors for specific tasks within a mass-marketed consumer product. In particular, a variety of functions performed by a digital STB might be well suited to distribution amongst a plurality of task-specific processors.

Further, none of these recent digital video recording devices provide the ability to monitor the status or condition of certain internal system parameters or functions, such as the status of storage capacity in the digital video recording device, recording time available or remaining, or whether a program being viewed is live or recorded, for example. Accordingly, there is a need for a status display that a user or viewer may access, and/or for visual status indicators that are automatically, or by user direction, are displayed on a display device to allow the viewer to monitor or check the status of certain operational parameters of the digital video recording device.

Still further, most everyone is acquainted with the conventional telephone answering device (TAD). Typically the device is hooked up to a telephone and by means of a magnetic recording medium, records oral messages received from a caller after sending an outgoing message beforehand. However, the conventional TAD is limited as to its storage capacity and is cumbersome to the user when retrieving messages, since often the user must listen to all messages stored thereon and then copy the messages down to obtain a hard copy.

In an effort to overcome some of these problems, digital telephone answering devices (DTAD) have been developed which provide much greater functionality and flexibility to the user than the conventional magnetic tape recording TADs. For example, voice mail DTADs such as that disclosed in U.S. Pat. No. 5,400,393 to Knuth et al. dynamically allocates RAM to store incoming and outgoing messages in particular “mailboxes”, converting analog voice received over a telephone line into digital form.

U.S. Pat. No. 5,343,516 to Callele et al. describe interfaces that can be used to connect a computer to a telecommunications system in order to perform functions that typically might be performed by a DTAD (caller-ID, repeat dial, automatic call back, etc.). Callele et al. also describe the ability to display caller-ID information on a TV screen for example.

U.S. Pat. No. 5,917,892 to Lee describes a recorded telephone message/number identifying apparatus that uses a TV screen in order to display the time at which a caller called with caller-ID (phone number only), and whether or not a voice message was saved. The user may then select a desired recording to hear, the voice message being played back on the TV speaker for example. And U.S. Pat. No. 5,917,892 to Lagoni et al. describe a television receiver that includes telephone network interface circuitry enabling the receiver to receive and process caller-ID signals for display, with messages from priority callers designated to interrupt a viewer's broadcast being displayed at the discretion of the viewer

Although digital video recording devices and the DTADs described above are known, the combination of these known arts have never been embodied in a digital telephone answering device (DTAD) that is operatively connected to or integral with a set top box (STB) equipped with a digital video recorder (DVR). Accordingly, there is a need for a DTAD that can take advantage of the unlimited storage capacity and plurality of menu driven functions offered by the DVR, providing a TAD with more functionality and flexibility than what is currently available.

Various other problems exist in conventional video-on-demand services including inconvenient and limited ways in which to designate desired content.

Another shortcoming of conventional video-on-demand services is the inability to aggregate a video library in a fast and efficient manner. Another shortcoming of conventional video-on-demand services is the negative impact of aggregating a video library on the normal viewing habits of the consumer.

Another shortcoming of conventional video-on-demand services is a limitation on the number of signals which may be recorded, viewed, and/or played back at any time. Other problems include the inability to manipulate the recorded, viewed and/or played back signal(s) in a manner desired by the user.

### SUMMARY OF THE INVENTION

An object of the present invention is to remedy the above-noted deficiencies in conventional video-on-demand services and equipment. Another object is to enable video-on-demand equipment with a capacity large enough to accommodate potentially desired content. Yet another object of the invention is to provide an expandable storage device that can be easily added to by a consumer thereby increasing the capacity for the personal video library. Another object of the invention is to provide simultaneous recording, play back, and viewing of multiple signals. Yet another object is to provide a set of functions to enable the user to manipulate the signals input thereto.

One aspect of achieving the above object is to utilize an array of hard disk drives to create a video server farm. Such a video server farm provides the enormous capacity necessary for an adequate content library while also providing an expandable storage space.

The invention creates a new paradigm for video-on-demand services in which a video server farm is utilized in combination with an electronic program guide and associated receiver, tuner, control unit, and user interface that enables a consumer to create his own, personal video-on-demand library.

More specifically, the present invention includes a content feed that provides a variety of content or broadcast television programs from numerous transmission media to, for example, a set-top box or other apparatus. The invention includes a receiver/tuner that receives the content stream from the content feed and routes the content stream to a display unit, a decoder/decrypter or to a storage device in response to a control signal from a control unit. In this way, the content stream may be directly viewed as in a conventional cable box or decoded/decrypted before being viewed by a display unit. Another route provided by the invention is to a storage device so that selected content may be recorded.

To aid in the selection of desired content, an electronic program guide is utilized. This electronic program guide receives programming information for available content that will be broadcast to the inventive apparatus in the future. With a user interface device, the user can interact with the electronic program guide and select the desired programs that will be recorded on the storage device. Enhanced functionality for the electronic program guide includes the ability to track previously selected content so that identical or similar programs can be recorded in the future. Other enhancements include inputting selection criteria such as actor, director, theme, keywords, channel information, station call letters, etc. which can be utilized by the control unit to search the electronic program guide for content matching the consumer's criteria.

Preferably, the storage device is expandable and/or removable such that the user can easily add and/or remove additional storage capacity as desired or needed. For example, the storage device may include magnetic tape, magnetic or optical disk (for example, a read/write disk or a write once/read many disk), CD, DVD, of a portable digital audio/video/data player.

Further enhancements to the present invention include the ability to transcode from one medium type to another to ensure efficient storage, regardless of the target medium. Transcoding may include using different compression techniques or different sets of compression parameters for the same compression technique.

Further enhancements to the present invention include a file manager for the creation and management of a database, which includes an entry for each program recorded. The file manager further supports other database manipulation operations, such as adding, deleting, searching, etc. The file manager also enables the user to print a physical label that may be attached to storage media. The file manager also permits annotation of the database entry for each program recorded. The information contained in these annotations may be supplied electronically, such as via an electronic program guide or may be manually generated by a user.

Further enhancements to the present invention include the use of internal and external memory in combination. This enables the present invention to record program information to internal memory and then to external memory or to stream program information directly to external memory. The combination of internal and external also permits recording from removable memory into internal memory and then ultimate playback from the internal memory.

Further enhancements to the present invention include a multiple receiver/tuner embodiment in which multiple content streams can be received, tuned and provided to the storage device. With a plurality of receiver/tuners, this modification has the ability to simultaneously record a plurality of programs on a storage device. A multiple display unit such as a picture-in-picture television can be utilized to simultaneously view the two programs being recorded. Alternatively, one program can be recorded while another is being viewed either from a live broadcast or from the previously recorded video library in the storage unit.

Further enhancements to the present invention include several modes, including, but not limited to recording two or more signals where one or both may also be simultaneously viewed, recording one or more signals and playing back one or more signals, playing back two or more signals, watching one or more signals, while recording one or more other signals, viewing two or more live signals (through the use of picture-in-picture or other similar function), and viewing at least one signal live, while viewing one or more signals in playback mode.

Further enhancements to the present invention include various functions, which enable the user to manipulate the recorded, viewed, and/or played back signals in a manner desired by the user. These functions include but are not limited to an intelligent agent function, by which the user may select at least one recorded event from a program guide or schedule, based on actors, actresses, directors, or other relevant information, a duplicate episode filter function, which alerts a user if a duplicate episode is being recorded, a status indicator function, which displays the status of the program the user is watching, a clear convert function, which offers the user the opportunity to clear paused live cached programming or convert paused programming to recorded programming during a channel change, a record after watching feature which allows a user to record an entire program after viewing the program for a period of time, an active snapshot feature, which permits the user to capture snippets of digital audio/video broadcasts, a personal instant replay feature, which permits a user to rewind recording in fixed increments for playback, and a back to pause feature, which enables the user to jump back from a live broadcast to the last paused video segment.

It is noted that the various functions described above may be utilized in conjunction with one or more of the modes. For example, the intelligent agent duplicate filter, and active snapshot functions may be used with any recording mode, the status indicator and personal instant replay features may be utilized with any playback mode, and the status indicator, clear convert, record after watching, and personal instant replay functions may be utilized in any live viewing mode. The back to pause function may be utilized to jump between any two or more live or playback signals.

The invention also includes a method of determining potentially desired content which includes manually inputting content selection(s) and selection criteria. As mentioned above, the selection criteria may include a variety of criteria such as actor, program name, director, keywords, channel information, station call letters, etc. Such selection criteria may be utilized in conjunction with tagged content in which the content stream is tagged with additional information associated with the content. For example, a typical tag may include which actors star in the program, the director, a synopsis, keywords, a thumbnail, a preview, a snippet, etc. The tags may be in-band or otherwise transmitted along with the content or associated with the program and sent separately such as with an electronic program guide. In any of these alternatives, the selection criteria may be utilized to search through these tags for potentially desired content.

Furthermore, the methods of the invention track previously selected content and previously utilized selection criteria in order to learn the consumers preferences. This tracked information is then added to the selection of potentially desired content so that the appropriate content may be recorded by the inventive apparatus.

The method of operating the inventive apparatus may also include downloading the electronic program guide on a periodic basis. Selections and criteria may then be inputted. The electronic program guide is then scanned for content matching the selections and/or input criteria. If a match is found, then a broadcast channel is tuned and the content output to the storage device. Appropriate changes are made to a file manager to keep track of the recorded content. Thereafter, the consumer can manage the recorded content by, for example, deleting, sorting, cataloging, commenting, etc.

On the content provider side, the electronic program guide may be compiled and uploaded to the user. Because different regions of the country have different available channels, the program listings may be winnowed to only those available to the particular consumer. Tags can then be generated that describe or otherwise indicate the program content and these tags are associated with the program listings.

The inventive methods also include simultaneous recording of multiple content streams. After scanning the electronic program for content matching the consumer's preferences, the invention determines whether there are scheduling conflicts. Such scheduling conflicts are resolved by multiple, simultaneous recording of plural content streams.

The present invention is also directed to a digital set top box (STB) having multiple processors that handle both real time and non-real time functions within the STB. In an embodiment, one of the processors performs substantially all of the real time operations, such as control of a data pipeline to the STB, conditional access, and control of a program guide stored within the STB. The other processor controls substantially all non-real time functions that are executed within the STB, such as presentation of a graphical user interface (GUI), browser functions, and general interaction with a user of the STB. In an embodiment, the STB is equipped with or embodied as a digital video recorder (DVR) having multiple processors therein.

The additional processor(s) provide for increased overall system bandwidth, improved system security and greater system stability for an STB and/or DVR configured with these multiple processors, as compared to conventional STB having a single micro-controller or processor. Additionally, the quality of the architecture and/or modularity of a multi-processor STB or DVR are improved over its single-processor brethren.

The present invention is also directed to a apparatus and method for displaying the status of a recording device such as a set top box (STB) equipped with a digital video recorder (DVR). The apparatus includes a memory that stores status parameters indicating functionality of the STB-equipped with DVR, and a processor for controlling the display of these status parameters based on receiving user commands to access the memory and display at least a selected one of the status parameters for review and/or manipulation by the viewer on a display device operatively connected to the STB-equipped with DVR. A suitable interface such as a remote control may be used in order to transmit a command to display desired status parameter(s).

Status parameters or features related to the operation of the STB-equipped with DVR that may be displayed include the time that a recording of a live feed is behind a live feed when the STB-equipped with DVR is in a pause mode, whether a program being viewed is live or recorded, available storage capacity for recording and or remaining available record time, visual or audiovisual alerts indicating various levels of storage available for recording, and other file attributes associated with the functionality and operation of the STB-equipped with DVR.

The present invention is also directed to a digital telephone answering device that utilizes the functionality of a device such as a set top box (STB) equipped with a digital video recorder (DVR). The system includes a DTAD operatively connected to or integral with an STB equipped with DVR. A memory within the DVR is used by the DTAD and for storing a plurality of parameters and data typically associated with the DTAD; and a microprocessor within the DVR controls DTAD functionality and display of parameters associated with the DTAD. Control is based on receiving user commands to access the memory and to display at least a selected one of the DTAD associated parameters for review and/or manipulation by the viewer on a display device operatively connected to the STB-equipped with DVR. A suitable interface such as a remote control may be used in order to transmit a command to display desired DTAD parameter(s) or associated data.

Parameters, features, functions and displays related to the operation of the integrated STB-equipped with DVR and DTAD (hereafter DTAD is referred to as “DVR TAD”) include, but are not limited to: a listing of messages received which include a menu display providing the identity of the caller, and a short adjacent text synopsis of the corresponding stored voice message; a “catalog” or “phone book” of stored caller information, which may include name, phone number and other identifying criteria that may be entered by the user; menu features that enable the user to choose between a text display or voice playback of a recorded message; automatic call back features; menu features enabling the user to send a stored voice and/or text message to another person via a medium such as the internet (i.e., transmitting an e-mail message with text file or sound file attached thereto, and other attributes associated with the functionality and operation of the DVR TAD.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a block diagram of a personalized video-on-demand system according to a first aspect of the invention;

FIG. 2 is a block diagram of a personalized video-on-demand system according to a second aspect of the invention;

FIG. 3 is a high-level flow chart of the inventive method of determining potentially desired content;

FIG. 4 is a high-level flow chart of a method of creating a video-on-demand service;

FIG. 5 is a high-level flow chart of a method of generating an electronic program guide according to the invention; and

FIG. 6 is a block diagram of an exemplary architecture in accordance with the present invention;

FIG. 7 is a block diagram showing an exemplary construction of a memory device according to an exemplary embodiment of the present invention;

FIG. 8 is a flow diagram showing data flow for recording or caching programs such as pay-per-view (PPV) events for later playback in accordance with an exemplary embodiment of the present invention;

FIG. 9 illustrates an alternative recording path in accordance with the present invention;

FIG. 10 is a high-level flow chart of a method of creating a personalized video-on-demand service capable of simultaneous, multiple recording of plural content streams.

FIG. 11 is an exemplary arrangement of a set-top box (STB) within a direct broadcast satellite or digital video broadcast system in accordance with the invention;

FIG. 12 illustrates a general data flow in a direct broadcast satellite or digital video broadcast system in accordance with the invention;

FIG. 13 is a flow chart illustrating the functions of a transport processor and host processor of the DVR for live broadcast modes of operation;

FIG. 14 is a flow diagram showing data flow for recording programs, broadcasts or events for later playback in accordance with an exemplary embodiment of the invention; and

FIG. 15 illustrates an alternative recording path in accordance with the invention.

FIG. 16 illustrates a partial block diagram of FIG. 6 to show an exemplary communication path between a remote and the host processor of the STB-equipped with DVR;

FIG. 17 illustrates the data flow to display a status parameter of the STB-equipped with DVR in accordance with the present invention;

FIG. 18 illustrates an exemplary status menu screen according to the invention;

FIGS. 19(a) through 19(c) illustrate several exemplary graphical objects that may represent the current delay status parameter of the invention;

FIGS. 20(a) and 20(b) illustrate exemplary graphical objects that may represent the live/recorded status indicator parameter of the present invention;

FIGS. 21(a) through 21(e) illustrate several exemplary graphical objects that may represent the disk gas gauge parameter of the invention;

FIGS. 22(a) through 22(c) illustrate several exemplary graphical objects that may represent the out-of-disk alert status parameter of the invention;

FIGS. 23(a) through 23(c) illustrate exemplary text messages of a status parameter related to program length versus recording time available;

FIG. 24 illustrates an exemplary status sub-menu screen related to certain file attributes according to the invention;

FIGS. 25(a) through 25(c) illustrate the information that may be displayed upon selection of cell 541 in FIG. 24;

FIGS. 26(a) through 26(c) illustrate the information that may be displayed upon selection of cell 542 in FIG. 24;

FIGS. 27(a) through 27(c) illustrate the information that may be displayed upon selection of cell 543 in FIG. 24;

FIGS. 28(a) through 28(c) illustrate the information that may be displayed upon selection of cell 544 in FIG. 24;

FIGS. 29(a) through 29(c) illustrate the information that may be displayed upon selection of cell 545 in FIG. 24;

FIGS. 30(a) through 30(c) illustrate the information that may be displayed upon selection of cell 546 in FIG. 24;

FIGS. 31(a)-(c) illustrate the information that may be displayed upon selection of cell 547 in FIG. 24; and

FIGS. 32(a) to 32(c) illustrates how a user in accordance with the invention may display a list of hidden files for selection.

FIG. 33 is an exemplary arrangement of a set-top box (STB) and DVR TAD within a direct broadcast satellite or digital video broadcast system in accordance with the invention;

FIG. 34 is a block diagram of an exemplary architecture of the STB-equipped with DVR and DVR TAD;

FIG. 35 is a block diagram showing an exemplary construction of the graphics accelerator according to the invention;

FIG. 36 illustrates a partial block diagram of FIG. 34 to show the components associated with the DVR TAD portion of the STB equipped with DVR;

FIG. 37 is a flow diagram showing data flow for recording a program, broadcast or event for later playback in accordance with an exemplary embodiment of the invention;

FIGS. 38A and 38B illustrate exemplary answer and record modes for the DVR TAD in accordance with the invention;

FIG. 39 illustrates a general playback flow diagram for a stored voice message in accordance with an exemplary embodiment of the invention;

FIG. 40 illustrates a partial block diagram of FIG. 34 to show an exemplary communication path between a remote control and the host processor of the DVR TAD;

FIG. 41 illustrates the data flow to display a parameter or data of the TAD using the DVR TAD circuitry;

FIG. 42 illustrates an exemplary DVR TAD main menu screen according to the invention;

FIG. 43 illustrates a submenu associated with message management, including auto callback and external transmission of messages in accordance with the invention.

FIG. 44 illustrates a submenu associated with a displayed directory, including entering caller information and accessing stored caller data;

FIG. 45 illustrates how to send caller information in text and/or sound file format to a remote destination;

FIG. 46 illustrates a submenu of an exemplary private box arrangement requiring password entry; and

FIG. 47 illustrates an alternate embodiment of a DVR TAD connected to an external mass storage device and the host processor of the STB equipped with DVR in accordance with the invention.

### DETAILED DESCRIPTION OF PREFERRED EMBODIMENTS

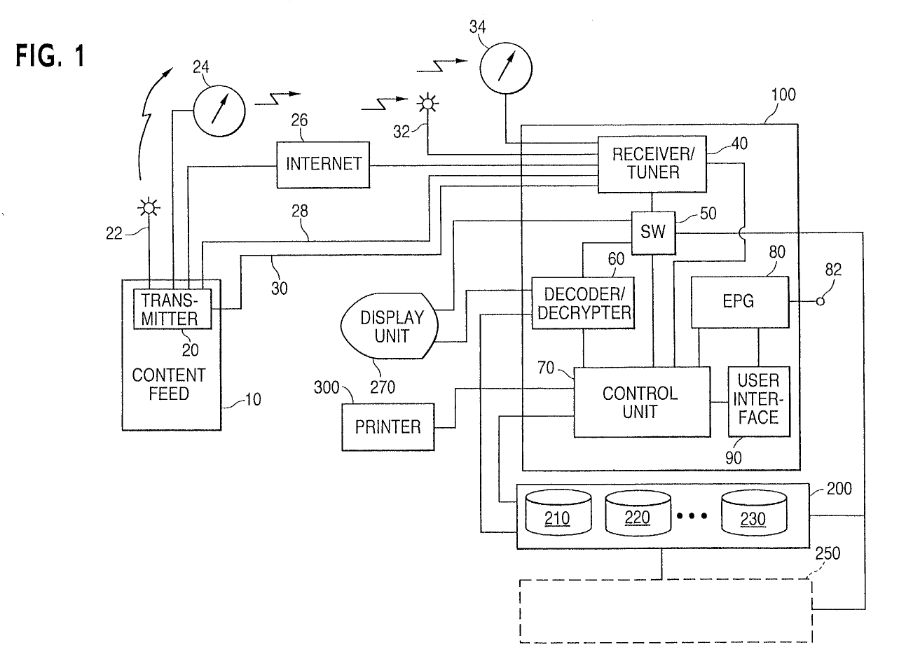

As shown in FIG. 1, the personalized video-on-demand system includes a content feed 10. This content feed 10 may include a broadcast television network or internet content provider. The content feed is compatible with all cable, satellite and terrestrial broadcast television systems as indicated by transmitter 20 that is connected to a broadcast antenna 22, satellite up-link 24, internet connection 26, cable 28, and phone line 30. These various connections and standards are exemplary only and are intended to include any system for feeding content to a consumer.

On the consumer side, an apparatus 100 such as a set-top box, hardware card, specially programmed computer or other device having the functionality described herein is provided that may be placed near to or within a television or other display device (such as a computer monitor) such as display unit 270. The apparatus 100 inputs content from devices such as satellite down-link 34, antenna 32, internet connection 26, cable 28, and/or phone line 30. It is to be understood that the apparatus 100 may include just a single communication path including 26, 28, 30, 32, or 34.

The received content is fed to receiver/tuner 40. The receiver/tuner 40 provides an appropriate connection to the corresponding communication path. The receiver/tuner 40 may also select or tune a channel within the spectrum of content being fed to the apparatus 100. If there is only one channel, then the receiver unit 40 need not include a tuner circuit.

A switch 50 is connected to the receiver/tuner 40 and routes the content to display unit 270, decoder/decrypter 60, or storage device 200. The switch 50 is controlled by control unit 70 to route the content to the desired destination. For example, switch 50 may decode, decrypt, output to display unit 270, and/or record to a storage device and is not limited to performing only a single function at a given time.

The decoder/decrypter 60 includes decoder circuitry and/or decryption circuitry. For example, many video broadcasts are encoded and the decoder 60 decodes this encoded content stream so that it may be viewed by the consumer on display unit 270. Conventional decoding processes such as MPEG1 and MPEG2 are examples of such decoding processes.

The component 60 may also include decryption circuitry that decrypts an encrypted content from the content feed. Some broadcasts, particularly pay-per-view broadcasts or premium channels such as HBO® and Showtime® are encrypted so that non-subscribers cannot view the content. The decrypter 60 decrypts any such encrypted content for viewing on the display unit 270 by the consumer. The decrypter may include a variety of decryption schemes for corresponding premium channels or services. As with conventional cable boxes, the decryption circuitry may be enabled or disabled depending upon the consumer's subscription to the premium channel or associated encrypted content. Authorization for decryption may be governed by appropriate payment for the associated content. For example, pay-per-view content is typically encrypted with decryption authorization governed by an appropriate payment by the consumer.

As a further alternative, the decrypted content may be stored for later purchase and playback. In this alternative, the consumer need not pay in advance or contemporaneous with the live broadcast and can, instead, store the encrypted content for later playback. Such delayed playback may also include an associated payment if required by the content provider by utilizing the user interface 90 and communication channel(s) with content feed 10 or by having the consumer contact the content provider using other communication channels and payment mechanisms.

The component 60 may also implement an encryption scheme separate from and/or in addition to the encryption scheme utilized by the content feed 10. In other words, encrypted content supplied from content feed may be further encrypted to further protect unauthorized access to the content.

The electronic program guide (EPG) 80 is connected to an input port 82 so that updates to the electronic program guide may be downloaded. In other words, the electronic program guide stores available content for the near future. This available content may be updated on a periodic basis so that the consumer can make appropriate selection for upcoming programs. The electronic program guide 80 preferably displays information on the display unit 270. For example, the electronic program guide 80 may display programs in a tabular format by channel and time so that the user can make selections of desired content. Other examples and functionality of the electronic program guide 80 are described below.

The user interface 90 may include various control devices such as a keypad connected directly to the apparatus 100 or a remote control device. The user interface 90 permits the user to interact with the apparatus 100 and electronic program guide 80 and thereby select content for recording and on-demand playback.

The storage device 200 is connected to the switch 50 as well as the control unit 70 and the decoder/decrypter 60. The storage device 200 may also be directly connected to the display unit 270. The storage device 200 may include a plurality of hard disk drives 210, 220, 230 as shown in FIG. 1. Also, the storage device 200 may include only one hard disk drive although the storage capacity would be necessarily limited by the capacity of the single hard disk drive 210.

Preferably, the storage device may be expanded by plugging in additional hard disk drives such as hard disk drive 220 as well as hard disk drive 230. Preferably, adding storage capacity could be easily accomplished by the user by simply plugging in a storage device such as a hard disc drive. The collection of hard disk drives 210, 220 . . . 230 may also be considered a hard disk drive array. Such an array may use conventional data loss prevention methods such as error correcting codes, and Redundant Array of Independent Discs (RAID) methodologies.

The storage device 200 may be further expanded by adding an optional array of hard disk drives 250 as shown by the dotted lines in FIG. 1. The storage devices 200, 250 may be provided in a separate unit from apparatus 100.

Alternatively, the storage device 200 may include other types of storage devices. For example, the storage device may include solid state memory devices such as chips, cards, or sticks. The storage device may also include magnetic tape, magnetic or optical disk (for example, a read/write disk or a write once/read many disk), CD, DVD, a portable digital audio/video/data player, a jukebox, or any other known or not yet invented form of storage.

The storage device further may be reconfigurable, including, as examples, expandable, addable, removable, and/or replaceable. The storage device may be manually reconfigurable or automatically reconfigurable. For example, a user may replace all or part of the storage device. Alternatively, the storage device may be configured as a “juke-box” including a plurality of memory devices 210, 220, 230 (either of the same or different types), which are automatically loaded for recording or playback, possibly based on a user initiated request. The memory devices 210, 200, 230 may be integrated with the storage device 200 and/or the apparatus 100 or accessible via a network (either local or wide-area) utilizing a transfer protocol (for example, the 1394 protocol) or a combination of integrated and removable memory. Preferably, the memory devices 210, 220, 230 may be plugged in or otherwise expanded with a modular design. This modular design is indicated in FIG. 1 by the plurality of storage devices 210, 220, 230 as well as the additional array of storage devices 250. Such a modular design permits a user to easily increase the storage capacity and thereby the size of the video-on-demand library.

The control unit is connected to the storage devices 200, 250, the decoder/decrypter 60, the switch 50, the receiving device 40, the electronic program guide 80, as well as the user interface 90.

In general, the control unit 70 coordinates all of the operations performed by the apparatus 100 by sending appropriate control signals to each of the various components. For example, when the electronic program guide indicates that the desired content will appear on channel 7 at 8:00 pm, the control unit 70 sends a control signal to receiver/tuner 40 to tune channel 7 at 8:00 pm, then control unit 70 sends a control signal to control switch 50 to switch the tuned content and output the tuned content to the storage device 200. The control unit 70 also controls the recording of this content on the storage device 200. For example, the control unit 70 may synchronize the sending/receiving of data between the storage device 200 and the control unit 70, in order to avoid periods of inaccessibility. For example, if one of the memory devices 210, 220, 230 is being removed or otherwise not available, the control unit 70 controls via synchronization, recording and/or playback, such that during the period of inaccessibility, the memory device 210, 220, 230 is not accessed. The control unit 70 may accomplish synchronization by sending a sync pulse to a storage device 200 and/or memory devices 210, 220, 230, in order to coordinate the availability of the memory devices 210, 220, and 230, with the operation desired by the control unit 70. Any necessary decoding or decryption is controlled by control unit 70 which sends commands to the decoder/decrypter the output of which is sent to display unit 270. The control unit 70 may also be utilized to control the rate at which information is recorded or played back. For example, the control unit 70 may record on a first medium, for example an internal medium, in real time, and then stream the information to a removable medium, either faster or slower than real time, depending on the capabilities of the removable medium. Similarly, the control unit 70 may permit the playback of information from either an internal or external memory, either faster or slower than real time, and subsequently output the data for playback in real time. The control unit 70 may utilize one or more medium to vary the rate at which content is either played back or recorded by utilizing at least one medium as a buffer.

The control unit 70 also coordinates the operations between the user interface 90 and the electronic program guide 80. For example, the on-demand playback of previously recorded content may be controlled with the user interface 90 by having the consumer input a command. This command is input by the control unit 70. For example, a play previously-recorded content command may be input by user interface 90. This command is sent to control unit 70 which activates the storage device 200 to read the corresponding content from the storage device 200. Any necessary decoding is then performed by decoder 60 under the control of control unit 70 the results of which are output to display unit 270.

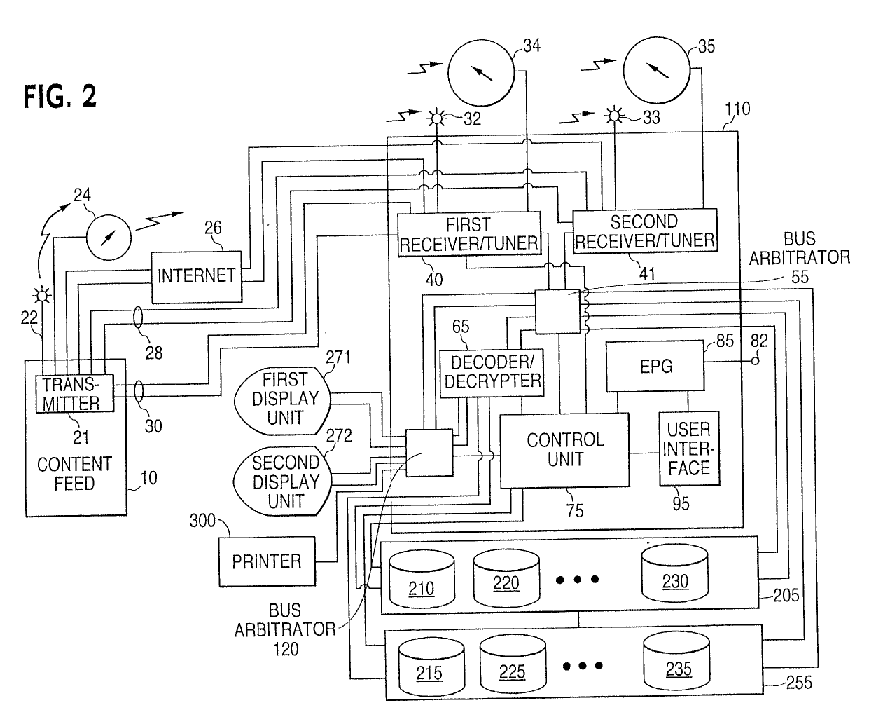

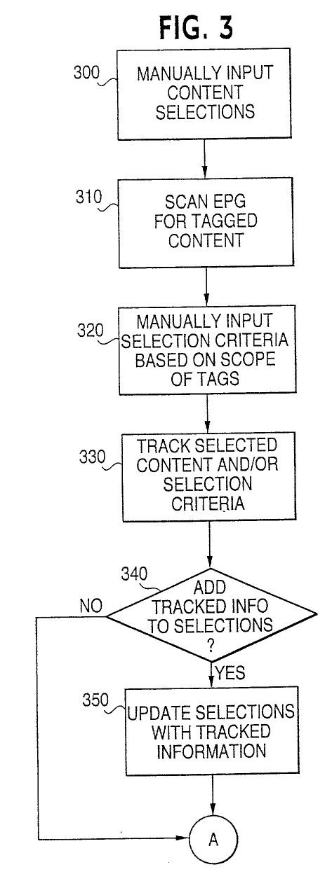

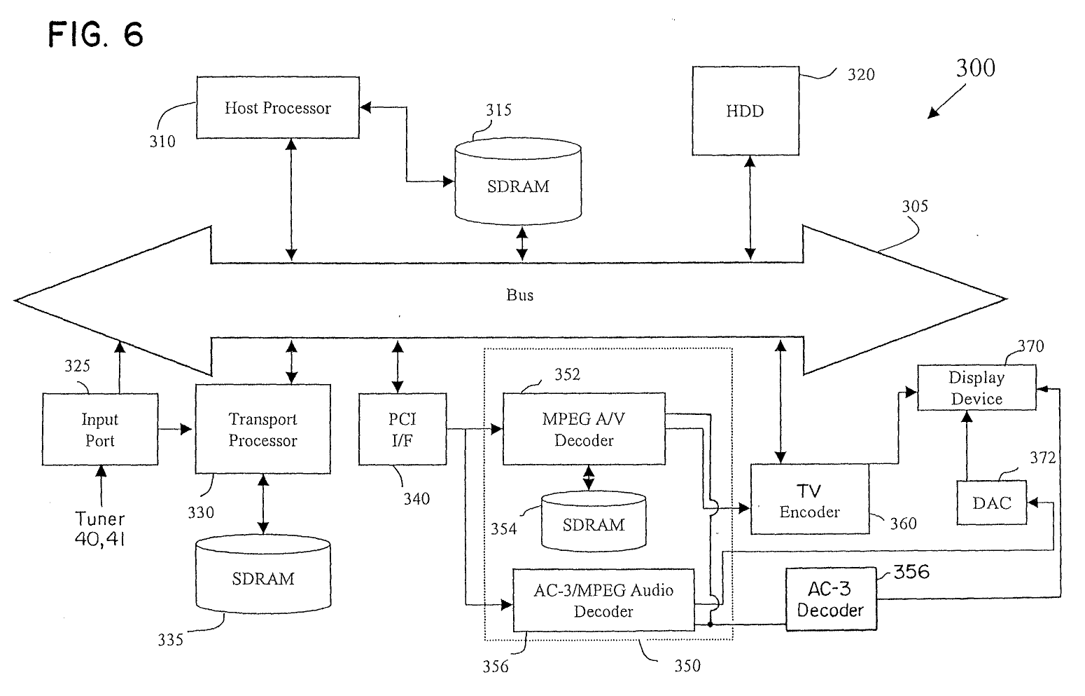

Although the system operates generally as described above, further details of the operation including both the provider and consumer side of the system are described below in relation to the flow charts of FIGS. 3-5. The block diagram of FIG. 6 further describes the operation of the system shown in FIG. 2.

FIG. 3 illustrates a particular example of how the FIG. 1 personal video-on-demand system operates. Specifically, FIG. 3 provides details on how the electronic program guide 80 interacts with the system.

As shown in FIG. 3, the consumer can manually input content selections in step 300. This may be done with the user interface 90. To aid in this process, the electronic program guide 80 may send a display to display unit 270 that aids in the manual input of content selections. In this way, the consumer can designate or otherwise select certain programs or other content to be recorded in the video-on-demand library. Step 300 may also delete previously selected content. In this way, the list of content selections may be tailored to the user's preferences.

Enhancing the electronic program guide 80 are tags. A tag includes data that is associated with or otherwise describes content. For example, a tag may indicate which actors are in a particular movie, the director of the movie, a synopsis of the movie, when it was released, critical reviews of the movie, related programs, sequels, keywords, a thumbnail, a preview, a snippet, or other information concerning or relating to the content. The tags may be in-band or otherwise transmitted along with the content. Alternatively, the tags may be associated with the program or otherwise sent separately such as with an electronic program guide.

Step 310 scans the electronic program guide 80 for content that has been tagged. In other words, step 310 searches or scans through the electronic program guide 80 for any content that has an associated tag. Step 320 allows the user to manually input selection criteria. These selection criteria are preferably based on the scope of the tags. In other words, if the tags are limited to actors and actresses, then the selection criteria may be similarly limited since other criteria would not effect the content selection. In this way, the user can manually input one or more selection criteria in order to search for desired content. This search may return a list or group of programs all of which may be recorded or which may be provided to the user for selection where only the selected content is recorded. This selection may be done by repeating step 300.

To further enhance the electronic program guide, step 330 tracks selected content and/or selection criteria. In other words, previously selected content may be tracked or otherwise stored by the control unit by the storage device 200. Also, previously input selection criteria may also be tracked or otherwise stored by the control unit 70 in the storage device 200. By tracking selected content and/or selection criteria, the electronic program guide 80 may learn the user's preferences and thereby speed the content selection process.

However, the consumer may not desire this tracking to be utilized. Thus, step 340 decides whether the consumer wants to add the tracked information to the selection. This may be done, for example, by prompting the user and inputting a command via the user interface 90. As another option, a default option may be utilized to make the decision of step 340.

If the tracked information is to be added to the selections, then step 350 is performed which updates the selections with the tracked information. In this way, a variety of content selections appropriate to and personalized to the consumer can be generated. The selection may be further managed by rearranging, deleting or by adding further selection by repeating the process shown in FIG. 3. The selection(s) may be presented to the user for modification(s). Alternatively, the system may simply retrieve the selections without user modification(s) to the selection(s).

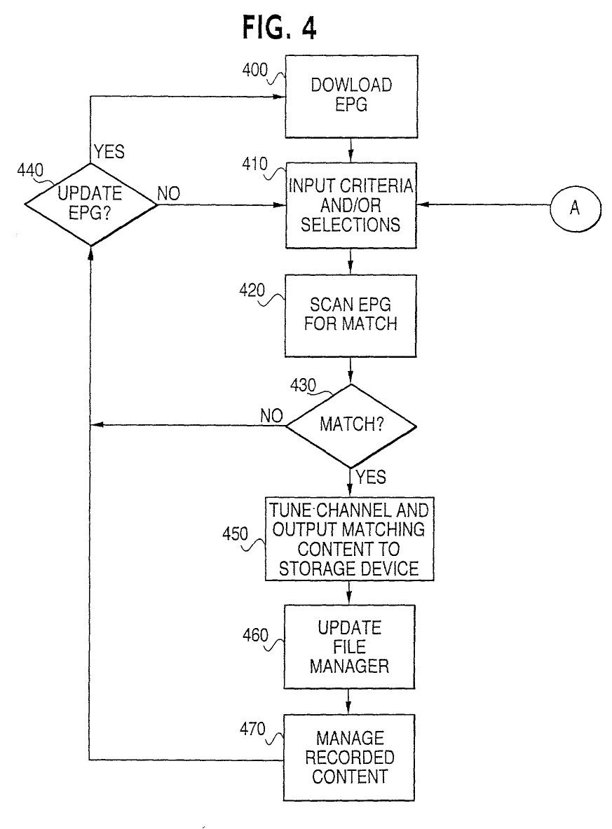

FIG. 4 illustrates further details of how the personalized video-on-demand system of FIG. 1 operates. This process begins in step 400 by downloading the electronic program guide 80. This may be done by utilizing port 82. For example, port 82 may be connected to a telephone line, cable connection, satellite up-link, or radio broadcast antenna. Using any or all of these methods, the information in the electronic program guide 80 may be down-loaded by step 400.

Step 410 then inputs criteria and/or selection(s). This process is described above in relation to FIG. 3 as indicated by connector A. In other words, the FIG. 3 process ends with connector point A which connects this process to the process of FIG. 4.

With the criteria and/or content selection in hand, step 420 can then scan the electronic program guide 80 for matches. In other words, the available content within the electronic program guide 80 is scanned for content matching the user's selections and/or criteria.

Step 430 then determines whether there is a match between the consumer selections and/or criteria and the electronic program guide 80. If there is no match, then the process may continue by proceeding to step 440 which decides whether to update the electronic program guide 80. Preferably, the electronic program guide 80 is updated on a periodic basis. For example, it may be most convenient to update the electronic program guide during off-peak hours. By tracking the user's viewing habits, the system can determine when these off-peak hours occur so that the downloading of the electronic program guide can occur when the consumer is not watching TV. If the electronic program guide 80 is to be updated, then the process proceeds to step 400 which downloads the electronic program guide 80. If not, then the process returns to the input step 410 which inputs the consumer's selections and/or criteria.

If there is a match between the consumer's selections and/or criteria, then the flow proceeds to step 450 which tunes the channel and/or otherwise outputs the matching content to the storage device. For example, the control unit 70 controls the receiver/tuner 40 to tune the channel of the available content spectrum to the appropriate channel. Then, the switch 50 is controlled by control unit 70 to switch the tuned channel to be fed to the storage device 200. The storage device 200 may then record the routed content.

Once the content has been recorded by storage device 200, step 460 then updates a file manager that may be part of the storage device 250, the control unit 70, other elements of the apparatus 100, or a separate entity. Essentially, the recorded content is stored as a file or files within the storage device 200. These file(s) have an associated address or header information that is managed by the file manager. Step 460 updates the file manager with information related to the recorded content.

By using the file manager, the user can then manage the recorded content with step 470. Specifically, the managing of the recorded content includes sorting, cataloging, adding comments, deleting, reorganizing, etc. Such management may also include on-demand playback. Such playback includes various commands including play, rewind, fast forward, pause, slow, skip, etc. in a manner similar to a video cassette recorder. It is noted that a VCR is given only by way of example, and any other device capable of the functions described above or similar functions, is also within the scope of the present invention.

The file manager may manage the recorded content by maintaining a data base, containing an entry for each recorded item. The entry may describe the content recorded and identify the memory device (either removable or not) which contains the recorded content. The entry may include all or part of the information received from the electronic program guide. The information received from the electronic program guide may be automatically entered. The entry may also be supplemented by notes or images from the user. The entry may contain alphanumeric characters, images, or both. The file manager may also forward the entry information to the printer 300, either directly from the storage device 200 or via the apparatus 100 (for example, the control unit 70) so that the entry information is printed on a label that can be affixed to the memory device. The file manager may also prompt the user, via user interface 90, to place a self-stick adhesive label in the printer 300.

The user may interface with the file manager via a graphical user interface (GUI), as is known in the art. The GUI allows the user to see what content is available. The GUI also indicates to the user where the content is stored, so the user can manually load the proper medium. As discussed above, alternatively the storage device 200 could automatically load the proper media by using a jukebox arrangement, for example.

As is apparent from the above, the database may be populated with information stored in the memory internal to the apparatus 100 or the storage device 200, as well as pre-recorded, removable media, for example, conventional DVDs. It is also possible that user-recorded content, which is stored in the memory internal to the apparatus 100 or the storage device 200, could be saved on removable media. In the instance, it may be advantageous to compress or modify compression parameters to improve the storage efficiency on the removable media. Generally, the apparatus 100 permits the copying or moving of content from internal, non-removable memory to external, removable memory, and vice versa.

The apparatus 100 also supports transcoding from one medium type to another to ensure efficient storage on the target medium. One such example is an initial, user-initiated request to record. The content may be recorded in internal, non-removable memory using one compression technique or set of compression parameters and recorded to an external, removable memory using a different compression technique or set of compression parameters, to thereby improve the storage efficiency of each memory type. In the context of the present specification, the term transcoding or coding is used to identify any type of compression, encryption, reformatting or other manipulation of the information to customize the information for the particular medium on which it is to be stored. After managing the recorded content in step 470, the flow then proceeds to step 440 which decides whether to update the electronic program guide 80 as described in detail above.

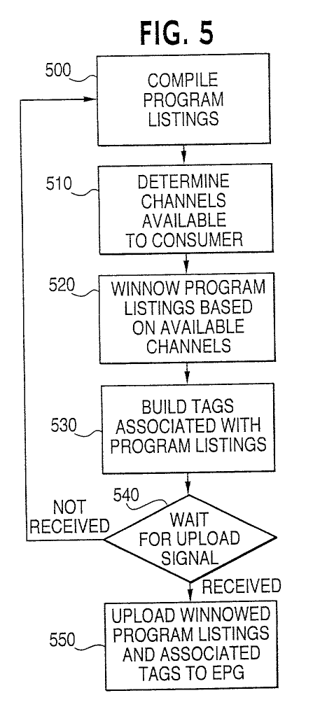

As shown in FIG. 5, the inventive methods also include building the electronic program guide. This process may start with step 500 which compiles the program listings. Such program listings include a channel line-up, names of programs, station information, descriptions of programs, and other information.

Next, step 510 determines which channels are available to the particular consumer. As there are a variety of broadcast systems throughout the world, the channel line-up is different for different consumers. Furthermore, consumers have a choice of broadcast system(s) from which to choose which affects the channels available to the consumer. Step 510 selects from the full spectrum of program listings those channels that are available to the consumer.

Step 520 then winnows the program listings based on the available channels. In other words, the data from step 510 is utilized to winnow the program listings to those that are available to the particular consumer.

Step 530 then builds tags that are associated with the program listings. The tags are described above and will not be repeated here. Step 530 gathers information to build the tags and associates the tags with the program listings.

Then, the system waits for an upload signal. If it has not been received, then the process leaps back to step 500. For example, more information may be available to build or supplement the tags. Also, more channels or less channels may be available to the consumer. All of these considerations are accounted for by looping through steps 500 through 540 until the upload signal has been received.

When the upload signal has been received, then the uploading process begins. Step 550 uploads the winnowed program listings and associated tags to the electronic program guide.

Although FIG. 5 is primarily directed to processes performed by the content feed 10, much of this process could alternatively performed on the consumer side by the apparatus 100. More specifically, the determination of the channels available to the consumer (step 510 ) and the winnowing of program listings based on available channels (step 520 ) may be performed on the consumer side by apparatus 100, in one example, by the control unit 70 working in conjunction with the electronic program guide 80 and the storage device 200. In this alternative, the content feed 10 would supply all program listings to the apparatus 100 for determination by the apparatus 100 of the available channels and winnowing of the program listings based on available channels.

As a further alternative, the tag building step 530 may also be performed by the apparatus 100. For example, the control unit 70 may utilize the various communication channels 26, 28, 30, 32 and/or 34 to gather information appropriate for the tags. These tags may then be associated with the corresponding program and stored in the electronic program guide.

The upload signal may be sent by the control unit to the content feed at a specific time, random time, or on command of the user via user interface 90. As mentioned above, it would be most convenient to update the electronic program guide during off-peak hours. By tracking the user's viewing habits, the system can determine when these off-peak hours occur so that the downloading of the electronic program guide can occur when the consumer is not watching TV.

FIG. 2 illustrates an alternative embodiment of the personalized video-on-demand system. This alternative of FIG. 2 is specifically designed for reception/tuning of plural programs, simultaneous recording of two or more programs, as well as simultaneously recording one program while viewing or playing back another program.

Many elements from the first embodiment of FIG. 1 are also utilized in FIG. 2. Common or like reference numerals indicate similar devices and functionality. The FIG. 2 embodiment supports all features described above in conjunction with the FIG. 1 embodiment. Additional features are emphasized below.

The transmitter 21 of content feed 10 is capable of transmitting a plurality of content streams. As further shown in FIG. 2, there are at least two connections each provided to the internet 26, cable 28 and telephone lines 30. Furthermore, the transmitter 22 is capable of broadcasting two or more content streams. Likewise, the satellite up-link 24 is also capable of transmitting two or more content streams.

On the receiving end, the apparatus 110 includes inputs from a first satellite down-link 34 as well as a second satellite down-link 35. These satellite down-links may be integrated into a single satellite down-link having two feeds. In addition, two antennas 32, 33 are utilized. Alternatively, a single connection (satellite down-link, cable, telephone, or internet or antenna) having a split feed could also be utilized instead of the two connections described above. In other words, the connections may be configured to transmit/receive more than one content stream.

As further shown in FIG. 2, the apparatus 110 includes two receivers, specifically receiver/tuner 40 and receiver/tuner 41 which are connected the various communication devices as shown.

The output from receiver/tuners 40, 41 are provided to bus arbitrator 55. Bus arbitrator 55 outputs to bus arbitrator 120 as well as decoder/decrypter 65, storage device 205 and storage device 255. In this way, either or both of the inputs from receivers 40, 41 can be routed to bus arbitrator 120, decoder/decrypter 65, and/or storage devices 205, 255.

The decoder/decrypter 65 receives inputs from bus arbitrator 55 as well as storage devices 205, 255. The outputs of the decoder/decrypter are provided to the bus arbitrator 120.

Bus arbitrator 120 receives inputs from bus arbitrator 55 and decoder/decrypter 65. The output of bus arbitrator 120 is provided to first display unit 271 and second display unit 272.

The decoder/decrypter 65 is similar to the decoder/decrypter 60 of the FIG. 1 embodiment, with the main difference being that decoder/decrypter 65 is capable of handling a plurality of content streams. In other words, the decoder/decrypter 65 may simultaneously decode and/or decrypt more than one content stream.

The electronic program guide 85 is connected to the control unit 75, the user interface 95 and an input port 82. The electronic program guide (EPG) 85 is similar to the electronic program guide (EPG) 80 of the first embodiment except that the EPG 85 may handle a plurality of content streams. For example, the EPG 85 may be a combination of two EPGs 80.

Similarly, the user interface 95 permits the user to enter commands for both of the content streams rather than the single content stream handled by the first embodiment of FIG. 1.

The control unit 75 has control outputs to the receiver/tuners 40, 41; the bus arbitrator 55; the decoder/decrypter 65; the EPG 85; the user interface 95; the bus arbitrator 120; and the storage devices 205, 255.

The storage device 205 is similar to storage device 200 of the first embodiment, but is preferably equipped with a plurality of read/write units. In other words, a storage device 205 is preferably capable of simultaneously recording and/or playing back at least two programs.

An optional, second storage device 255 may also be provided as further shown in FIG. 2. This optional second storage device is connected to the first storage device 205 as well as to bus arbitrator 55 and decoder/decrypter 65.

The storage devices 205, 255 are preferably modular units that can be expanded by adding additional units therein. For example, if hard disk drives are used for the storage devices 205, 255 then the storage capacity can be expanded by adding additional hard disk drive units. Also, the same variety of storage media may be utilized for the storage devices 205, 255 as described in relation to the storage device 200, 250 of the first embodiment.

FIG. 6 illustrates an exemplary architecture 700 of the apparatus 100 in accordance with another exemplary embodiment of the present invention. The architecture 700 utilizes a bus 305 to interconnect various components and to provide a pathway for data and control signals. FIG. 6 illustrates a host processor 310, a memory device 315 (in an exemplary configuration embodied as an SDRAM 315 ) and a hard disc drive (HDD) 320 connected to the bus 305. The host processor 310 may also have a direct connection to SDRAM 315 as shown in FIG. 6.

As further shown in FIG. 6, a transport processor 330 and PCI I/F 340 (peripheral component interconnect interface) are connected to the bus 305. The transport processor 330 also has a connection to input port 325 and SDRAM 335. Furthermore, the PCI I/F 340 is connected to a decoder 350. The decoder 350 is connected to a TV encoder 360. The output of TV encoder 360 is in turn sent to a display device 370. Decoder 350 may include both an MPEG A/V decoder 352 and an AC-3/MPEG audio decoder 356, the output of the latter being sent to display device 370 after conversion in a digital-to-analog converter (DAC) 372.

The host processor 310 may be constructed with conventional microprocessors such as the currently available Pentium™ processors from Intel. Host processor 310 performs non real-time functions in the architecture 700, such as graphics-user interface and browser functions.

HDD 320 is actually a specific example of a mass storage device. In other words, the HDD 320 may be replaced with other mass storage devices as is generally known in the art, such as known magnetic and/or optical storage devices, (i.e., embodied as RAM, a recordable CD, a flash card, memory stick, etc.). In an exemplary configuration, HDD 320 may have a capacity of at least about 25 Gbytes, where preferably about at least 20 Gbytes is available for various recording applications, and the remainder flexibly allocated for pause applications in architecture 700.

The bus 305 may be implemented with conventional bus architectures such as a peripheral component interconnect (PCI) bus that is standard in many computer architectures. Alternative bus architectures could, of course, be utilized to implement bus 305.

The transport processor 330 performs real-time functions and operations such as control of the A/V data flow, conditional access, program guide control, etc., and may be constructed with an ASIC (application specific integrated circuit) that contains, for example, a general purpose R3000 A MIPS RISC core, with sufficient on-chip instruction cache and data cache memory. Furthermore, the transport processor 330 may integrate system peripherals such as interrupt, timer, and memory controllers on-chip, including ROM, SDRAM, DMA controllers; a packet processor, crypto-logic, PCI compliant PC port, and parallel inputs and outputs. The implementation shown in FIG. 6 actually shows the SDRAM 335 as being separate from the transport processor 330, it being understood that the SDRAM 335 may be dispensed with altogether or consolidated with SDRAM 315. In other words, the SDRAMs 315 and 335 need not be separate devices and can be consolidated into a single SDRAM or other memory device.

The input port 325 receives audiovisual bitstreams from at least two tuners 40 that may include, for example, MPEG-1 and MPEG-2 video bitstreams, MPEG-1 layer II audio bitstreams and Dolby digital (AC-3) audio bitstreams. Exemplary A/V bitrates may range from about 60 Kbps to 15 Mbps for MPEG video, from about 56-384 Kbps for MPEG audio, and between about 32-448 Kbps for AC-3 audio. The single-stream maximum bitrate for architecture 700 may correspond to the maximum bitrate of the input programming, for example 16 Mbps or 2 MBps, which corresponds to the maximum MPEG-2 video bitrate of 15 Mbps, maximum MPEG-1 Layer-2 audio bitrate of 384 kbps, and maximum AC-3 bitrate of 448 kbps.

Of course, various other audiovisual bitstream formats and encodation techniques may be utilized in recording. For example, architecture 700 may record an AC-3 bitstream, if AC-3 broadcast is present, along with MPEG-1 digital audio. Still further, the received audiovisual data may be encrypted and encoded or not encrypted and encoded. If the audiovisual data input via the input port 325 to the transport processor 330 is encrypted, then the transport processor 330 may perform decryption. Moreover, the decryption may be performed instead by the host processor 310.

Alternatively, the host processor 310 and transport processor 330 may be integrated or otherwise replaced with a single processor. As mentioned above, the SDRAMs (315 and 335 ) may be consolidated or replaced with a single SDRAM or single memory device.

The PCI I/F 340 may be constructed with an ASIC that controls data reads from memory. Audiovisual (A/V) data may be sent to the host processor 310's memory while simultaneously being sent to an MPEG A/V decoder 352, as further discussed below.

As previously noted, decoder 350 may be constructed as shown in FIG. 6 by including the MPEG A/V decoder 352 connected to the PCI I/F 340, as well as an AC-3/MPEG audio decoder 356 which is also connected to the PCI I/F 340. In this way, the video and audio bitstreams from the PCI I/F 340 can be separately decoded by decoders 352 and 356, respectively. Alternatively, a consolidated decoder may be utilized that decodes both video and audio bitstreams together. As mentioned above, the encodation techniques are not limited to MPEG and AC-3 and can include any known or future developed encodation technique. In a corresponding manner, the decoder 350 could be constructed to process the selected encodation technique(s) utilized by the particular implementation desired.

In order to more efficiently decode the MPEG bitstream, the MPEG A/V decoder 352 may also include a memory device such as SDRAM 354 connected thereto. This SDRAM 354 may be eliminated, consolidated with decoder 352 or consolidated with the other SDRAMs 315 and/or 335.

TV encoder 360 is preferably an NTSC encoder that encodes, or converts the digital video output from decoder 350 into a coded analog signal for display. Regarding the specifications of the NTSC (National Television Standards Committee) encoder 360, the NTSC is responsible for setting television and video standards in the United States. The NTSC standard for television defines a composite video signal with a refresh rate of 60 half-frames (interlaced) per second. Each frame contains 525 lines and can contain 16 million different colors.

In Europe and the rest of the world, the dominant television standards are PAL (Phase Alternating Line) and SECAM (Sequential Color with Memory). Whereas NTSC delivers 525 lines of resolution at 60 half-frames per second, PAL delivers 625 lines at 50 half-frames per second. Many video adapters or encoders that enable computer monitors to be used as television screens support both NTSC and PAL signals. SECAM uses the same bandwidth as PAL but transmits the color information sequentially. SECAM runs on 625 lines/frame.

Thus, although use of NTSC encoder 360 is envisioned to encode the processed video for display on display device 370, the present invention is not limited to this standard encoder. PAL and SECAM encoders may also be utilized. Further, hi-definition television (HDTV) encoders may also be viable to encode the processed video for display on a HDTV, for example.

Display device 370 may be an analog or digital output device capable of handling a digital, decoded output from the TV encoder 360. If analog output device(s) are desired, to listen to the output of the AC-3/MPEG audio decoder 356, a digital-to-analog converter (DAC) 372 is connected to the decoder 350. The output from DAC 372 is an analog sound output to display device 370, which may be a conventional television, computer monitor screen, portable display device or other display devices which are known and used in the art. If the AC-3/MPEG digital audio data are to be decoded by an external audio component, a digital audio output interface (not shown) may be included between the AC-3/MPEG audio decoder 356 and display device 370. The interface may be a standard interface known in the art such as a SPDIF audio output interface.

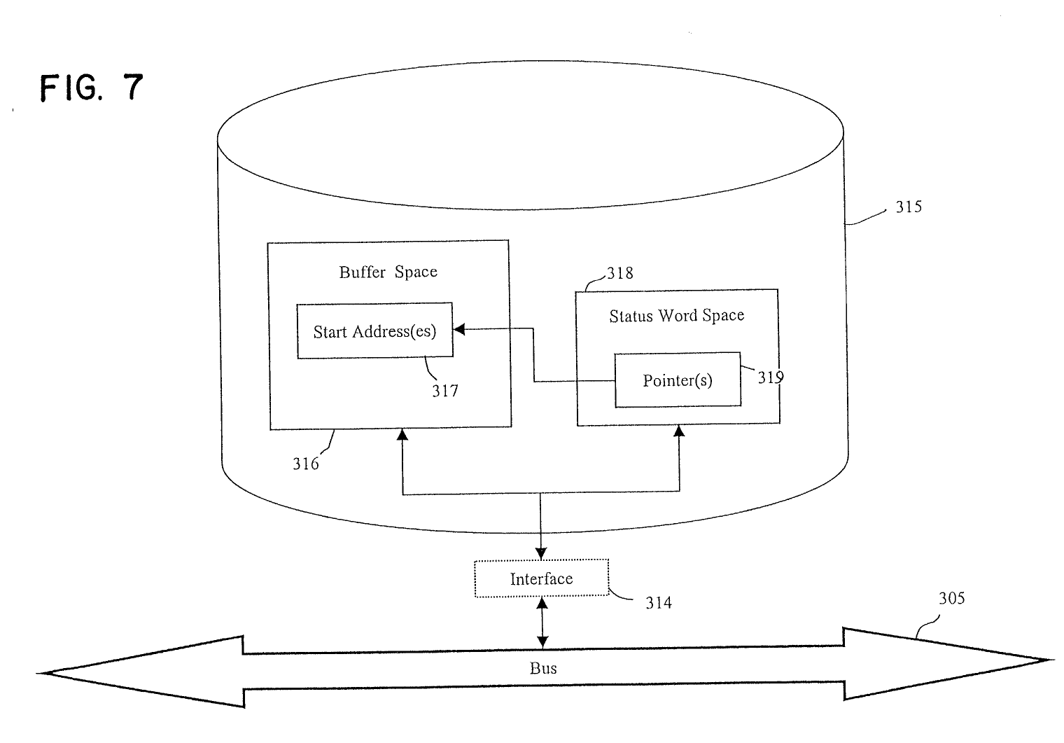

FIG. 7 illustrates various components that may be provided for the SDRAM 315. As mentioned above, the SDRAM shown in FIG. 6 is actually a specific implementation of a memory device. It is noted that the invention is not limited to this specific implementation of SDRAM 315 and can include any other known or future developed memory technology. Regardless of the technology selected, the memory device 315 may include a buffer space 316 which may be a fixed or virtual set of memory locations that buffers or otherwise temporarily stores audiovisual data. In practice, the video data may be stored separate from the audio data, but it would be possible to intermix these data types depending upon the particular application and coding techniques utilized for the audio and visual data.

The audio visual data stored in the buffer space 316 includes one or more start addresses 317 which indicate the beginning memory address at which the audio and/or video data (A/V) is stored. If the A/V data is separately stored, then a plurality of stored addresses will be necessary. Furthermore, if there are more than one set of, or a block of data within the buffer space 316, then the start addresses 317 will individually point to each block of data.

The memory device 315 also includes a status word space 318. This status word space includes fixed or virtual addresses at which status words may be stored. An example of a status word that may be stored in the status word space 318 is a status word summarizing the status of a peripheral device. For example, the status word that may be stored within the status word space 318 may include the status of the host processor 310 or transport processor 330. The status word space 318 may also include pointers 319 that point to the start addresses 317 within the buffer space 316.

As further shown in FIG. 7, the SDRAM 315 may connect to the bus 305 via an interface 314. The dash lines indicate that the interface 314 is optional and may or may not be included depending upon the interface requirements of the particular memory device 315 and/or bus 305.

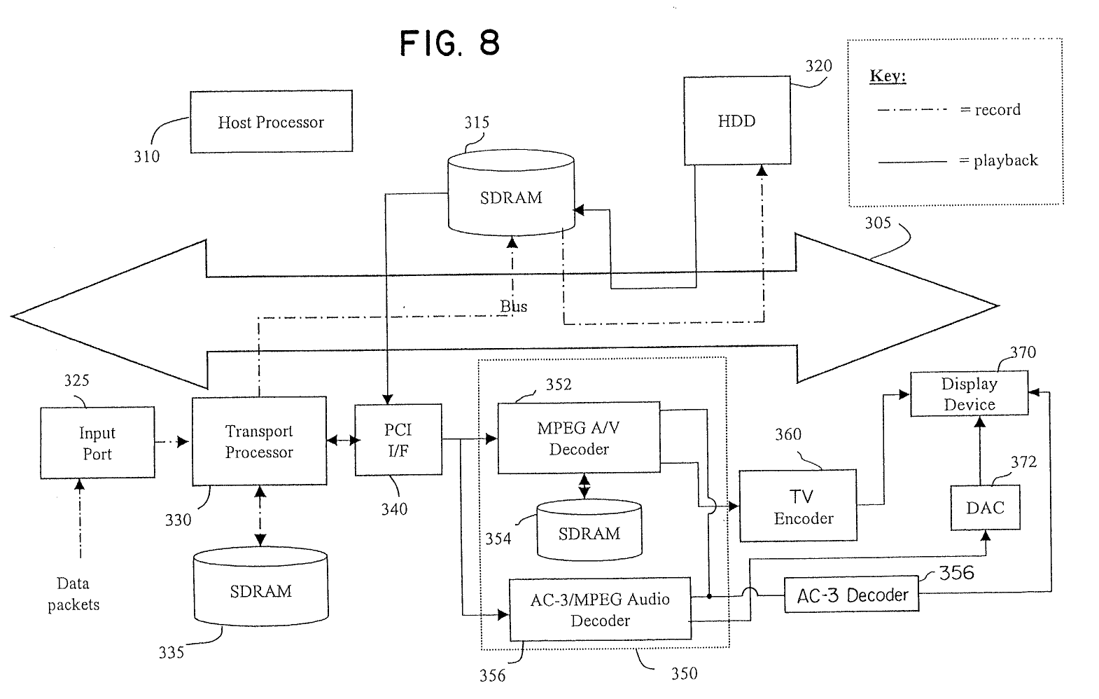

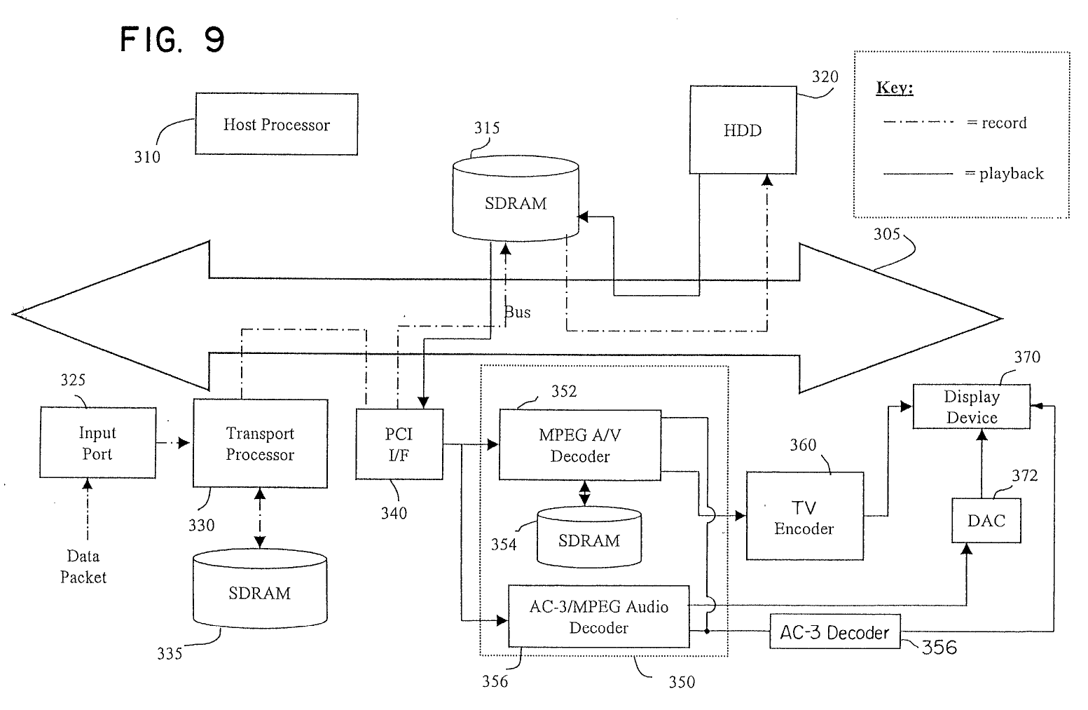

Exemplary recording and playback paths are described in accordance with FIGS. 8 and 9. FIG. 8 shows the recording and playback data flows among the various components of the architecture 700. Some of the connections between components, and associated reference numerals from FIG. 6 may have been eliminated in FIG. 8 in order to highlight the data flow which is shown using dashed lines (see Key) in FIG. 8.

As shown in FIG. 8, A/V data of a selected or desired event, program and/or broadcast from at least two tuners 40 is received by input port 325 (typically the data is received in packetized form) and fed to the transport processor 330. The transport processor 330 then transfers the received A/V data to SDRAM 315. Digital recording is accomplished by the host processor 310, which transfers the A/V data buffered by SDRAM 315 to the HDD 320. In other words, the SDRAM 315 serves as a buffer which buffers data sent by transport processor 330. This allows the host processor 310 to control the recording onto the HDD 320 when host processor 310 time is available. When a sufficient amount of programming data has been accumulated in the SDRAM 315, the host processor 310 transfers the data from the SDRAM 315 to the HDD 320 for recording therein.

FIG. 9 illustrates an alternative signal path for recording. Audiovisual data is fed from the input port 325 to the transport processor 330. The transport processor 330 then transfers the received audiovisual data to the PCI I/F 340, as indicated by the dashed data flow line. The PCI I/F 340 receives audiovisual data from the transport processor 330 via bus 305, and sends this data to host processor 310, more particularly to SDRAM 315.

Digital recording is accomplished similarly, with SDRAM 315 serving as a buffer that buffers data sent by the PCI I/F 340. This allows the host processor 310 to control the recording onto the HDD 320 when processor time is available. When a sufficient amount of A/V data has been accumulated in the SDRAM 315, the host processor 310 transfers the data from the SDRAM 315 to the HDD 320 for recording therein. To record data, the host processor 310 may also inform the PCI I/F 340 of available start addresses in the SDRAM buffer space 315 to which data may be buffered for eventual recording in HDD 320.

The operation of playing back the recorded A/V data that represents a stored event, program, broadcast, etc. in architecture 700 is now described. Referring again to FIGS. 8 and 9, when the viewer turns the apparatus 100 on, the viewer is given the option to playback any of the previously recorded programs, events, broadcast, etc. Preferably, this may be done by using remote control (not shown) to access a menu on display device 370. If the viewer selects a desired event, the corresponding A/V data (which typically may also include system time and conditional access packets) are retrieved from HDD 320.

In particular, when the user selects the playback option, the selected A/V data recorded on HDD 320 is sent via bus 305 to a queue in SDRAM 315. Next, the buffered data is sent from SDRAM 315 via bus 305 to PCI I/F 340, which in turn sends the selected A/V data to decoder 350. More specifically, the video portion of the bitstream is sent to MPEG A/V decoder 352, with the audio portion being sent to AC-3/MPEG audio decoder 356. Alternatively, MPEG video and audio can be conveyed to MPEG A/V decoder 352.

Within decoder 350, MPEG A/V decoder 352 may be provided with an SDRAM 354 in order to more efficiently decode the MPEG bitstream received from PCI I/F 340. SDRAM 354 is similar to SDRAM 315 discussed above in its construction. SDRAM 354 temporarily holds the encoded video bitstream data, and also provides the three frame buffers required for MPEG decoding, as is known in the art. Thereafter, the decoded A/V data is output to TV encoder 360 for conversion to an analog format, so that it may be displayed on display device 370. From this point on, the playback data looks, for all intents and purposes, identical to the originally recorded event, program, broadcast, etc.

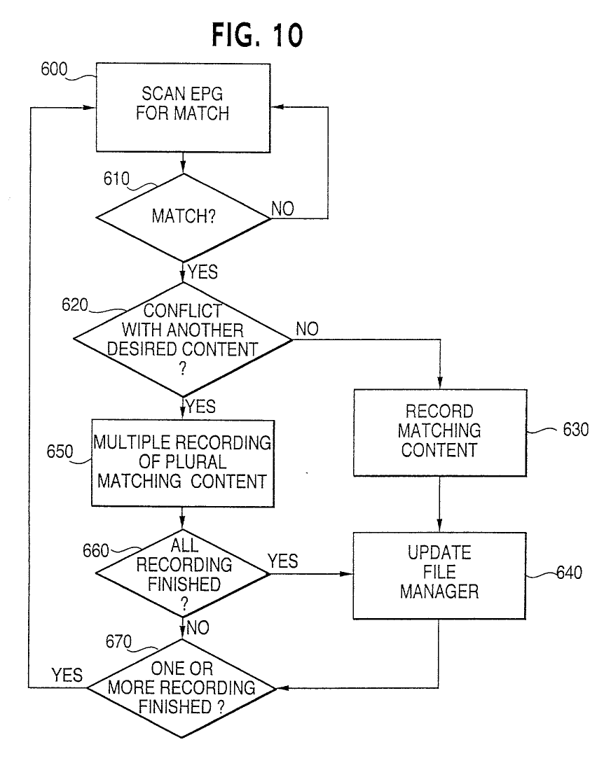

FIG. 2 illustrates another exemplary embodiment The embodiment of FIG. 2 generally operates as follows. For further details on an exemplary method of operation, further reference is made to FIG. 10 which is explained below in detail.

As mentioned above, a plurality of content streams may be fed to apparatus 110 of the second embodiment. For example, two simultaneous content streams can be provided to the receiver/tuners 40, 41. The bus arbitrator 55 can switch either or both of these content streams and provide the output to various devices.

If recording is desired, then the control unit 75 directs the bus arbitrator 55 to switch the content from receiver/tuners 40, 41 to the storage device 205. In this way, two programs from two separate content streams can be simultaneously recorded by the storage device 205. Alternatively, one of the programs can be fed to storage device 205 while the other is fed to storage device 255.

Some of the features performed by the various exemplary embodiments of the present invention are described below.

As described above in conjunction with FIG. 3, a user may select a single or multiple recorded events from a program guide or scheduler, such EPG 85, for viewing based on actors, actresses, directors, program title, key words, key phrases, synopsis, release date, critical review, related programs, sequels, a thumbnail, a preview, a snippet, or other information concerning or relating to the content. In one embodiment, the user activates this “intelligent agent” feature via an input device such as a remote control. For example, the user may display the EPG 85 on the screen of a display unit, such as first display 271 or second display unit 272 and activate one or more menu screens for entering key word information such as the tag information described above or phrases that the user has pre-assigned to programs.

Alternatively, the user may initiate a browse function to search a listing of programs stored on HDD 320, which may be organized alphabetically, by category of program (i.e., drama, comedy, action adventure, etc.) and/or by organizational structure created by the user. For example, a user may assign “record channel” numbers to various recorded programs, whereby the user may click up or down a channel listing menu screen to select a desired channel. Once selected, the screen may display a listing of recorded programming assigned to that channel, grouped by key word such as title, for example.

Another feature of the control unit 75 is the implementation of a duplicate episode filter. This feature of control unit 75 tracks the list of recorded programs for duplicates when a record operation is initiated. When a user selects a record operation, the control unit 75 references the storage devices 205, 255, to check certain characteristics of the selected program to be recorded with the information stored in memory devices 210, 215, 220, 225 . . . 230, 235. If a match is determined, a notification may visually be displayed for the user.

In order to identify a match, characteristics such as the tag information described above, or unique call numbers may be compared. In one exemplary embodiment, the first display unit 271 or second display unit 272 may display the characteristics of the selected program to record with the best match in memory in a side-side fashion, for ease of comparison by the user. Alternatively, the user may be prompted with the notification and the option to view the possible match so as to confirm that the user is about to record a duplicate of a recorded program.

Additionally, the user may be provided with a halt recording option if the duplicate episode filter feature has identified a match, where the control unit 75 sends a prompt or notification after the match, asking the user if they would like any or all portions of the duplicate episode to be erased. Alternatively, the user may activate an automatic preference to have the control unit 75 erase any recording of a program that is identified as a duplicate episode by the duplicate episode filter feature.

An active snapshot is another operational mode of the present invention which dumps the A/V stream from the TV encoder 360 to another device such as a PC or other output device. In this way, the active snapshot can offload A/V segments (or entire programs or even the entire contents of the HDD 320) to another device. This active snapshot may be accomplished by feeding the decoded stream from the decoders 352, 356 (MPEG A/V decoder and/or AC-3/MPEG Audio decoder) to the display device 370 as shown in FIG. 6, for example. The output device 370 may be a PC, another HDD, CDR (recordable CD), or other digital device capable of storing the data.

Alternatively, the active snapshot may dump encoded or decoded data to an external device by having the host processor 310 route data from the HDD 320 to the PCI bus and eventually to the external drive.

As a further alternative, the active snapshot can dump analog data to the analog output device by feeding the decoded stream from the decoders 352, 356 (MPEG A/V decoder and/or AC-3/MPEG Audio decoder) to the DAC 372 and TV encoder 360 which converts the digital, decoded stream to an analog signal. The analog signal is then supplied to an analog display device 370 as shown in FIG. 6. The analog output device 370 may be a conventional VCR or other analog mass storage device.

If simultaneous record and playback is desired, then control unit 75 directs one of the content streams from receiver/tuner 40, 41 to the storage device 205 by sending a control signal to bus arbitrator 55. At the same time, the control unit 75 can control the storage device 205 or 255 to playback another program previously recorded therein which is fed from the storage device 205 or 255 to decoder/decrypter 65 and then to bus arbitrator 120. Further control can then be exercised by control unit 75 which can control bus arbitrator 120 to feed the playback or record program to either or both display units 271, 272.

The display units 271, 272 may be separate display devices or may be integrated in a single display device. For example, conventional picture-in-picture display devices can handle two simultaneous input streams and such a device is within the scope of this invention.

The exemplary embodiments of the present invention may also be provided with a status indicator function which can be displayed via a user interface to the apparatus 100, such as with a remote control unit for example. The following features may be provided: current delay, status indicator, available record time, HDD 320 capacity (Disk Gas Gauge), out-of-disk space alert and certain file attributes. These features are summarized in Table 1 below.

TABLE 1
Special Features

| Feature | Description |
|---|---|
| Automatic record | Theme recording base on program title, |
| | keywords or key phrases |
| Duplicate show handling | Will not record two copies of the same |
| | show |
| On-screen time display | Display the current time into the show, ie. |
| | 0:34, 1:12 etc while in Playback, Fast- |
| | forward or Rewind |
| Back to pause | After resume live broadcast, jump back to |
| | last pause point |
| Active Snapshot | Dump audio/video to PC or other output |
| | device |
| Smart delete | Once a show is recorded, it can be set it |
| | to never be deleted |

The current delay feature allows the user to see how far the recording is behind a live feed when pausing the live signal. The status indicator may be displayed on the display device 370, and indicates whether the material a viewer is watching is LIVE (a live feed) or RECORDED. In one embodiment, the status indicator may flash LIVE or RECORDED on the output device 370. The available record time feature indicates the amount of time available for recording (in minutes, for example).

If simultaneous playback of two programs is desired, then control unit 75 controls the storage devices 205 and/or 255 to simultaneously playback two previously recorded programs. These programs are fed through decoder/decrypter 65 into bus arbitrator 120. Preferably, control unit 75 would then control bus arbitrator 120 to switch one of the programs to the first display unit number 271 while the other is directed to the second display unit 272.

If the user wants to view a live broadcast while recording another program, then the control unit 75 operates as follows. In this example, it is assumed that the live program to be viewed is being received by the first receiver/tuner 40. Control unit 75 then sends a control signal to bus arbitrator 55 to route the live broadcast program to either the bus arbitrator 120 or the decoder/decrypter 65. This decision is made depending on whether the live broadcast requires decoding and/or decryption. Depending upon which display unit is intended for viewing, the control unit 75 controls the bus arbitrator 120 to route the decoded and/or decrypted content to the appropriate display unit 271, 272. If no decryption or decoding is necessary, then control unit 75 directs the bus arbitrator 55 to route the content directly to bus arbitrator 120 which can then send the live broadcast to either of the display units 271, 272.

A clear/convert function is another feature of the present invention which permits a user to convert a paused program to a permanently recorded program. For example, when the apparatus 100 is turned on, an auto pause function may be enabled that automatically pauses (records) the currently-tuned channel. The user could then be given the option to convert this paused program to a permanently recorded program. Alternatively, a channel surfing user who pauses a program and who, at some point within the pause window, decides that the program is worth permanently recording could, for example, press an button on the remote control to command the apparatus 100 to permanently record the program.

As another alternative, as the duration of the pause approaches the pause time window, the user could be prompted with a query such as “permanently record?” If yes, then the program is converted from a paused program to a permanently recorded program. In this way, the user will not lose any of the program that may have otherwise extended beyond the pause time window.

As yet another alternative, a channel change from channel #1 to channel #2 converts paused channel #1 to recorded channel #1, begins pause of channel #2 and provides user with option to clear recorded channel #1.

To convert from a paused to a recorded program, the apparatus 100 may move the paused program from a portion of the HDD 320 reserved for pausing to a portion reserved for recorded programs. Alternatively, the HDD 320 directory may be updated to reallocate space such that the paused program now resides in a virtual recorded program HDD 320 space. Such moves or HDD directory updates may be performed by the host processor 310.

A personal instant replay is another feature of the present invention which permits a variable back tracking instant replay (up to the length of pause). The amount to back track may correspond to the duration the remote control button is depressed. The mechanism for instant replay may be identical to that of playback. Furthermore, an infinite loop may be established so that the instant replay is played again and again until stopped by command of the user. Alternatively, the playback may stop when a certain number of loops have been completed.

If the consumer wants to see two live broadcasts with no recording, then the control unit 75 controls bus arbitrator 55 to route both received content streams to either decoder/decrypter 65 or to bus arbitrator 120 depending upon whether decryption and/or decoding is necessary. Thereafter, the displays can be switched by bus arbitrator 120 under the control unit 75 to the appropriate displays 271, 272.

A back to pause function is another feature of the present invention which may also be triggered with the remote control. The back to pause function jumps back to the paused time location. More specifically, after resuming a live broadcast from a paused program, the back to pause function jumps back to last pause point. In other words, the A/V stream is played back from the last pause point.

As can be seen from the above description, the FIG. 2 embodiment is highly advantageous and permits a variety of functions. For example, a user can simultaneously record at least two content streams on the storage devices 205 or 255. In this way, the video-on-demand library can be quite rapidly accumulated.

Furthermore, the FIG. 2 embodiment permits the simultaneous viewing of one program while another is being recorded. In this way, a consumer can watch his television in the normal manner while still accumulating a video-on-demand library in the background. When the live television broadcast gets boring or is no longer interesting, then the user can switch to the video-on-demand library that has been accumulating during his viewing or at other times.

Furthermore, the electronic program guide 85 permits a user to navigate the plurality of desired content, make appropriate selections and build the video-on-demand library that most suits his needs.

FIG. 10 further illustrates some of the methods utilized by the second embodiment. Generally speaking, FIG. 10 resolves scheduling conflicts between two or more programs.

More specifically, the process of FIG. 10 begins by scanning the electronic program guide 85 for a match. This is similar to the process described in relation to step 430 in FIG. 4. One difference is that step 600 may scan for more than one match.

Step 610 determines if there is at least one match. If not, then the process loops back to step 600. If there is at least one match, then the flow proceeds to step 620 which determines whether there is a scheduling conflict. More specifically, step 620 determines whether the recording of one program matching the consumer's desires would overlap with the recording of another program matching the consumer's desires.

If there is no conflict, then the flow proceeds to step 630 which records the matching content. Thereafter, the file manager is updated in a manner similar to step 460 in FIG. 4 and the flow proceeds to step 670 which is described below.

If there is a conflict, then step 650 performs multiple recording of the plurality of programs matching the consumer's desires. This process is generally described above and utilizes the control unit 75 to switch the desired content through bus arbitrator 55 to the storage devices 205 or 255. The switching is controlled on a scheduled basis according to the time schedule of each program. Multiple recording continues as long as there is an overlap between the schedules.

Step 660 determines whether all recording has finished. If so, then the file manager is updated in step 640 which process is described above.

If all recording has not been finished, then a further decision is made in step 670 to determine whether there is one or more recording to be completed. If so, then the process loops back to step 600 which again scans the electronic program guide 85 for another match. In this way, the system can continue recording at least two programs simultaneously.

Although the above description relates to recording two programs simultaneously, the embodiment of FIG. 2 can be extended to record three or more programs simultaneously. Essentially, the components of FIG. 2 would be multiplied such that there would be N receivers/tuners and the storage devices would be capable of recording N programs simultaneously.

As described above, the various exemplary embodiments of the present invention include several modes, including, but not limited to recording two or more signals where one or both may also be simultaneously viewed, recording one or more signals and playing back one or more signals, playing back two or more signals, watching one or more signals, while recording one or more other signals, viewing two or more live signals (through the use of picture-in-picture or other similar function), and viewing at least one signal live, while viewing one or more signals in playback mode. It is noted that the various functions described above may be utilized in conjunction with one or more of these modes. For example, the intelligent agent duplicate filter, and active snapshot functions may be used with any recording mode, the status indicator and personal instant replay features may be utilized with any playback mode, and the status indicator, clear convert, record after watching, and personal instant replay functions may be utilized in any live viewing mode. The back to pause function may be utilized to jump between any two or more live or playback signals.

Although most of the specification is directed to devices and methods for handling video content, the invention also applies to audio content, data content or mixed content. In other words, the content feed may supply audio or data content to the apparatus 100 or 110.

For example, the decoder/decrypter 60, 65 could be reconfigured to decode and/or decrypt audio data. In addition, the MP 3 standard (currently MPEG-1 Layer III), the Windows Media Audio (WMA) standard or other conventional decoding schemes as well as conventional decrypting schemes may be utilized by decoder/decrypter 60, 65 to decode and/or decrypt the audio content. Furthermore, the display units 270, 271, 272 would be speakers or other audio reproduction devices instead of video display units in this alternative. Otherwise, the systems and methods of the invention would work in much the same manner to aggregate an audio-on-demand library.

In at least one embodiment described above, the present invention contemplates the concurrent use of internal, non-removable memory and external, removable memory. In at least one embodiment described above, the present invention also contemplates recording content in an internal, non-removable memory prior to recording in an external, removable memory, where the recording to the external, removable memory can occur in a background mode. In at least one embodiment described above, the present invention also contemplates recording content by streaming directly to the removable medium. In at least one embodiment described above, the present invention also contemplates playing back by recording from the external, removable memory into the internal, non-removable memory and then playing back from the internal, non-removable memory. As mentioned above, the invention may also be applied to aggregate desired data. If data is being aggregated by the present invention, then the system may be labeled a personal data server farm. For example, a personal data server farm according to the invention may aggregate a data-on-demand library such as a library of desired usenet news. The consumer could designate usenet newsgroups that interest that user using the user interface 90 and, perhaps an electronic program guide 80 and the system would then aggregate a library of usenet news. This aggregated library of data may then be manipulated on-demand of the user. Various other types of data may be aggregated by the invention with usenet news being only an illustrative example. If the invention is being applied to aggregate data content, then the decoding and/or decrypting schemes may utilize schemes appropriate to decoding and/or decrypting data. Furthermore, if the data is being broadcast according to a schedule then the scheduling and scheduling conflict resolution features described above in terms of audio data may be applied to such broadcast data.

Furthermore, the inventive apparatus 100, 110 may be embodied in a variety of ways. A set-top box is one example. Other examples include a personal computer (PC), TV or hardware card that is added to an existing apparatus such as a conventional set-top box, PC or TV. Still further, the inventive functionality may be downloaded or otherwise programmed into a set-top box, PC or TV. Such programming may be accompanied by connecting the programmed device to a storage device such as hard disc drive array 200. Furthermore, although FIGS. 1 and 2 illustrate electronic program guides 80, 85 as part of the apparatus 100, 110, the electronic program guide content could also be provided by the content feed 10.

It is noted that the functional blocks in FIGS. 1-2 and 6-9 may be implemented in hardware and/or software. The hardware/software implementations may include a combination of processor(s) and article(s) of manufacture. The article(s) of manufacture may further include storage media and executable computer program(s). The executable computer program(s) may include the instructions to perform the described operations. The computer executable program(s) may also be provided as part of externally supplied propagated signal(s) either with or without carrier wave(s).

In accordance with another aspect of the invention, there is a digital STB that includes a first processor which performs essentially all of the real time operations, such as control of a data pipeline to the STB, conditional access, and control of a program guide stored within the STB. A second processor operatively connected to the first via a data bus controls essentially all non-real time functions that are executed within the STB, such as graphical user interface (GUI) and browser functions, for example. In an embodiment, the STB may be embodied as a digital video recorder (DVR) having multiple processors that are slated for essentially real-time operations or functions, or essentially non-real time operations or functions.

The STB may be operatively connected to, or embodied within, a digital satellite broadcast system, direct video broadcast system, cable TV system, off-air broadcast system or other known broadcast system. One may expect that the addition of one or more processors would increase the available system bandwidth of the STB. However, this increase may not be solely due to the power provided by the additional processor(s). A single processor consisting of or having the aggregate power capabilities of two or “N” processors would not be as efficient as a system with multiple individual processors dedicated to specific tasks. In part, this is due to the overhead associated with switching between tasks, and also due to the need to resolve conflicts when multiple tasks or functions are submitted to the processor (i.e., by instructions or commands) at the same time.

For example, the demands of real time events, broadcasts or programs that are processed by the STB and/or DVR may often conflict with each other. In the present invention, one processor may handle reception of remote IR commands for various functions related to the manipulation of the real time events, broadcasts or programs, while another processor receives satellite-transmitted (or cable-transmitted or off-air broadcast-transmitted) program guide data. It would be disadvantageous if either the IR transmission or the satellite transmission were stopped while the processor pays attention to something else. Even if the data were buffered until a processor was available, this would still be undesirable as latency would increase, ultimately constraining the processor to respond before the available buffering capacity is exceeded. This is a case, considered by the inventors in light of the present invention, where multiple processors may be dedicated to specific tasks in order to avoid the aforementioned pitfalls, so as to increase overall system bandwidth.

Additionally, separate processors executing code in separated memories and/or segmented memory segments, in accordance with the present invention, may also increase system security. For example, decryption algorithms could be hidden from the prying eyes of application developers by executing the security codes on a different processor.

Further, the present invention provides greater stability in that if incorrect code or unexpected circumstances disrupt the operation of one processor in the STB or DVR, another processor may continue operation unaffected by the disrupted processor. In this way, multiple processor STB or DVR systems can be made more robust as compared to the single micro-controller STB. Moreover, dividing functions amongst multiple processors provides an opportunity to improve the quality of system architecture. The hard separation between processors encourages the implementation of well-defined interfaces between the various operations running on the STB platform, for example.

However, before describing the multi-processor-features in greater detail, the inventors offer a general discussion on an exemplary satellite-based distribution system envisioned for the present invention, and more specifically discuss a set-top box (STB) equipped with a digital video recorder (DVR) within a direct broadcast satellite or digital video broadcast (DVB) system. Additionally, the basic architecture and operation of the STB or STB-equipped with DVR is explained in order to provide a context for the multi-processor configuration of the present invention.

In general, television signal distribution systems generally rely on either a cable network or on free-space propagation for delivering television signals to individual users or subscribers. Cable-based television systems transmit one or more individual television signals or “channels” over wire, while free-space propagation systems transmit one or more channels over-the-air, i.e., in a wireless manner. Most large-scale cable and wireless television signal distribution systems broadcast a broadband television signal having a plurality of individual television signals or channels modulated onto one or more carrier frequencies within a discernable frequency band.

Some wireless television signal distribution systems use one or more geosynchronous satellites to broadcast a broadband television signal to receiver units within a large geographic area, while other wireless systems are land-based, using one or more transmitters located within smaller geographic areas to broadcast to individual receiver units within those geographic areas. An example of a land-based “cellular” type television signal distribution system is disclosed in Bossard, U.S. Pat. No. 4,747,160. This system includes multiple television signal transmitting stations, each of which transmits a television signal to individual receivers spread throughout a limited geographic region, and is configured so that adjacent transmitting stations use modulation and frequency diversity to prevent interference.

Some cellular systems, such as those commonly referred to as LMDS (local multi-point distribution system) and MMDS (multi-channel, multi-point distribution system), use a land-based cellular-type transmitting setup to rebroadcast satellite signals at frequencies different than the frequencies used by the satellite. Each of the transmitters of an LMDS system typically transmits within a one to five mile radius cell while each of the transmitters of an MMDS system typically transmits within an approximately 30 -mile radius cell.

The present invention may be embodied in a satellite-based distribution system. The system generally includes an earth station that compiles a number of programs (video and audio) into a broadband signal, modulates a carrier frequency band with the broadband signal and then transmits (uplinks) the modulated signal to a geosynchronous satellite via a transmit antenna. The satellite amplifies the received signal, shifts the signal to a different carrier frequency band and transmits (downlinks) the frequency shifted signal to earth for reception at individual receiver stations.

The uplink and downlink broadband signals of the disclosed satellite distribution system may be divided into a plurality of transponder signals, each having a plurality of individual channels. For example, analog satellite systems operating in the so-called “G-band,” i.e., between about 3.7 GHz and about 4.2 GHz, typically broadcast ten (10)- 500 MHz-wide transponder signals, with each transponder signal further including twelve, 40 MHz-wide analog channels. Satellite systems may also broadcast a set of transponder signals at multiple polarizations, for example, a right-hand circular polarization (RHCP) and a left-hand circular polarization (LHCP), within the band of carrier frequencies associated with the satellite; effectively doubling the number of channels broadcast by the system.

Satellite-based signal distribution systems exist for many frequency bands, including the so-called “Ku-band” which ranges from approximately 12 GHz to approximately 18 GHz. The preferred embodiment of the present invention uses an uplink signal having 16 RHCP transponder signals and 16 LHCP transponder signals modulated into the frequency band between about 17.2 GHz and about 17.7 GHz. Each of these 32 transponder signals includes data packets related to approximately 10 individual television channels associated therewith. The satellites shift the uplink transponder signals to carrier frequencies ranging from approximately 11.7 GHz to approximately 12.2 GHz and transmit these frequency-shifted transponder signals back to earth for reception at each of a plurality of individual receiver stations.

Each receiver station may include an antenna coupled to a STB that is equipped with a digital video recorder (DVR). In another embodiment, the STB may have interface circuitry coupled thereto for connection to an external digital peripheral unit such as a storage medium. The antenna may comprise a parabolic dish antenna such as an outdoor unit (ODU) for example, pointed in the general direction of the transmitting satellite (or other transmitting location) to thereby receive the broadband signal. Such antennas may also include a low-noise block (LNB) downconverter, which filters and shifts the incoming signal to an intermediate frequency band, such as L-band, which is between approximately 1.0 GHz and approximately 2.0 GHz. In one embodiment, the signal received from the satellite is shifted to the frequency band between approximately 950 MHz and approximately 1450 MHz.

Sometimes, only the RHCP transponder signals or the LHCP transponder signals are mixed down to L-band, depending on which channel a user is viewing. However, in systems having a two-channel LNB downconverter, both the RHCP and the LHCP transponder signals are shifted down to L-band and provided, via separate lines, to the receiver station.

Although the present invention will be explained in reference to a STB within a direct broadcast satellite or digital video broadcast (DVB) system, the STB and/or STB-equipped with DVR may function within any of a cable TV, off-air broadcast or other applicable or known and used communication-related and/or wireless digital-TV system.

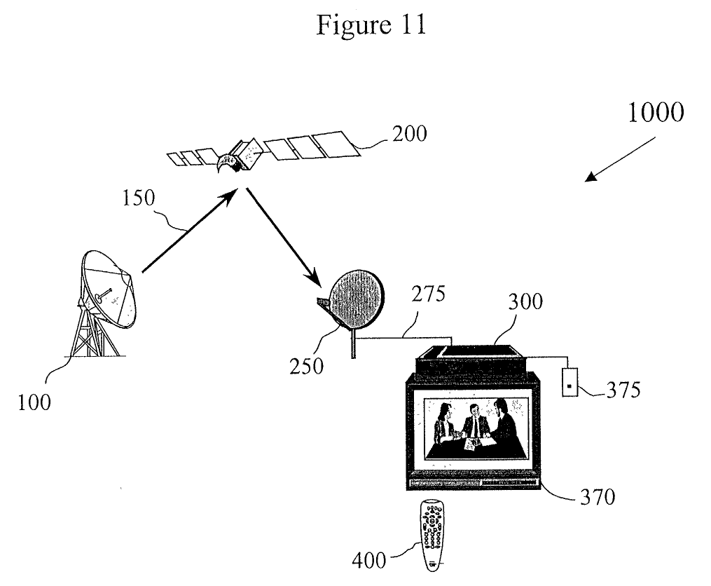

FIG. 11 is an exemplary arrangement of a STB 300 equipped with a DVR within a direct broadcast satellite or digital video broadcast (DVB) system, in accordance with the present invention. In the exemplary embodiment of FIG. 11, the system 1000 may comprise a transmit antenna station (hereinafter referred to as uplink facility 100 for clarity), satellite 200, receive antenna 250 and STB 300 equipped with DVR.

The transmit antenna station may be a DIRECTV(r) satellite uplink facility, for example, or any other earth station as described above and which is well known in the art. The bitstream or airlink 150 is a suitable content signal such as a digital audio and video television data signal (A/V signal), the medium is a satellite 200, and the receive antenna 250 is preferably an outdoor unit (ODU). As illustrated in FIG. 11, the ODU is connected to STB 300 via coaxial cable 275.

In this exemplary embodiment, the DVR of the present invention is included in, or subsumed within STB 300. However, the invention is applicable to any STB having a multiple-processor configuration. STB 300 may further be connected to a display 370, such as a standard definition television, a high definition television or a PC monitor and also may be connected to a telephone line 375. The DVR-equipped STB 300 may be controlled via a remote control 400 as is well known in art, using known RF and/or IR transmission and reception techniques.

The user command interface in the present invention however is not limited to a remote control device. Alternatively, any of function buttons residing on the STB or DVR structure itself, a keyboard operatively connected thereto and/or connected to a PC that is in communication with the STB, USP serial ports, voice-activation software devices within or operatively connected to the STB, or command and/or instructions by remote call-in using DTMF tones for example, may be substituted as the user command interface to the STB or DVR.

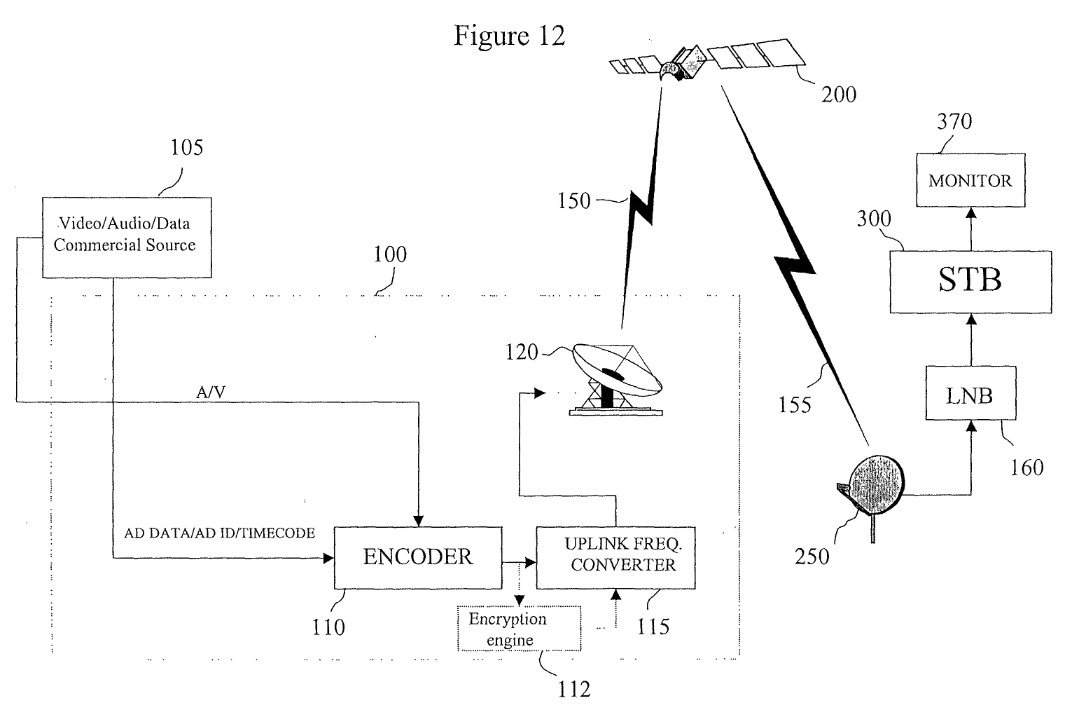

FIG. 12 illustrates the general data flow in a direct broadcast satellite or digital video broadcast system. In operation, the uplink facility 100 can receive video and audio programming from a number of sources, including satellites, terrestrial fiber optics, cable, or tape. Preferably, the received programming signals, along with data signals such as electronic scheduling data and conditional access data, are sent from some commercial source 105 to a video/audio/data encoding system 110 within uplink facility 100. Here, they are digitally encoded and multiplexed into a packetized data stream using a number of conventional algorithms, including convolution error correction and compression, for example.

In a conventional manner, the encoded data stream is modulated and sent through an uplink frequency converter 115 which converts the modulated encoded data stream to a frequency band suitable for reception by the satellite 200. Preferably, the satellite frequency is K-band such as in the Ku-band; however the frequency may be in the Ka band as well. The modulated, encoded data stream is then routed from the uplink frequency converter 115 to an uplink satellite antenna/dish 120, where it is broadcast toward the satellite 200 over the airlink 150. The encoded data stream may be encrypted and encoded, by a suitable encryption engine 112 (dotted lines), or not encrypted and encoded.

The satellite 200 receives the modulated, encoded Ku-band data stream via airlink 150, and re-broadcasts it downward via downlink 155 toward an area on earth that includes the various receiver stations (STB 300, for example). In this embodiment, the satellite dish (ODU 250) of STB 300 shifts the Ku-band signal down to an L-band signal which is transmitted via a LNB downconverter 160 to STB 300, for eventual reproduction on display monitor 370.

Front-end circuitry, which may or may not be part of STB 300, receives the L-band RF signals from the LNB downconverter 160 and converts them back into the original digital data stream. The front-end circuitry may include a tuner. Circuitry (shown and explained in more detail in FIG. 6) receives the original data streams via an input port and performs video/audio processing operations such as de-multiplexing and decompression. The overall operation of STB 300, including the selection of parameters, the set-up and control of components, channel selection, a user's access to different program packages, and many other functions, both real time and non-real time, are controlled by one or more processors within STB 300, as will be further explained below.

As described above, FIG. 6 illustrates an exemplary architecture of the DVR-equipped STB 300 in accordance with the present invention. The STB 300 utilizes a bus 305 to interconnect various components and to provide a pathway for data and control signals.

FIG. 6 illustrates a host processor 310, a memory device 315 (in an exemplary configuration embodied as an SDRAM 315) and a hard disc drive (HDD) 320 connected to the bus 305. In this embodiment, the host processor 310 may also have a direct connection to SDRAM 315 as shown in FIG. 6 (i.e., such that SDRAM 315 is associated as the memory for host processor 310). Although memory device 315 is described as SDRAM 315 hereinafter in the present application, memory devices of EDO RAM (extended data output DRAM), BEDO RAM (Burst EDO RAM), RLDRAM by Rambus, Inc., SLDRAM by the SyncLink Consortium VRAM (video RAM), or any other known or developing memory that is writeable may be sufficient as memory device 315.

As further shown in FIG. 6, a transport processor 330 and PCI I/F 340 (peripheral component interconnect interface) are connected to the bus 305. The transport processor 330 also has a connection to input port 325 and SDRAM 335. SDRAM 335 has the same attributes as SDRAM 315 and may be replaced with any of the other above-noted alternative memory devices. Furthermore, the PCI I/F 340 is connected to a decoder 350. The decoder 350 is connected to a video encoder 360. The output of video encoder 360 is in turn sent to a display device 370. Decoder 350 may include both an MPEG A/V decoder 352 and an AC-3/MPEG audio decoder 356, the output of the latter being sent to display device 370 after conversion in a digital-to-analog converter (DAC) 372.

The host processor 310 may be constructed with conventional microprocessors such as the currently available PENTIUM(r) processors from Intel. Host processor 310 performs non real-time functions in the STB 300, such as graphical-user interface and browser functions. A browser is a software engine that presents the interface to, and interacts with, a user of the STB 300. The browser is responsible for formatting and displaying user-interface components and pictures. Typically, the user interface is displayed as a Graphical User Interface (GUI).

Browsers are often controlled and commanded by the standard HTML language, which is used to position and format the GUI. Additionally, or in the alternative, any decisions and control flow of the GUI that requires more detailed user interaction may be implemented using JavaScript(tm). Both of these languages may be customized or adapted for the specific details of a given STB 300 implementation, and images may be displayed in the browser using well known JPG, GIF and other standardized compression schemes. It is noted that other non-standardized languages and compression schemes may be used for the browser and GUI, such as XML, “home-brew” languages or other known non-standardized languages and schemes.

HDD 320 is actually a specific example of a mass storage device. In other words, the HDD 320 may be replaced with other mass storage devices as is generally known in the art, such as known magnetic and/or optical storage devices, (i.e., embodied as RAM, a recordable CD, a flash card, memory stick, etc.). In an exemplary configuration, HDD 320 may have a capacity of at least about 25 Gbytes, where preferably about at least 20 Gbytes is available for various recording applications, and the remainder flexibly allocated for pause applications in STB 300.

The bus 305 may be implemented with conventional bus architectures such as a peripheral component interconnect (PCI) bus that is standard in many computer architectures. Alternative bus architectures such as VMEBUS(r) from Motorola, NUBUS(r), address data bus, RAM bus, DDR (double data rate) bus, etc., could of course be utilized to implement bus 305.

The transport processor 330 performs real-time functions and operations such as control of the A/V data flow, conditional access, program guide control, etc., and may be constructed with an ASIC (application specific integrated circuit) that contains, for example, a general purpose R3000A MIPS RISC core, with sufficient on-chip instruction cache and data cache memory. Furthermore, the transport processor 330 may integrate system peripherals such as interrupt, timer, and memory controllers on-chip, including ROM, SDRAM, DMA controllers; a packet processor, crypto-logic, PCI compliant PC port, and parallel inputs and outputs. The implementation shown in FIG. 6 actually shows the SDRAM 335 as being separate from the transport processor 330, it being understood that the SDRAM 335 may be dispensed with altogether or consolidated with SDRAM 315. In other words, the SDRAMs 315 and 335 need not be separate devices and can be consolidated into a single SDRAM or other memory device.

The input port 325 receives audiovisual bitstreams that may include, for example, MPEG-1 and MPEG-2 video bitstreams, MPEG-1 layer II audio bitstreams and DOLBY DIGITAL (AC-3) audio bitstreams. Exemplary A/V bitrates may range from about 60 Kbps to 15 Mbps for MPEG video, from about 56-384 Kbps for MPEG audio, and between about 32-640 Kbps for AC-3 audio. The single-stream maximum bitrate for STB 300 may correspond to the maximum bitrate of the input programming, for example 16 Mbps or 2 MBps, which corresponds to the maximum MPEG-2 video bitrate of 15 Mbps, maximum MPEG-1 Layer-2 audio bitrate of 384 kbps, and maximum AC-3 bitrate of 640 kbps.

Any audio or video formats known to one of ordinary skill in the art could be utilized. Although FIG. 6 has been described in conjunction with digital television, the signal supplied could be any type of television signal, any type of audio or video data, or any downloadable digital information. Of course, various other audiovisual bitstream formats and encodation techniques may be utilized in recording. For example, STB 300 may record an AC-3 bitstream, if AC-3 broadcast is present, along with MPEG-1 digital audio. Still further, the received audiovisual data may be encrypted and encoded or not encrypted and encoded. If the audiovisual data input via the input port 325 to the transport processor 330 is encrypted, then the transport processor 330 may perform data decryption and transport processing. Moreover, the decryption may be performed instead by the host processor 310.

As mentioned above, the SDRAMs (315 and 335) may be consolidated or replaced with a single SDRAM or single memory device. The PCI I/F 340 may be constructed with an ASIC that controls data reads from memory. Audiovisual (A/V) data may be sent to the host processor 310's memory while simultaneously being sent to an MPEG A/V decoder 352, as further discussed below.

Decoder 350 may be constructed as shown in FIG. 6 by including the MPEG A/V decoder 352 connected to the PCI I/F 340, as well as an AC-3/MPEG audio decoder 356 which is also connected to the PCI I/F 340. In this way, the video and audio bitstreams from the PCI I/F 340 can be separately decoded by decoders 352 and 356, respectively. Alternatively, a consolidated decoder may be utilized that decodes both video and audio bitstreams together. The encoding techniques are not limited to MPEG and AC-3, of course, and can include any known or future developed encoding technique. In a corresponding manner, the decoder 350 could be constructed to process the selected encodation technique(s) utilized by the particular implementation desired.

In order to more efficiently decode the MPEG bitstream, the MPEG A/V decoder 352 may also include a memory device such as SDRAM 354 connected thereto. This SDRAM 354 may be eliminated, consolidated with decoder 352 or consolidated with the other SDRAMs 315 and/or 335. SDRAM 354 has the same attributes as SDRAM 315 and 335, and may be replaced with any of the other above-noted alternative memory devices.

Video encoder 360 in one embodiment may be an NTSC encoder that encodes, or converts the digital video output from decoder 350 into a coded analog signal for display. Regarding the specifications of the NTSC (National Television Standards Committee) encoder 360, the NTSC is responsible for setting television and video standards in the United States. The NTSC standard for television defines a composite video signal with a refresh rate of 60 half-frames (interlaced) per second. Each frame contains 525 lines and can contain 16 million different colors.

In Europe and the rest of the world, the dominant television standards are PAL (Phase Alternating Line) and SECAM (Sequential Color with Memory). Whereas NTSC delivers 525 lines of resolution at 60 half-frames per second, PAL delivers 625 lines at 50 half-frames per second. Many video adapters or encoders that enable computer monitors to be used as television screens support both NTSC and PAL signals. SECAM uses the same bandwidth as PAL but transmits the color information sequentially. SECAM runs on 625 lines/frame.

Thus, although use of a video encoder 360 is envisioned to encode the processed video for display on display device 370, the present invention is not limited to the NTSC standard encoder. PAL and SECAM encoders may also be utilized. Further, hi-definition television (HDTV) encoders may also be viable to encode the processed video for display on a HDTV, for example.

Display device 370 may be an analog or digital output device capable of handling a digital, decoded output from the video encoder 360. If analog output device(s) are desired, to listen to the output of the AC-3/MPEG audio decoder 356, a digital-to-analog converter (DAC) 372 is connected to the decoder 350. The output from DAC 372 is an analog sound output to display device 370, which may be a conventional television, computer monitor screen, portable display device or other display devices which are known and used in the art. If the output of the AC-3/MPEG audio decoder 356 is to be decoded by an external audio component, a digital audio output interface (not shown) may be included between the AC-3/MPEG audio decoder 356 and display device 370. The interface may be a standard interface known in the art such as a SPDIF audio output interface, for example, and may be used with, or in place of DAC 372, depending on whether the output devices are analog and/or digital display devices.

The video output from video encoder 360 and/or audio from audio decoder 356 or DAC 372 does not necessarily have to be sent to display device 370. Alternatively, encoded A/V data may be output to external devices or systems operatively connected to the STB 300, such an off-broadcast system, cable TV system or other known systems which can reproduce the encoded audio and/or video signals for reproduction and/or display. This may also include a PC that can play video or audio files containing the encoded A/V data sent from the STB 300, for example.

As described above, FIG. 7 illustrates various components that may be provided for the SDRAM 315. As mentioned above, the SDRAM shown in FIG. 6 is actually a specific implementation of a memory device. It is noted that the invention is not limited to this specific implementation of SDRAM 315 and can include any other known or future developed memory technology. Regardless of the technology selected, the memory device 315 may include a buffer space 316 which may be a fixed or virtual set of memory locations that buffers or otherwise temporarily stores audiovisual data. In practice, the video data may be stored separate from the audio data, but it would be possible to intermix these data types depending upon the particular application and coding techniques utilized for the audio and visual data.

The A/V data stored in the buffer space 316 includes one or more start addresses 317 which indicate the beginning memory address at which the audio and/or video data (A/V) is stored. If the A/V data is separately stored, then a plurality of stored addresses will be necessary. Furthermore, if there is more than one set of, or a block of data within the buffer spaces 316, then the start addresses 317 will individually point to each block of data.

The memory device 315 also includes a status word space 318. This status word space includes fixed or virtual addresses at which status words may be stored. An example of a status word that may be stored in the status word space 318 is a status word summarizing the status of a peripheral device. For example, the status word that may be stored within the status word space 318 may include the status of the host processor 310 or transport processor 330. The status word space 318 may also include pointers 319 that point to the start addresses 317 within the buffer space 316.

As further shown in FIG. 7, the SDRAM 315 may connect to the bus 305 via an interface 314. The dash lines indicate that the interface 314 is optional and may or may not be included depending upon the interface requirements of the particular memory device 315 and/or bus 305.

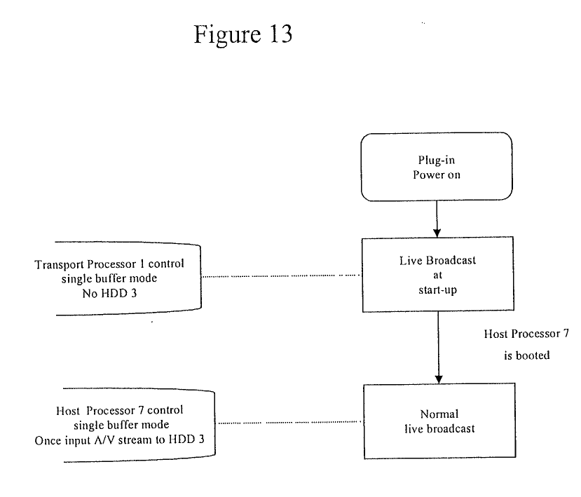

FIG. 13 is a flow chart illustrating the functions of the transport processor 330 and host processor 310 for live broadcast at startup and for a normal live broadcast. In order to overcome possible delay during plug-in power on, two signal flows may be supported for live broadcast, a live broadcast at startup mode and a normal live broadcast mode. For receiving a live broadcast at startup, transport processor 330 controls the input A/V signal flow (which may consist of MPEG-1 and MPEG-2 video bitstreams, MPEG-1 layer II audio bitstreams and digital (AC-3) audio bitstreams for example) received at input port 325. As another function, transport processor 330 may set up PCI I/F 340 for data transfer to downstream decoder or storage components. At this point, SDRAM 315 may operate in what is called a single buffer mode (i.e., HDD 320 is not required for live broadcast at startup).

Further in this mode, transport processor 330 may perform data decrypting and transport processing. For example, the input and already-compressed A/V data of the desired live broadcast may be encrypted. The transport processor contains algorithms that will remove this encryption so that the compressed A/V bit streams may be decoded and displayed on a suitable display device 370. The compressed bit streams are routed to SDRAM 315 via bus 305, and sent to MPEG A/V decoder 352, with the audio portion being sent to AC-3/MPEG audio decoder 356. As previously discussed the decoded video bit streams are converted to analog in video encoder 360 and the decoded audio is converted at DAC 372, prior to display on a suitable display device 370.

Normal live broadcast is effectuated when host processor 310 signifies that it is ready to assume signal flow control from transport processor, which occurs at least after the HDD 320 is ready. Much as when one turns on a laptop or desktop PC, it will take some time (on the order of several seconds to a minute or so, depending on the system load) for the host processor 310 and HDD 320 to go through their respective startup iterations, (i.e., booting-up). There may only be a single input A/V stream in this mode, namely one input stream relative to HDD 320. The compressed bit streams continue to be routed to SDRAM 315 via bus 305. Under the control of host processor 310, the compressed bit streams are transported to HDD 320 for storage (in order to perform various trick modes that are available for live broadcast, simple transitions between modes, etc.) and also conveyed via bus 305 and PCI I/F 340 for decoding prior to display.

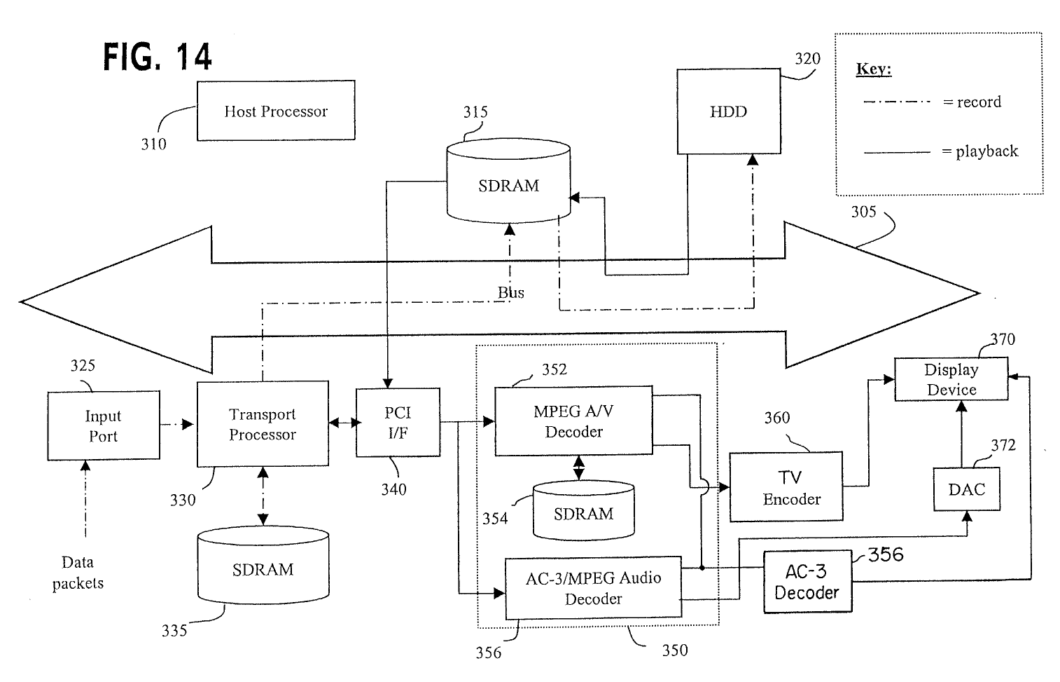

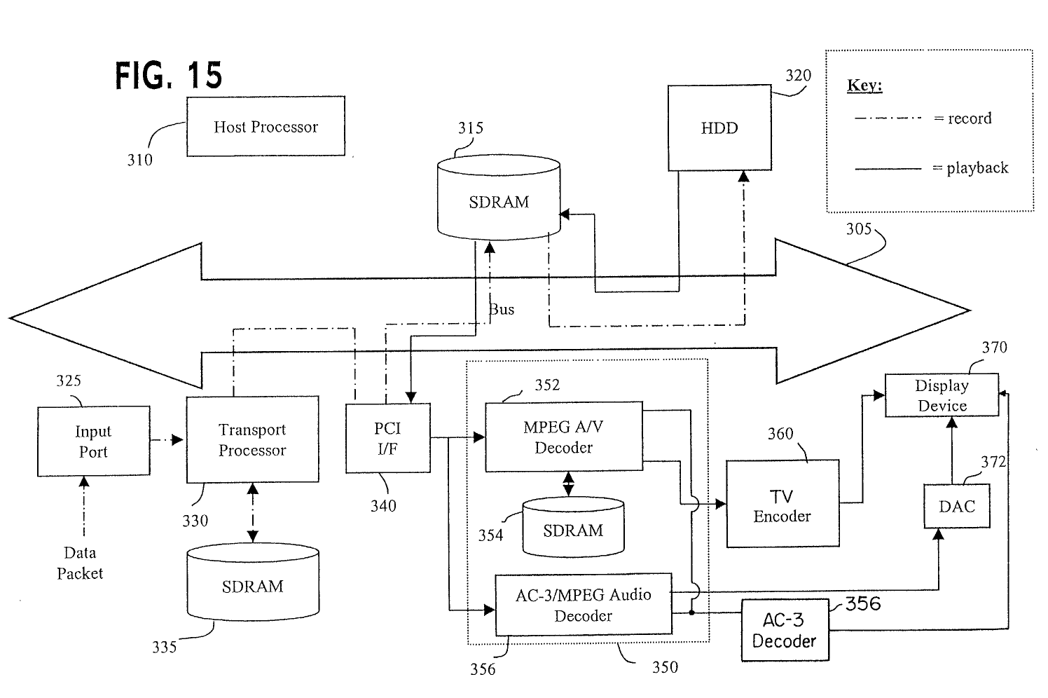

The recording and playback paths of the STB or STB-equipped with DVR is described in accordance with FIGS. 14 and 15. FIG. 14 shows the recording and playback data flows among the various components of the STB 300. Some of the connections between components, and associated reference numerals from FIG. 6 may have been eliminated in FIGS. 14 and 15 in order to highlight the data flow which is shown using dashed lines (see Key) in FIGS. 14 and 15.

As shown in FIG. 14, A/V data of a selected or desired event, program and/or broadcast is received by input port 325. This may be selected by the viewer manipulating or browsing a menu on display device 370 that is displayed via host processor 310 (acting as a browser with GUI, a non-real time function). This may be performed via a remote control device, whereby the user actuates push buttons or function keys to send a command. The command is typically embodied as an RF or IR signal as is well known in the art, to be received by the STB.

Typically the A/V data is received in packetized form and fed to the transport processor 330. The transport processor 330 then transfers the received A/V data (a real-time function) to SDRAM 315. Digital recording is accomplished by the host processor 310, which transfers the A/V data buffered by SDRAM 315 to the HDD 320. In other words, the SDRAM 315 serves as a buffer which buffers data sent by transport processor 330. This allows the host processor 310 to control the recording onto the HDD 320 when host processor 310 time is available. When a sufficient amount of programming data has been accumulated in the SDRAM 315, the host processor 310 transfers the data from the SDRAM 315 to the HDD 320 for recording therein.

FIG. 15 illustrates an alternative signal path for recording. Audiovisual data is fed from the input port 325 to the transport processor 330. The transport processor 330 then transfers the received audiovisual data to the PCI I/F 340, as indicated by the dashed data flow line. The PCI I/F 340 receives audiovisual data from the transport processor 330 via bus 305, and sends this data to host processor 310, more particularly to SDRAM 315.

Digital recording is accomplished similarly, with SDRAM 315 serving as a buffer that buffers data sent by the PCI I/F 340. This allows the host processor 310 to control the recording (a non-real time function) onto the HDD 320 when processor time is available. When a sufficient amount of A/V data has been accumulated in the SDRAM 315, the host processor 310 transfers the data from the SDRAM 315 to the HDD 320 for recording therein. To record data, the host processor 310 may also inform the PCI I/F 340 of available start addresses in the SDRAM buffer space 315 to which data may be buffered for eventual recording in HDD 320.

The operation of playing back the recorded A/V data that represents a stored event, program, broadcast, etc. in STB 300 is now described. Referring again to FIG. 14, when the viewer turns the STB 300 on, the viewer is given the option to playback any of the previously recorded programs, events, broadcast, etc. This may be done by using remote control or other suitable user command interface as described above (not shown) to access a menu on display device 370. If the viewer selects a desired event, the corresponding A/V data (which typically may also include system time stamps and conditional access packets within the A/V data that are recorded in HDD 320) are retrieved from HDD 320.

In particular, when the user selects the playback option, the selected A/V data recorded on HDD 320 is sent via bus 305 to a queue in SDRAM 315. Next, the buffered data is sent from SDRAM 315 via bus 305 to transport processor 330, back to bus 305 and then to PCI I/F 340, which in turn sends the selected A/V data to decoder 350. Any conditional access is removed (decrypted) by transport processor 330 before the data is then sent to decoder 350. Conditional access packets are used to decrypt the audio and video data in transport processor 330, with the decrypted data being sent to decoder 350 via PCI I/F 340. More specifically, the video portion of the bitstream is sent to MPEG A/V decoder 352, with the audio portion being sent to AC-3/MPEG audio decoder 356.

Transport processor 330 and decoder 350 (in particular MPEG A/V decoder 352), use the recorded time stamps to recreate the original transmission timing of the data. Within decoder 350, MPEG A/V decoder 352 may be provided with an SDRAM 354 in order to more efficiently decode the MPEG bitstream received from PCI I/F 340. SDRAM 354 is similar to SDRAM 315 discussed above in its construction. SDRAM 354 temporarily holds the encoded video bitstream data, and also provides the three frame buffers required for MPEG decoding, as is known in the art. Thereafter, the decoded A/V data is output to video encoder 360 for conversion to an analog format, so that it may be displayed on display device 370. From this point on, the playback data looks, for all intents and purposes, identical to the originally recorded event, program, broadcast, etc.

Therefore, the present invention provides a digital STB 300 having multiple processors for performing specified tasks. A transport processor 330 performs essentially all of the real time operations, such as control of a data pipeline to the STB, and conditional access, for example. A host processor 310 controls essentially all non-real time functions that are executed within the STB, such as presentation of a graphical user interface (GUI), browser functions, and general interaction with a user of the STB. The STB may be equipped with or embodied as a digital video recorder (DVR) with multiple processors therein, and may be operatively connected to, or embodied within, a digital satellite broadcast system, direct video broadcast system, cable TV system, off-air broadcast system or other known broadcast system.

The addition of one or more processors increases the available system bandwidth of the STB 300. The separate processors executing code in separated memories and/or segmented memory segments, in accordance with the present invention, may also increase system security. Further, the present invention provides greater stability in that if incorrect code or unexpected circumstances disrupt the operation of one processor in the STB or DVR, another processor may continue operation unaffected by the disrupted processor. Moreover, the modular separation between processors encourages the implementation of well-defined interfaces between the various operations running on the STB platform.

The invention being thus described, it will be obvious that the same may be varied in many ways. For example, the present invention has been described in terms of a STB or STB-equipped with DVR having two processors. However, for extended functionality in which a plurality of channels generating a plurality of A/V streams to the input port 325 the bandwidth and processors should be able to handle N simultaneous data streams. To provide such bandwidth, transport processors 330 could be duplicated.

As described above, the functional blocks in FIGS. 6-7 and 13-15 may be implemented in hardware and/or software. The hardware/software implementations may include a combination of processor(s) and article(s) of manufacture. The article(s) of manufacture may further include storage media and executable computer program(s). The executable computer program(s) may include the instructions to perform the described operations. The computer executable program(s) may also be provided as part of externally supplied propagated signal(s). Furthermore, the inventive apparatus may be embodied as a variety of ways. A STB 300 is just one example. Other examples include a personal computer (PC), TV or hardware card that is added to an existing apparatus such as a conventional STB, PC or TV. Still further, the inventive functionality may be downloaded or otherwise programmed into a STB, PC or TV. Such variations are not to be regarded as departure from the spirit and scope of the invention, and all such modifications as would be obvious to one skilled in the art are intended to be included within the scope of the following claims.

In accordance with the status display apparatus and method of the present invention, an STB equipped with a digital video recording device such as a digital video recorder (DVR) may have a plurality of status parameters that can be viewed and/or manipulated by a user on a screen of a display. The display may be of a status menu or status guide that is depicted on a TV or other display device, effected via a user command interface to the DVR, such as by operation of a remote control device to send commands to a processor within the DVR, for example, and manipulated via a graphical user interface (GUI) controlled by the processor.

Status parameters or features related to DVR functionality or operability may be accessed, displayed for viewing and/or manipulated by the user or viewer. These features may include current delay of recording behind live feed, live/recorded status indicator, mass storage device capacity (Disk Gas Gauge) of a mass storage device that is operatively connected to the STB equipped with DVR--and/or a display of remaining recording time available in minutes, for example, various out-of-disk space alerts, program length versus recording time available data, and other file attributes.

The current delay feature allows the user to see how far the recording is behind a live feed when pausing a signal of the live feed or broadcast. The live/recorded status indicator may be displayed to indicate whether material a viewer is watching is LIVE (a live feed) or RECORDED. In an embodiment, the live/recorded status indicator may flash LIVE or RECORDED on an output device.

The Disk Gas Gauge feature may indicate the percent of a mass storage device or storage medium that has been consumed by recorded material, and/or the amount of remaining time available for recording (in minutes, for example). These status parameters may be displayed numerically in conjunction with an icon or other uniquely shaped feature or figure on a specified area of a video monitor, TV or other display device operatively connected to the DVR for example. In fact, the various status parameters associated with the Disk Gas Gauge and other status parameters described herein may be displayed as any of an icon, animated icon, flashing text or figures, pie-chart, bar graph or other known or used graphical objects consistent with what is known in the art.

Additionally, as percent of storage consumed by recorded material reaches lower levels, different video icons/shapes may be displayed to visually alert the viewer, and are hereinafter collectively termed as “out-of-disk space alerts”. For an out-of-disk space alert, the user may receive a notification indicating the approximate minutes of recording time still available while recording is in progress. In another embodiment, if the program length is greater than the amount of unused storage space available, the user may receive a notification indicating such, as well as the recording time available, prior to or at the start of the recording.

Further, other file attributes of the DVR may be selected via the GUI. These may include the date a program is recorded, the latest or last date a stored program has been accessed, size of a recorded or live program in Mbytes, length of a live or recorded program in minutes, implementation of a protect feature to prevent erasure of a recorded program, save options designating how much of a program is to be recorded and/or how long of a time a program is to be stored before being erased, and implementation of a hidden file feature to prevent titles of certain programs, such as those of an explicit nature, for example, from being displayed within the program guide.

Therefore, the present invention enables a viewer to be provided with a display of the aforementioned status parameters of his or her own set-top box STB equipped with DVR, within a direct broadcast satellite or digital video broadcast (DVB) system. Accordingly, the viewer may be able to have a better understanding of what programs he or she may be able to record, or be alerted that some of the previously recorded material may have to be erased in order to provide room for recording a desired event, program or broadcast that exceeds to current storage capacity of a mass storage device. As will be explained in further detail later in this disclosure, the user or viewer simply sends commands to a processor within the STB equipped with DVR in order to display the desired status parameter(s). Moreover, a menu screen of status parameters or status program guide may be displayed, providing a plurality of status parameter options or data available for selection by the user.

However, before describing the above features in greater detail, the inventors offer a general discussion on the overall satellite-based distribution system envisioned for the present invention, and more specifically discuss a set-top box (STB) equipped with a digital video recorder (DVR) within a direct broadcast satellite or digital video broadcast (DVB) system. Additionally, the basic architecture and operation of the STB-equipped with DVR is explained in order to provide a context for the status display method and apparatus of the invention, which enable a viewer to monitor various functions or parameters of a STB-equipped with DVR on a display device operatively connected thereto.

In general, television signal distribution systems generally rely on either a cable network or on free-space propagation for delivering television signals to individual users or subscribers. Cable-based television systems transmit one or more individual television signals or “channels” over wire, while free-space propagation systems transmit one or more channels over-the-air, i.e., in a wireless manner. Most large-scale cable and wireless television signal distribution systems broadcast a broadband television signal having a plurality of individual television signals or channels modulated onto one or more carrier frequencies within a discernable frequency band.

Some wireless television signal distribution systems use one or more geo-synchronous satellites to broadcast a broadband television signal to receiver units within a large geographic area, while other wireless systems are land-based, using one or more transmitters located within smaller geographic areas to broadcast to individual receiver units within those geographic areas. An example of a land-based “cellular” type television signal distribution system is disclosed in Bossard, U.S. Pat. No. 4,747,160. This system includes multiple television signal transmitting stations, each of which transmits a television signal to individual receivers spread throughout a limited geographic region, and is configured so that adjacent transmitting stations use modulation and frequency diversity to prevent interference.

Some cellular systems, such as those commonly referred to as LMDS (local multi-point distribution system) and MMDS (multi-channel, multi-point distribution system), use a land-based cellular-type transmitting setup to rebroadcast satellite signals at frequencies different than the frequencies used by the satellite. Each of the transmitters of an LMDS system typically transmits within a one to five mile radius cell while each of the transmitters of an MMDS system typically transmits within an approximately 30 -mile radius cell.

The present invention may be embodied in a satellite-based distribution system. The system generally includes an earth station that compiles a number of programs (video and audio) into a broadband signal, modulates a carrier frequency band with the broadband signal and then transmits (uplinks) the modulated signal to a geosynchronous satellite via a transmit antenna. The satellite amplifies the received signal, shifts the signal to a different carrier frequency band and transmits (downlinks) the frequency shifted signal to earth for reception at individual receiver stations.

The uplink and downlink broadband signals of the disclosed satellite distribution system may be divided into a plurality of transponder signals, each having a plurality of individual channels. For example, analog satellite systems operating in the so-called “G-band,” i.e., between about 3.7 GHz and about 4.2 GHz, typically broadcast ten (10)- 500 MHz-wide transponder signals, with each transponder signal further including twelve, 40 MHz-wide analog channels. Satellite systems may also broadcast a set of transponder signals at multiple polarizations, for example, a right-hand circular polarization (RHCP) and a left-hand circular polarization (LHCP), within the band of carrier frequencies associated with the satellite; effectively doubling the number of channels broadcast by the system.

Satellite-based signal distribution systems exist for many frequency bands, including the so-called “Ku-band” which ranges from approximately 12 GHz to approximately 18 GHz. The preferred embodiment of the present invention uses an uplink signal having 16 RHCP transponder signals and 16 LHCP transponder signals modulated into the frequency band between about 17.2 GHz and about 17.7 GHz. Each of these 32 transponder signals includes data packets related to approximately 10 individual television channels associated therewith. The satellites shift the uplink transponder signals to carrier frequencies ranging from approximately 11.7 GHz to approximately 12.2 GHz and transmit these frequency-shifted transponder signals back to earth for reception at each of a plurality of individual receiver stations.

Each receiver station may include an antenna coupled to an STB that is equipped with a digital video recorder (DVR). In another embodiment, the STB may have interface circuitry coupled thereto for connection to an external digital peripheral unit such as a storage medium.

The antenna may comprise a parabolic dish antenna such as an outdoor unit (ODU) for example, pointed in the general direction of the transmitting satellite (or other transmitting location) to thereby receive the broadband signal. Such antennas may also include a low-noise block (LNB) downconverter, which filters and shifts the incoming signal to an intermediate frequency band, such as L-band, which is between approximately 1.0 GHz and approximately 2.0 GHz. In one embodiment, the signal received from the satellite is shifted to the frequency band between approximately 950 MHz and approximately 1450 MHz.

Sometimes, only the RHCP transponder signals or the LHCP transponder signals are mixed down to L-band, depending on which channel a user is viewing. However, in systems having a two-channel LNB downconverter, both the RHCP and the LHCP transponder signals are shifted down to L-band and provided, via separate lines, to the receiver station.

Although the present invention will be explained in reference to a STB within a direct broadcast satellite or digital video broadcast (DVB) system, the STB and/or STB-equipped with DVR may function within any of a cable TV, off-air broadcast or other applicable or known and used communication-related and/or wireless digital-TV system.

As described above, FIG. 11 is an exemplary arrangement of a STB 300 equipped with a DVR within a direct broadcast satellite or digital video broadcast (DVB) system, in accordance with the present invention. In the exemplary embodiment of FIG. 11, the system 1000 may comprise a transmit antenna station (hereinafter referred to as uplink facility 100 for clarity), satellite 200, receive antenna 250 and STB 300 equipped with DVR.

The transmit antenna station may be a DIRECTV satellite uplink facility, for example, or any other earth station, broadcast cable or broadband transmission system or facility as is known in the art. The bitstream (airlink 150) is a suitable content signal such as a digital audio and video television data signal (A/V signal), the medium is a satellite 200, and the receive antenna 250 is preferably an outdoor unit (ODU). As illustrated in FIG. 1, the ODU is connected to STB 300 via coaxial cable 275.

In this exemplary embodiment, the DVR of the present invention is included in, or subsumed within STB 300. However, the invention is applicable to any STB having a multiple-processor configuration. STB 300 may further be connected to a display 370, such as a standard definition television, a high definition television or a PC monitor and also may be connected to a telephone line 375. The DVR-equipped STB 300 may be controlled via a remote control 400 as is well known in art, using known RF and/or IR transmission and reception techniques.

The user command interface in the present invention however is not limited to a remote control device. Alternatively, any of function buttons residing on the STB or DVR structure itself, a keyboard operatively connected thereto and/or connected to a PC that is in communication with the STB, USP serial ports, voice-activation software devices within or operatively connected to the STB, or command and/or instructions by remote call-in using DTMF tones for example, may be substituted as the user command interface to the STB or DVR.

As described above, FIG. 12 illustrates the general data flow in a direct broadcast satellite or digital video broadcast system. In operation, the uplink facility 100 can receive video and audio programming from a number of sources, including satellites, terrestrial fiber optics, cable, or tape. Preferably, the received programming signals, along with data signals such as electronic scheduling data and conditional access data, are sent from some commercial source 105 to a video/audio/data encoding system 10 within uplink facility 100. Here, they are digitally encoded and multiplexed into a packetized data stream using a number of conventional algorithms, including convolution error correction and compression, for example.

In a conventional manner, the encoded data stream is modulated and sent through an uplink frequency converter 115 which converts the modulated encoded data stream to a frequency band suitable for reception by the satellite 200. Preferably, the satellite frequency is K-band such as in the Ku-band; however the frequency may be in the Ka band as well. The modulated, encoded data stream is then routed from the uplink frequency converter 115 to an uplink satellite antenna/dish 120, where it is broadcast toward the satellite 200 over the airlink 150. The encoded data stream may be encrypted and encoded, by a suitable encryption engine 112 (dotted lines), or not encrypted and encoded.

The satellite 200 receives the modulated, encoded Ku-band data stream via airlink 150, and re-broadcasts it downward via downlink 155 toward an area on earth that includes the various receiver stations (STB 300, for example). In this embodiment, the satellite dish (ODU 250) of STB 300 shifts the Ku-band signal down to an L-band signal which is transmitted via a LNB downconverter 160 to STB 300, for eventual reproduction on display monitor 370.

Front-end circuitry, which may or may not be part of STB 300, receives the L-band RF signals from the LNB downconverter 160 and converts them back into the original digital data stream. The front-end circuitry may include a tuner. Circuitry (shown and explained in more detail in FIG. 6) receives the original data streams via an input port and performs video/audio processing operations such as de-multiplexing and decompression. The overall operation of STB 300, including the selection of parameters, the set-up and control of components, channel selection, a user's access to different program packages, and many other functions, both real time and non-real time, are controlled by one or more processors within STB 300, as will be further explained below.

As described above, FIG. 6 illustrates an exemplary architecture of the STB 300 that is capable of performing background caching of encrypted programing for later playback in accordance with the present invention. The STB 300 utilizes a bus 305 to interconnect various components and to provide a pathway for data and control signals.

FIG. 6 illustrates a host processor 310, a memory device 315 (in an exemplary configuration embodied as an SDRAM 315) and a hard disc drive (HDD) 320 connected to the bus 305. In this embodiment, the host processor 310 may also have a direct connection to SDRAM 315 as shown in FIG. 6 (i.e., such that SDRAM 315 is associated as the memory for host processor 310). Although memory device 315 is described as SDRAM 315 hereinafter in the present application, memory devices of EDO RAM (extended data output DRAM), BEDO RAM (Burst EDO RAM), RLDRAM by Rambus, Inc., SLDRAM by the SyncLink Consortium, VRAM (video RAM), or any other known or developing memory that is writeable may be sufficient as memory device 315.

As further shown in FIG. 6, a transport processor 330 and PCI I/F 340 (peripheral component interconnect interface) are connected to the bus 305. The transport processor 330 also has a connection to input port 325 and SDRAM 335. SDRAM 335 has the same attributes as SDRAM 315 and may be replaced with any of the other above-noted alternative memory devices. Furthermore, the PCI I/F 340 is connected to a decoder 350. The decoder 350 is connected to a video encoder 360. The output of video encoder 360 is in turn sent to a display device 370. Decoder 350 may include both an MPEG A/V decoder 352 and an AC-3/MPEG audio decoder 356, the output of the latter being sent to display device 370 after conversion in a digital-to-analog converter (DAC) 372.

The host processor 310 may be constructed with conventional microprocessors such as the currently available PENTIUM processors from Intel. Host processor 310 performs non real-time functions in the STB 300, such as graphical-user interface and browser functions. A browser is a software engine that presents the interface to, and interacts with, a user of the STB 300. The browser is responsible for formatting and displaying user-interface components and pictures. Typically, the user interface is displayed as a Graphical User Interface (GUI).

Browsers are often controlled and commanded by the standard HTML language, which is used to position and format the GUI. Additionally, or in the alternative, any decisions and control flow of the GUI that requires more detailed user interaction may be implemented using JavaScript(tm). Both of these languages may be customized or adapted for the specific details of a given STB 300 implementation, and images may be displayed in the browser using well known JPG, GIF and other standardized compression schemes. It is noted that other non-standardized languages and compression schemes may be used for the browser and GUI, such as XML, “home-brew” languages or other known non-standardized languages and schemes.

HDD 320 is actually a specific example of a mass storage device. In other words, the HDD 320 may be replaced with other mass storage devices as is generally known in the art, such as known magnetic and/or optical storage devices, (i.e., embodied as RAM, a recordable CD, a flash card, memory stick, etc.). In an exemplary configuration, HDD 320 may have a capacity of at least about 25 Gbytes, where preferably about at least 20 Gbytes is available for various recording applications, and the remainder flexibly allocated for pause applications in STB 300.

The bus 305 may be implemented with conventional bus architectures such as a peripheral component interconnect (PCI) bus that is standard in many computer architectures. Alternative bus architectures such as VMEBUS from Motorola, NUBUS, address data bus, RAM bus, DDR (double data rate) bus, etc., could of course be utilized to implement bus 305.

The transport processor 330 performs real-time functions and operations such as control of the A/V data flow, conditional access, program guide control, etc., and may be constructed with an ASIC (application specific integrated circuit) that contains, for example, a general purpose R3000A MIPS RISC core, with sufficient on-chip instruction cache and data cache memory. Furthermore, the transport processor 330 may integrate system peripherals such as interrupt, timer, and memory controllers on-chip, including ROM, SDRAM, DMA controllers; a packet processor, crypto-logic, PCI compliant PC port, and parallel inputs and outputs. The implementation shown in FIG. 6 actually shows the SDRAM 335 as being separate from the transport processor 330, it being understood that the SDRAM 335 may be dispensed with altogether or consolidated with SDRAM 315. In other words, the SDRAMs 315 and 335 need not be separate devices and can be consolidated into a single SDRAM or other memory device.

The input port 325 receives audiovisual bitstreams that may include, for example, MPEG-1 and MPEG-2 video bitstreams, MPEG-1 layer II audio bitstreams and DOLBY DIGITAL (AC-3) audio bitstreams. Exemplary A/V bitrates may range from about 60 Kbps to 15 Mbps for MPEG video, from about 56-384 Kbps for MPEG audio, and between about 32-640 Kbps for AC-3 audio. The single-stream maximum bitrate for STB 300 may correspond to the maximum bitrate of the input programming, for example 16 Mbps or 2 MBps, which corresponds to the maximum MPEG-2 video bitrate of 15 Mbps, maximum MPEG-1 Layer-2 audio bitrate of 384 kbps, and maximum AC-3 bitrate of 640 kbps.

Any audio or video formats known to one of ordinary skill in the art could be utilized. Although FIG. 6 has been described in conjunction with digital television, the signal supplied could be any type of television signal, any type of audio or video data, or any downloadable digital information. Of course, various other audiovisual bitstream formats and encoding techniques may be utilized in recording. For example, STB 300 may record an AC-3 bitstream, if AC-3 broadcast is present, along with MPEG-1 digital audio. Still further, the received audiovisual data may be encrypted and encoded or not encrypted and encoded. If the audiovisual data input via the input port 325 to the transport processor 330 is encrypted, then the transport processor 330 may perform decryption. Moreover, the decryption may be performed instead by the host processor 310.

Alternatively, the host processor 310 and transport processor 330 may be integrated or otherwise replaced with a single processor. As mentioned above, the SDRAMs (315 and 335) may be consolidated or replaced with a single SDRAM or single memory device.

The PCI I/F 340 may be constructed with an ASIC that controls data reads from memory. Audiovisual (A/V) data may be sent to the host processor 310's memory (SDRAM 315) while simultaneously being sent to an MPEG A/V decoder 352, as further discussed below.

Decoder 350 may be constructed as shown in FIG. 6 by including the MPEG A/V decoder 352 connected to the PCI I/F 340, as well as an AC-3/MPEG audio decoder 356 which is also connected to the PCI I/F 340. In this way, the video and audio bitstreams from the PCI I/F 340 can be separately decoded by decoders 352 and 356, respectively. Alternatively, a consolidated decoder may be utilized that decodes both video and audio bitstreams together. The encoding techniques are not limited to MPEG and AC-3, of course, and can include any known or future developed encoding technique. In a corresponding manner, the decoder 350 could be constructed to process the selected encoding technique(s) utilized by the particular implementation desired.

In order to more efficiently decode the MPEG bitstream, the MPEG A/V decoder 352 may also include a memory device such as SDRAM 354 connected thereto. This SDRAM 354 may be eliminated, consolidated with decoder 352 or consolidated with the other SDRAMs 315 and/or 335. SDRAM 354 has the same attributes as SDRAM 315 and 335, and may be replaced with any of the other above-noted alternative memory devices.

Video encoder 360 is preferably an NTSC encoder that encodes, or converts the digital video output from decoder 350 into a coded analog signal for display. Regarding the specifications of the NTSC (National Television Standards Committee) encoder 360, the NTSC is responsible for setting television and video standards in the United States. The NTSC standard for television defines a composite video signal with a refresh rate of 60 half-frames (interlaced) per second. Each frame contains 525 lines and can contain 16 million different colors.

In Europe and the rest of the world, the dominant television standards are PAL (Phase Alternating Line) and SECAM (Sequential Color with Memory). Whereas NTSC delivers 525 lines of resolution at 60 half-frames per second, PAL delivers 625 lines at 50 half-frames per second. Many video adapters or encoders that enable computer monitors to be used as television screens support both NTSC and PAL signals. SECAM uses the same bandwidth as PAL but transmits the color information sequentially. SECAM runs on 625 lines/frame.

Thus, although use of a video encoder 360 is envisioned to encode the processed video for display on display device 370, the present invention is not limited to the NTSC standard encoder. PAL and SECAM encoders may also be utilized. Further, hi-definition television (HDTV) encoders may also be viable to encode the processed video for display on a HDTV, for example.

Display device 370 may be an analog or digital output device capable of handling a digital, decoded output from the video encoder 360. If analog output device(s) are desired, to listen to the output of the AC-3/MPEG audio decoder 356, a digital-to-analog converter (DAC) 372 is connected to the decoder 350. The output from DAC 372 is an analog sound output to display device 370, which may be a conventional television, computer monitor screen, portable display device or other display devices which are known and used in the art. If the output of the AC-3/MPEG audio decoder 356 is to be decoded by an external audio component, a digital audio output interface (not shown) may be included between the AC-3/MPEG audio decoder 356 and display device 370. The interface may be a standard interface known in the art such as a SPDIF audio output interface, for example, and may be used with, or in place of DAC 372, depending on whether the output devices are analog and/or digital display devices.

The video output from video encoder 360 and/or audio output from audio decoder 356 or DAC 372 does not necessarily have to be sent to display device 370. Alternatively, encoded A/V data may be output to external devices or systems operatively connected to the STB 300, such an off-broadcast system, cable TV system or other known systems which can reproduce the encoded audio and/or video signals for reproduction and/or display. This may also include a PC that can play video or audio files containing the encoded A/V data sent from the STB 300, for example.

As described above, FIG. 7 illustrates various components that may be provided for the SDRAM 315. As mentioned above, the SDRAM shown in FIG. 6 is actually a specific implementation of a memory device. It is noted that the invention is not limited to this specific implementation of SDRAM 315 and can include any other known or future developed memory technology. Regardless of the technology selected, the memory device 315 may include a buffer space 316 which may be a fixed or virtual set of memory locations that buffers or otherwise temporarily stores audiovisual data. In practice, the video data may be stored separate from the audio data, but it would be possible to intermix these data types depending upon the particular application and coding techniques utilized for the audio and visual data.

The audio visual data stored in the buffer space 316 includes one or more start addresses 317 which indicate the beginning memory address at which the audio and/or video data (A/V) is stored. If the A/V data is separately stored, then a plurality of stored addresses will be necessary. Furthermore, if there is more than one set of, or a block of data within the buffer space 316, then the start addresses 317 will individually point to each block of data.

The memory device 315 also includes a status word space 318. This status word space includes fixed or virtual addresses at which status words may be stored. An example of a status word that may be stored in the status word space 318 is a status word summarizing the status of a peripheral device. For example, the status word that may be stored within the status word space 318 may include the status of the host processor 310 or transport processor 330. The status word space 318 may also include pointers 319 that point to the start addresses 317 within the buffer space 316.

As further shown in FIG. 7, the SDRAM 315 may connect to the bus 305 via an interface 314. The dash lines indicate that the interface 314 is optional and may or may not be included depending upon the interface requirements of the particular memory device 315 and/or bus 305.

The recording and playback paths of the STB 300 are described in accordance with FIGS. 8 and 9. FIG. 8 shows the recording and playback data flows among the various components of the STB 300. Some of the connections between components, and associated reference numerals from FIG. 6 may have been eliminated in FIGS. 8 and 9 in order to highlight the data flow which is shown using dashed lines (see Key) in FIGS. 8 and 9.

As shown in FIG. 8, A/V data of a selected or desired event, program and/or broadcast is received by input port 325 (typically the data is received in packetized and encrypted form) and fed to the transport processor 330. The transport processor 330 then transfers the received A/V data to SDRAM 315. Digital recording is accomplished by the host processor 310, which transfers the A/V data buffered by SDRAM 315 to the HDD 320. In other words, the SDRAM 315 serves as a buffer that buffers data sent by transport processor 330. This allows the host processor 310 to control the recording onto the HDD 320 when host processor 310 time is available. When a sufficient amount of programming data has been accumulated in the SDRAM 315, the host processor 310 transfers the data from the SDRAM 315 to the HDD 320 for recording therein.

FIG. 9 illustrates an alternative signal path for recording. Audiovisual data is fed from the input port 325 to the transport processor 330. The transport processor 330 then transfers the received audiovisual data to the PCI I/F 340, as indicated by the dashed data flow line. The PCI I/F 340 receives audiovisual data from the transport processor 330 via bus 305, and sends this data to host processor 310, more particularly to SDRAM 315.

Digital recording is accomplished similarly, with SDRAM 315 serving as a buffer that buffers data sent by the PCI I/F 340. This allows the host processor 310 to control the recording onto the HDD 320 when processor time is available. When a sufficient amount of A/V data has been accumulated in the SDRAM 315, the host processor 310 transfers the data from the SDRAM 315 to the HDD 320 for recording therein. To record data, the host processor 310 may also inform the PCI I/F 340 of available start addresses in the SDRAM buffer space 315 to which data may be buffered for eventual recording in HDD 320.

The operation of playing back the recorded A/V data that represents a stored event, program, broadcast, etc. in STB 300 is now described. Referring again to FIG. 8, when the viewer turns the STB 300 on, the viewer is given the option to playback any of the previously recorded programs, events, broadcast, etc. This may be done, for example, by using a remote control or other suitable user command interface (not shown) to access a menu on display device 370. If the viewer selects a desired event, the corresponding A/V data (which typically may also include system time and conditional access packets) are retrieved from HDD 320.

In particular, when the user selects the playback option, the selected A/V data recorded on HDD 320 is sent via bus 305 to a queue in SDRAM 315. Next, the buffered data is sent from SDRAM 315 via bus 305 to transport processor 330, back to bus 305 and then to PCI I/F 340, which in turn sends the selected A/V data to decoder 350. More specifically, the video portion of the bitstream is sent to MPEG A/V decoder 352, with the audio portion being sent to AC-3/MPEG audio decoder 356.

Within decoder 350, MPEG A/V decoder 352 may be provided with an SDRAM 354 in order to more efficiently decode the MPEG bitstream received from PCI I/F 340. SDRAM 354 is similar to SDRAM 315 discussed above in its construction. SDRAM 354 temporarily holds the encoded video bitstream data, and also provides the three frame buffers required for MPEG decoding, as is known in the art. Thereafter, the decoded A/V data is output to video encoder 360 for conversion to an analog format, so that it may be displayed on display device 370. From this point on, the playback data looks, for all intents and purposes, identical to the originally recorded event, program, broadcast, etc.

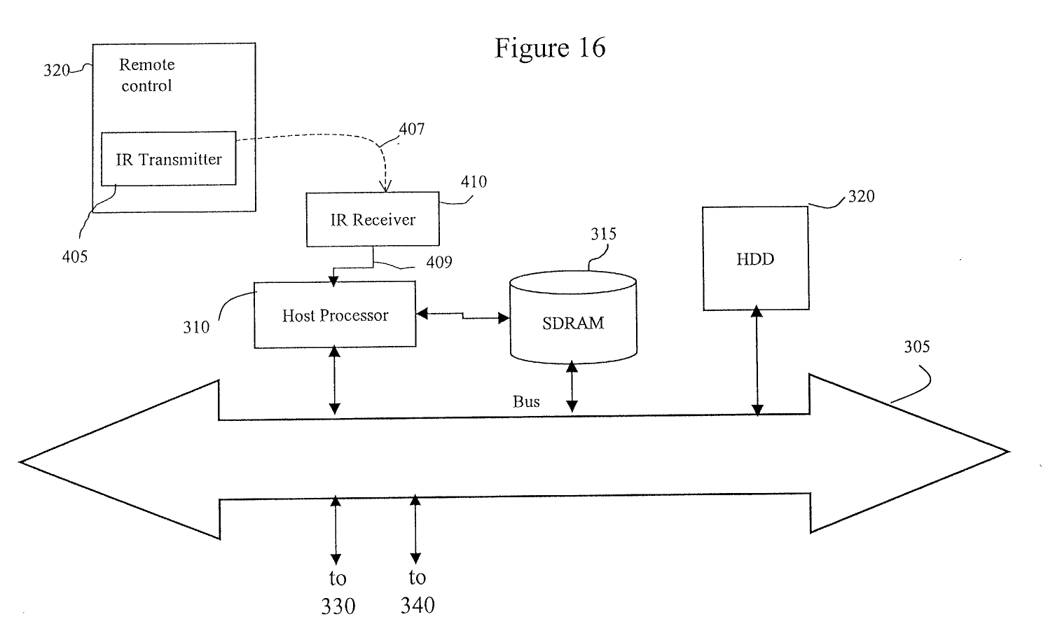

The architecture of the STB 300 and the operations of recording and playback having been described, a status display apparatus and status display method for the STB 300 equipped with DVR are now explained in light of the above description. FIG. 16 illustrates a partial block diagram of FIG. 6, so as to show an exemplary communication path between a remote control device and the host processor of the STB 300. In FIG. 16, there is illustrated a remote control device 400 which is in communication with the host processor 310. The remote control device may be a device that is specific to the STB 300, and/or may be a universal remote control device which controls various individual components connected within a home entertainment system (TV, stereo, tape deck, DVD player, CD player, STB, etc.)

As is well known in the art, the remote control device 400 may include a remote control transmitter 405 therein for transmitting various key or pushbutton-associated signals (commands) selected by the viewer or user. These are sent in the form of AN infrared (IR) ray signal 407 for example, to the STB 300, and in particular to an IR receiver 410 that may be operatively connected to host processor 310. IR receiver 410 decodes the received infrared ray signal 407, such as by photoelectric conversion for example, and sends a system drive signal 409 (which is preferably a digital signal) to host processor 310. The host processor 310 thus analyzes composed code information (i.e., the command data generated by the user) corresponding to the received system drive signal 409. This may be a command to display a desired status parameter or status feature, for example.

Although the above communication path and interface to the STB 300 is explained with regard to using a remote control device, commands and/or processing necessary to display status parameters may also be initiated by a user actuating buttons, switches and/or keys that may be provided on, and integral with STB 300. Moreover, these buttons, switches and/or keys may interact with software or package programs within STB 300 (i.e., provided within SDRAM 315, HDD 320 or as part of host processor 310) in order to effect display of a status parameter on a screen of a device. These alternative interfaces provide redundancy for the viewer, as well as alternative means to display a status parameter or function of STB 300 on a display device 370.

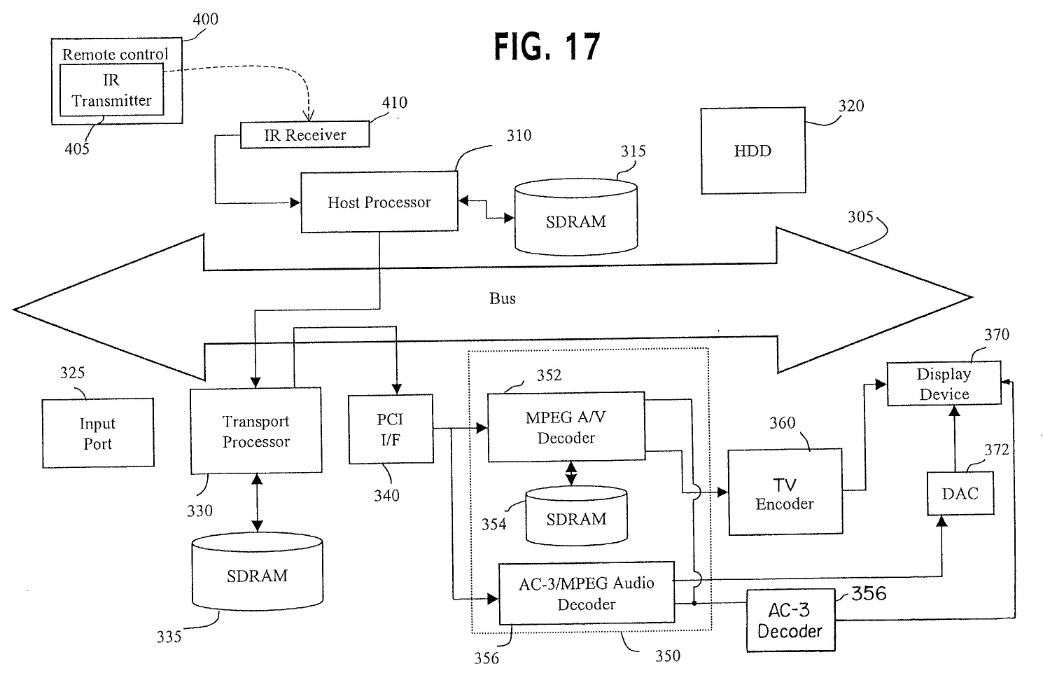

FIG. 17 illustrates the data flow to display a status parameter of the STB 300 in accordance with the present invention. A plurality of status parameters are stored in SDRAM 315. Additionally, certain ones of these stored status parameters may be updated to reflect current status of the STB 300; for example, remaining recording time available, current delay behind live feed, etc. This may be done, for example, by using designated software programs or predetermined algorithms within host processor 310.

The host processor 310 receives an IR ray signal (i.e., a command) from remote control device 400 that is converted into a digital signal. This signal is a command directing that a certain status parameter or status data be displayed. Thus, host processor 310 retrieves the ordered status parameter (this may be only digital video data or digital A/V data, depending on the selected status parameter and/or status feature) from SDRAM 315, and sends the selected A/V data corresponding to the desired status parameter via bus 305 to transport processor 330, and through PCI I/F 340, which in turn sends the A/V data of the selected status parameter to decoder 350. From this point, the flow path is identical to that for playback described above. The decoded A/V data is output to video encoder 360 for conversion to an analog format, so that the desired status parameter may be displayed on display device 370.

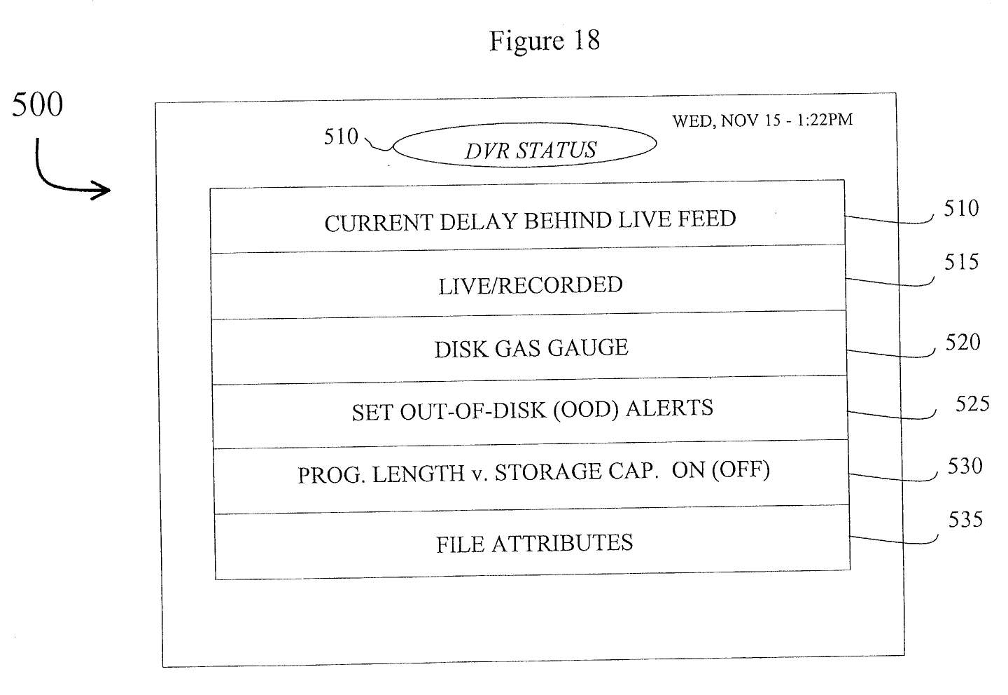

FIG. 18 illustrates an exemplary status menu screen according to the invention. When a user or viewer sends a command to display a status menu, an exemplary status menu 500 or status guide such as is depicted in FIG. 18 may be displayed on the screen of a display device 370. In an exemplary embodiment, various status parameters or features may be displayed in stacked cells or rows of the menu 500, each cell being assigned to a particular status parameter.

As shown in FIG. 18, a title line 505 such as “DVR Status” may be provided. The individual cells may list status parameters such as Current Delay behind Live Feed 510, “LIVE/RECORDED” program status 515, Disk Gas Gauge 520, Set Out-of-Disk (OOD) Alert 525, Program Length vs. Storage Capacity, and File Attributes 535. These features are only exemplary of the many other possible status features or parameters of the STB 300 that a user may display in order to review.

To view the desired status parameter, and/or to manipulate or display additional information such as sub menus, icons, animated icons or other graphical displays such as bar-graphs, pie-charts, etc. associated with a particular status parameter, the viewer simply presses a designated key on the remote control 400 or on the STB 300, such as a scroll down key, left/right or up/down arrow button, for example, in order to highlight a specific cell. The status parameter of the highlighted cell may then be actuated or implemented on the display by pressing an execution key, button, etc. on the remote control 400 or STB 300, such as an “action”, “enter” or “execution” key as is known in the art. The present invention is not limited to these user command interfaces, of course, as any of the other exemplary user command interfaces may be implemented as well.

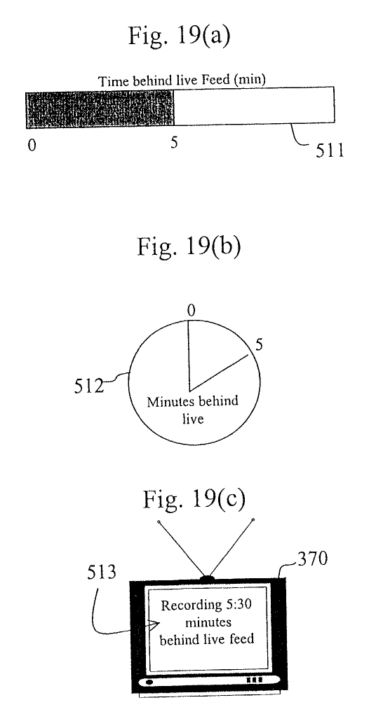

FIGS. 19(a) through 19(c) illustrates several exemplary graphics that may represent the current delay status parameter of the invention. A viewer may select the Current Delay behind Live Feed cell 510 if the viewer has paused a live broadcast. This may be done by actuating a pause button on remote control 400, sending a signal to host processor 310 to direct the A/V data of the live feed being received by transport processor 330 to be buffered in SDRAM 315 via bus 305. During pause mode up to 30 minutes of a live broadcast may be buffered or cached (recorded) in SDRAM 315 and/or HDD 320, depending on the storage requirement. A freeze frame displaying the final frame processed may be shown in the pause mode. Further, the viewer may resume the live broadcast simply be pressing a button on the remote control 400 or STB 300 to resume live broadcast, in effect “jumping forward” to the current live broadcast.

During pause mode, if a viewer desires to see how far the recording is behind the live broadcast, the viewer displays the status menu 500 and actuates the Current Delay behind Live Feed cell 510 as previously described above. In lieu of the status menu 500, there may be provided a designated key or button on remote control 400 or STB 300 which actuates processing to display the graphics corresponding to the current delay status parameter.

As shown in FIG. 19(a), once the Current Delay behind Live Feed cell 510 is selected, a simple horizontal window or bar graph 511 may be displayed on the screen of display device 370, calibrated in units of time such as minutes (or minutes and seconds) and labeled “Time Behind Live Feed”, with a portion of the window shaded to depict the current delay. Alternatively, this may be displayed as a pie chart graphic object 512 as shown in FIG. 19(b), or as a text message 513 that overlays the frozen frame on the screen of display device 370, which may be a TV as shown in FIG. 19(c). Moreover, a suitable icon, or plurality of interactive or animated icons indicating the time behind live feed may also be displayed, such as two human icon forms running one behind the other in a line, the rear icon labeled “Recording”, the front labeled “Live Feed” for example, with the rear icon also depicting a time in minutes behind, or minutes and seconds behind, being labeled thereon as well.

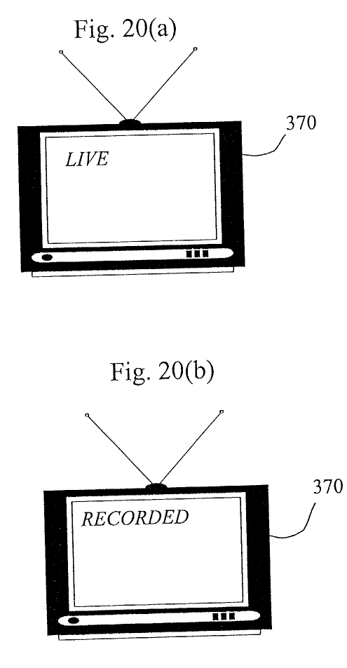

FIGS. 20(a) and 20(b) illustrates exemplary graphical objects that may represent the live/recorded status indicator parameter of the present invention. A viewer may desire to see if a program he or she is watching is LIVE (a live feed) or RECORDED. To do so, the viewer may display the status menu 500 and select the “LIVE/RECORDED” program status cell 515 as previously described above. Thereafter, and as shown in FIGS. 20(a) and 20(b), the word LIVE or RECORDED will flash on the screen of display device 370 (shown as a TV here), indicating the status of the program being viewed. So as not to annoy the viewer, this status parameter may be displayed for a designated period of time, preferably a short time such as about 5 seconds or so, before disappearing. In lieu of the status menu 500, there may be provided a designated key or button on remote control 400 or STB 300 which actuates processing to directly display LIVE or RECORDED on the screen of display 370, without having to first display and then manipulate status menu 500 to select the “LIVE/RECORDED” program status cell 515.

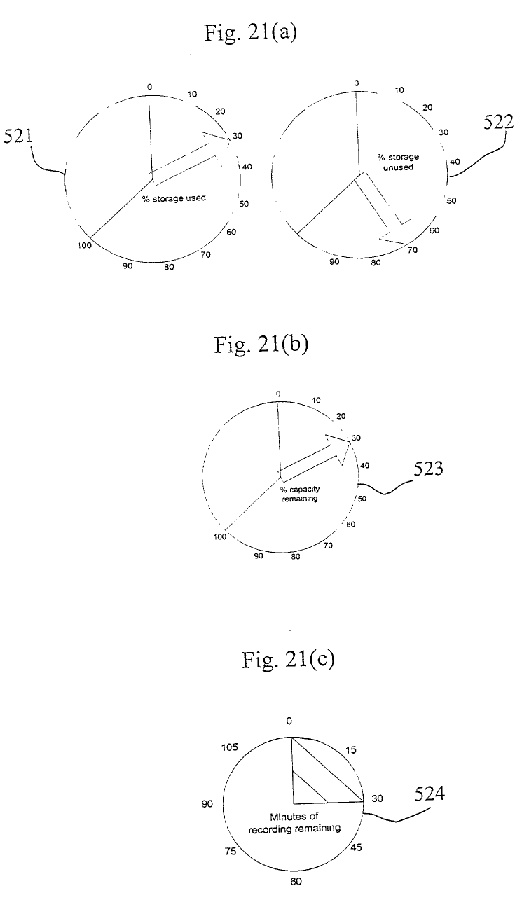

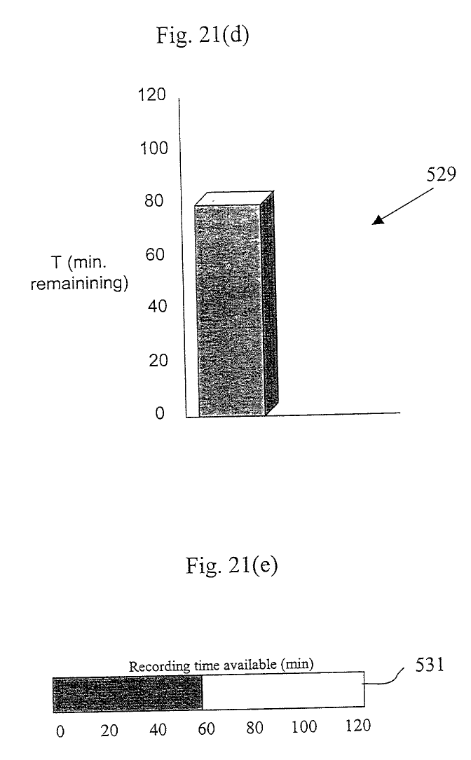

FIGS. 21(a) through 21(e) illustrate several exemplary graphical objects that may represent the Disk Gas Gauge status parameter of the invention. The Disk Gas Gauge status parameter generally indicates the percent of the HDD 320 that has been consumed by recorded material. Once selected, the Disk Gas Gauge may be displayed in various forms. In FIG. 21 (a), two icons (gauges 521 and 522) representing “percent used” and “percent unused” may be displayed on display device 370. These two icons may alternatively depict “recording time used” and “remaining recording time available” in lieu of percent used/unused.

As shown in FIG. 21(b), a single gauge icon 523 may be displayed to represent only the “percent capacity remaining” of HDD 320. Alternatively, a pie-chart 524 depicting the amount of recording time remaining, in minutes and/or minutes and hours may be displayed as shown in the shaded portion of FIG. 21(c). Additionally, a simple bar graph 529 may indicate “percent of HDD 320's capacity unused”, or more preferably “available recording time remaining” in minutes, as shown in FIG. 21(d). Or as shown in FIG. 21(e), a horizontal of vertical window 531 somewhat similar to that shown in FIG. 19(a) regarding the current delay status parameter may be provided, with the remaining available recording time shaded within the window. The present invention is not limited to these graphical objects or icons, as other graphical forms and objects may be used as well.

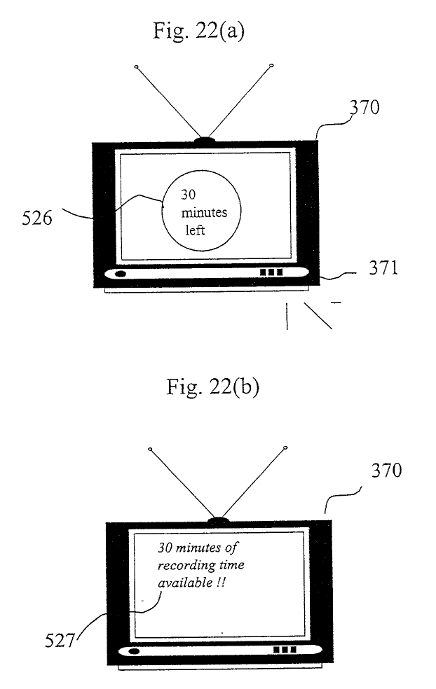

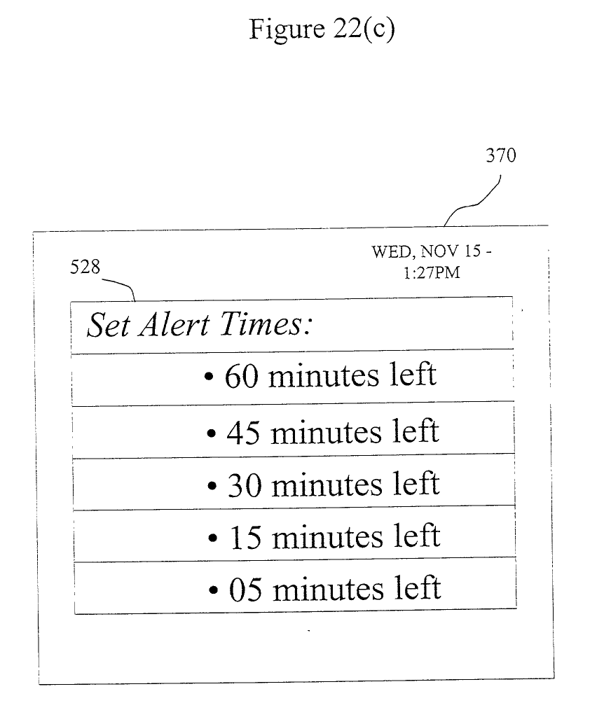

FIGS. 22(a) through 22(c) illustrates several exemplary graphics that may represent the out-of-disk space alert status parameter of the invention. For the out-of-disk space alert, the user may receive a notification indicating the approximate minutes of recording time still available while recording is in progress. This out-of-disk space alert may appear automatically on display device 370, to be triggered when the remaining recording time available decreases to a default value that is preset in SDRAM 315, such as thirty (30) minutes for example.

As shown in FIG. 22(a) this alert may be a flashing icon 526, that may also be accompanied by a warning sound or tone. The tone is generated by host processor 310 to be output via transport processor 330, PCI I/F 340, AC-3/MPEG Audio decoder 356, DAC 372 for conversion prior to being output from a speaker 371 of display device 370, for example. The flashing icon 526 may visually indicate that 30 minutes of recording time remain available. Alternatively, a simple text message 527 may be displayed, as shown in FIG. 22(b). The present invention is not limited to these graphical objects or icons, as other graphical forms and objects may be used as well.

FIG. 22(c) illustrates a sub menu associated with the out-of-disk space alert status parameter in accordance with the invention. As an additional feature, as percent of HDD 320 consumed by recorded material (or remaining recording time available) reaches lower levels, different video icons/shapes may be displayed to visually alert the viewer, which also may be accompanied with warning tones or sounds. For example, alerts may be generated for display on display device 370 at 45 minutes, 30 minutes, 15 minutes and 5 minutes of remaining recording time available. These alert times may be selected by the user or viewer by accessing the status menu 500 and selecting the Set Out-of-Disk (OOD) Alert cell 525. Thereafter, and as shown in FIG. 22(c), a submenu 528 may be displayed in which the user highlights those alerts that he/she desires, and then presses an action or execute button provided on the remote control 400 or STB 300. Until changed, these out-of-disk space alerts become the defaults for STB 300.

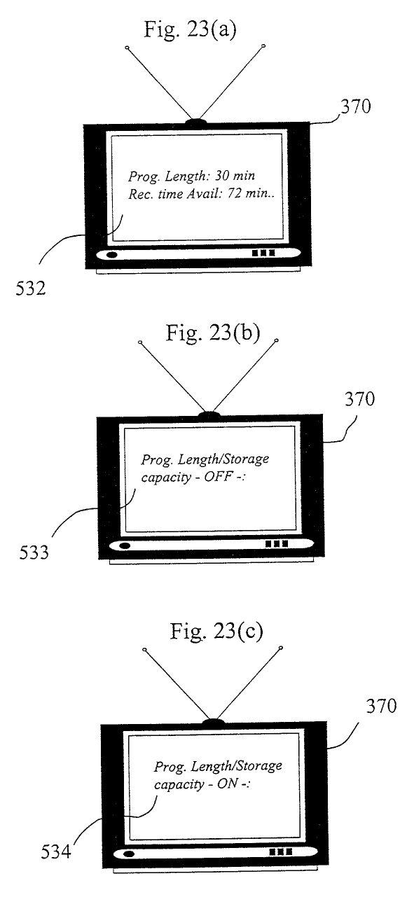

FIGS. 23(a) through 23(c) illustrate exemplary text messages of a status parameter related to program length versus recording time available. In another embodiment, if the program length is greater than the amount of unused HDD 320 space available, the user may receive a notification indicating such, as well as the recording time available, prior to or at the start of the recording. This is determined by a algorithm preset within host processor 310, which compares the program length of a desired event or broadcast that is to be recorded with the remaining storage capacity in HDD 320.

FIG. 23(a) illustrates an exemplary notification text message 532 that may be displayed in on overlain fashion on the program that has begun to be recorded, informing the user of the program length as well as the recording time available. Although this status feature is preferably automatically set as a default in the host processor 310 at time of manufacture of the STB 300, so as to be displayed prior to or at the start of the recording, the user may also elect to inactivate this feature. FIG. 23(b) illustrates an exemplary text message 533 associated with inactivating this feature. For example, a key or button on remote control 400 or STB 300 may send a command to host processor 310 to inactivate this notification, whereby a text message such as “Program Length/Storage Capacity OFF” is briefly displayed on display device 370. To re-activate the notification, the user simply presses the same key or button on remote control 400 or STB 300, whereby a text message 534 such as “Program Length/Storage Capacity ON” is briefly displayed on display device 370. This is illustrated in FIG. 23(c).

The present invention is not limited to the graphical text messages illustrated in FIGS. 23(a)-(c) in order to inform the user of the program length as well as the recording time available, as other graphical forms such as icons or animated icons may be used as well. For example, the status menu 500 of FIG. 18 may also include a program length versus storage capacity cell 530, which as a default is set to “ON” so that the notification is automatically displayed prior to or at time of recording a desired program. The user may inactivate this notification simply by selecting cell 530 on menu 500, and then to actuate an execute button or key provided on remote control 400 or STB 300 to change the status from “ON” to “OFF”. This will be reflected in cell 530. To re-activate the notification, the user simply highlights cell 530 and punches the aforementioned execute button or key.

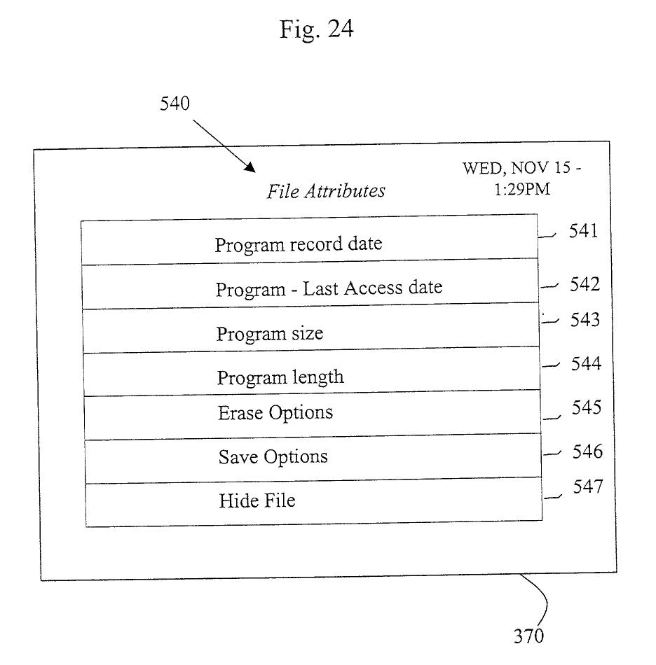

FIG. 24 illustrates an exemplary status sub-menu screen related to certain file attributes according to the invention. A viewer may wish to review or manipulate certain file attributes of the STB 300. To do so, the viewer may display the status menu 500 and select the “FILE ATTRIBUTES” program status cell 535 as previously described above.

As shown in FIG. 24, a submenu 540 entitled “FILE ATTRIBUTES” may be displayed on the display device 370. Submenu 540 might include cells designating certain features or status parameters. The user would scroll down submenu 540 to highlight a desired cell in order to review or manipulate the information or data corresponding to the selected cell. Algorithms or software well known in the art for determining the parameters corresponding to the cells in submenu 540 are under the control of host processor 310, and are implemented based on a command from a command user interface such as remote control 400.

These cells may include the date a program is recorded cell 541, a latest or last date a stored program has been accessed cell 542, size of a recorded or live program cell 543 in Mbytes, length of a live or recorded program in minutes cell 544, erase options cell 545 for implementation of a protect feature to prevent erasure of a recorded program, save options cell 546 designating how much of a program is to be recorded and/or how long of a time a program is to be stored before being erased, and a hide file cell 547 for implementation of a hidden file feature to prevent titles of certain programs, such as those of an explicit nature, for example, from being displayed within the program guide.

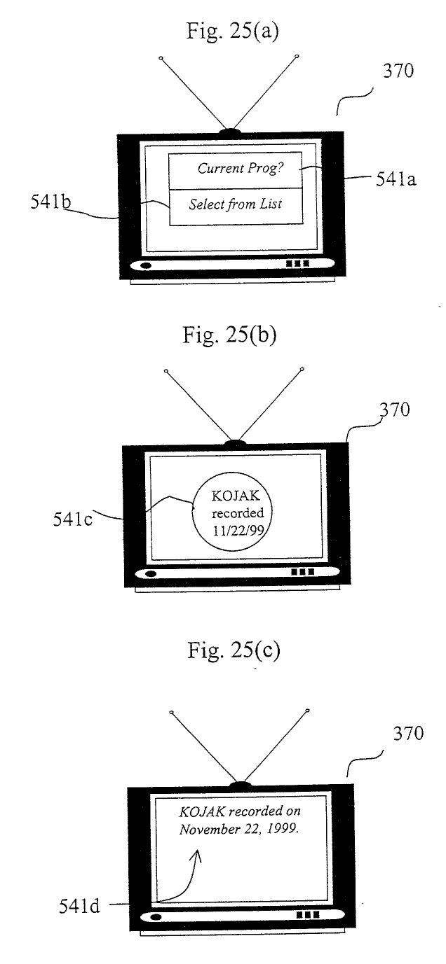

FIGS. 25(a) through 25(c) illustrate the information that may be displayed upon selection of cell 541 in FIG. 24. If a user selects the date recorded cell 541, the user may be prompted to select the recorded date from the currently viewed recorded program (cell 541a) or to select a recorded program from the program guide list (a browse function—see cell 541b), as shown in FIG. 25(a). The use simply selects the desired cell to display the date information corresponding to the chosen program. This may be displayed as a icon or test message 541c or 541d for example, as shown in FIGS. 25(b) and 25(c).

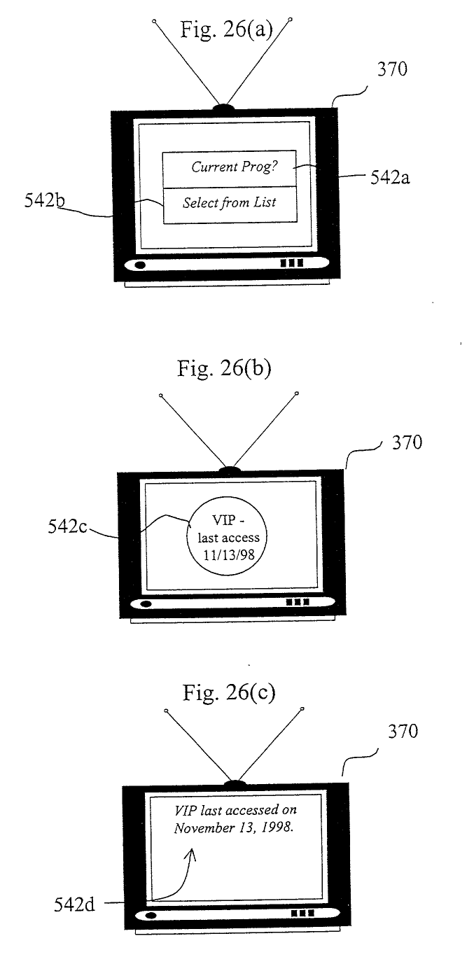

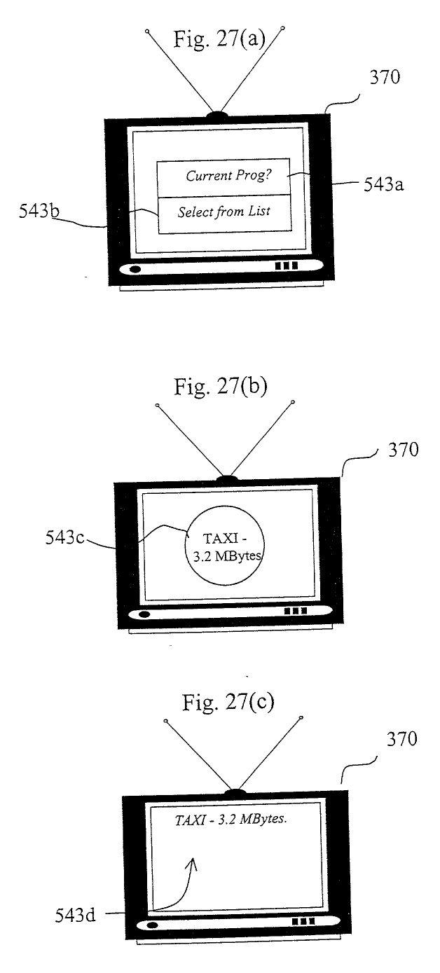

FIGS. 26(a) through 26(c) illustrate the information that may be displayed upon selection of cell 542 in FIG. 24. If a user selects the latest date accessed cell 541, the user may be prompted to select from the currently viewed recorded program (cell 542a) or to select a recorded program from the program guide list (a browse function—see cell 542b), as shown in FIG. 26(a). The use simply selects the desired cell to display the latest access date information corresponding to the chosen program. This may be displayed as a icon or test message 542c or 542d for example, as shown in FIGS. 26(b) and 26(c).

FIGS. 27(a) through 27(c) illustrate the information that may be displayed upon selection of cell 543 in FIG. 24. Like FIGS. 25(a) and 26(a), if a user selects the Program Size cell 543, the user may be prompted to select from the currently viewed live or recorded program (cell 543a) or to select a recorded program from the program guide list (a browse function—see cell 543b), as shown in FIG. 26(a). The use simply selects the desired cell to display the program size information corresponding to the chosen program. This may displayed as a icon or test message 543c or 543d for example, as shown in FIGS. 27(b) and 27(c).

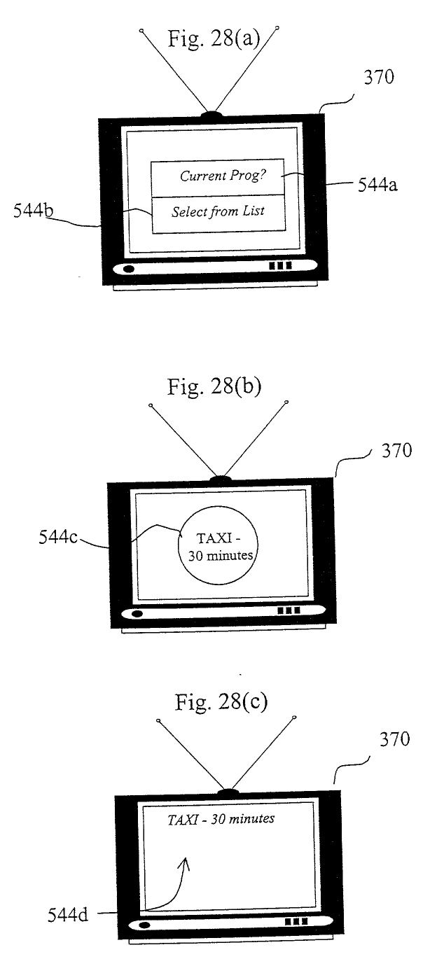

FIGS. 28(a) through 28(c) illustrate the information that may be displayed upon selection of cell 544 in FIG. 24. Similar to the above, if a user selects the Program Length cell 544, the user may be prompted to select from the currently viewed live or recorded program (cell 544a) or to select a recorded program from the program guide list (a browse function—see cell 544b), as shown in FIG. 28(a). The use simply selects the desired cell to display the program size information corresponding to the chosen program. This may displayed as a icon or test message 544c or 544d for example, as shown in FIGS. 28(b) and 28(c).

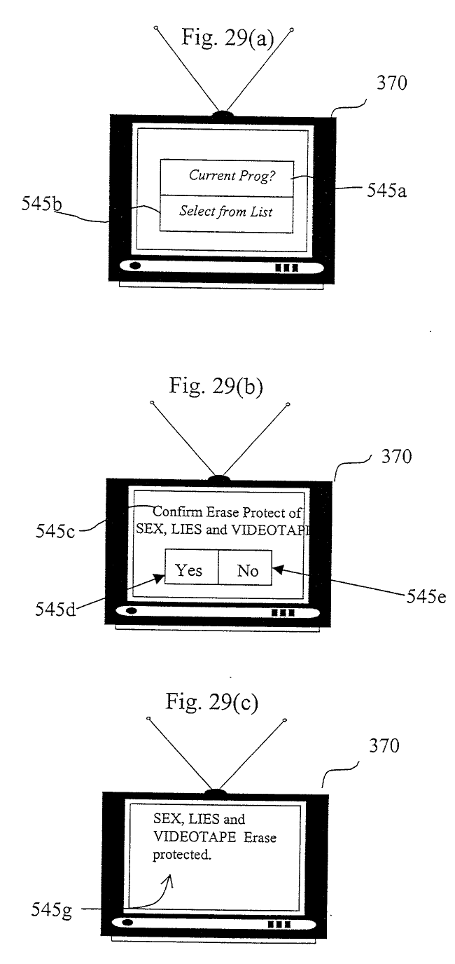

Should the user choose the prevent erase cell 545, subcells and/or test messages such as shown in FIGS. 29(a) through 29(c) may be displayed. In FIG. 29(a), the user will be prompted for the desired program to protect, to be selected from the currently viewed live or recorded program (cell 545a), or from the list (cell 545b). Once selected, a confirmation message 545d will be displayed, prompting to user to verify that the selected program (the title shown here as “SEX, LIES and VIDEOTAPES” will be protected from erasure. The user simply highlights the “YES” subcell 545e or “NO” subcell 545f. Thereafter, an icon or test message 545g may be displayed indicating that “SEX, LIES and VIDEOTAPES” is protected. This is shown in FIG. 29(c).

Should the user choose the prevent erase cell 545, subcells and/or test messages such as shown in FIGS. 29(a) through 29(c) may be displayed. In FIG. 29(a), the user will be prompted for the desired program to protect, to be selected from the currently viewed live or recorded program (cell 545a), or from the list (cell 545b). As shown in FIG. 29(b), once selected, a confirmation message 545c will be displayed, prompting to user to verify that the selected program (the title shown here as “SEX, LIES and VIDEOTAPES” will be protected from erasure. The user simply highlights the “YES” subcell 545d or “NO” subcell 545e. Thereafter, an icon or test message 545g may be displayed indicating that “SEX, LIES and VIDEOTAPES” is protected. This is shown in FIG. 29(c).

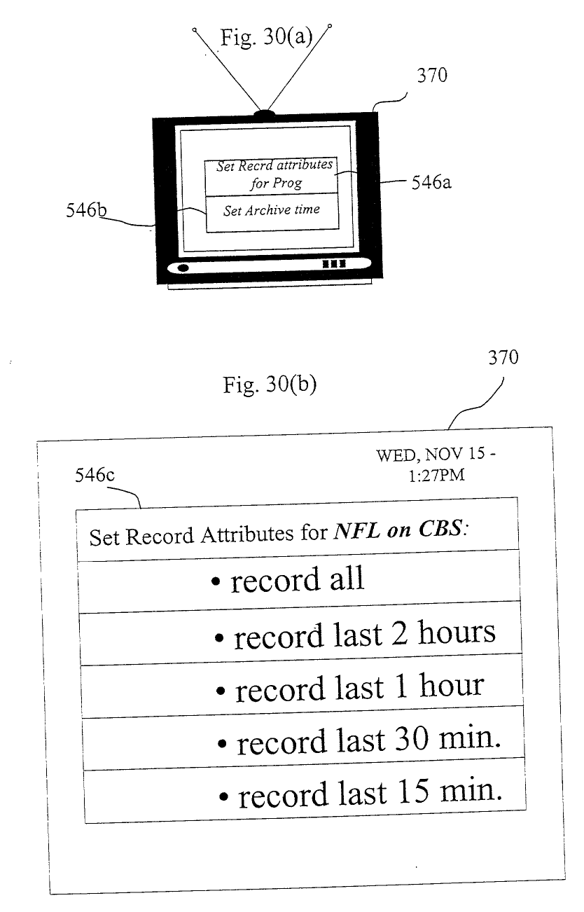

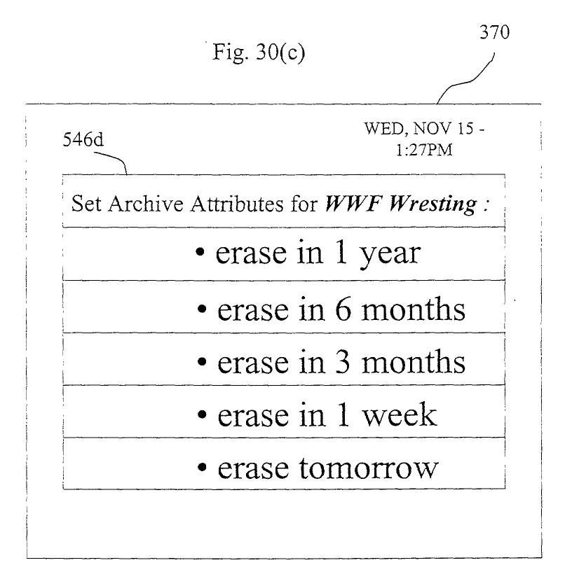

FIGS. 30(a) through 30(c) illustrate the information that may be displayed upon selection of cell 546 in FIG. 24. When the user selects the save options cell 546 designating how much of a program is to be recorded and/or how long of a time a program is to be stored before being erased, subcells 546a and 546b are displayed, as shown in FIG. 30(a). The viewer would select cell 546a only if he wants to record a portion of a currently or soon to be viewed program, broadcast or event. Selecting 546a requires the user to enter the title of the desired program, which can be accessed from the program guide list (not shown) as is well known in the art. Once the program is selected, a text message and/or submenu 546c is displayed on the screen of display device 370, as shown in FIG. 30(b). The use may then select the desired portion or part of the broadcast to record by choosing on of the subcells.

If cell 546b is selected, the user will be prompted for the desired program title, to be selected from the currently viewed live or recorded program, or from browsing a program guide list as described above. Once selected, a text message and/or submenu 546d is displayed on the screen of display device 370, as shown in FIG. 30(c). The user may then select the desired time at which the recorded program (or to be recorded program) is to remain archived before being erased.

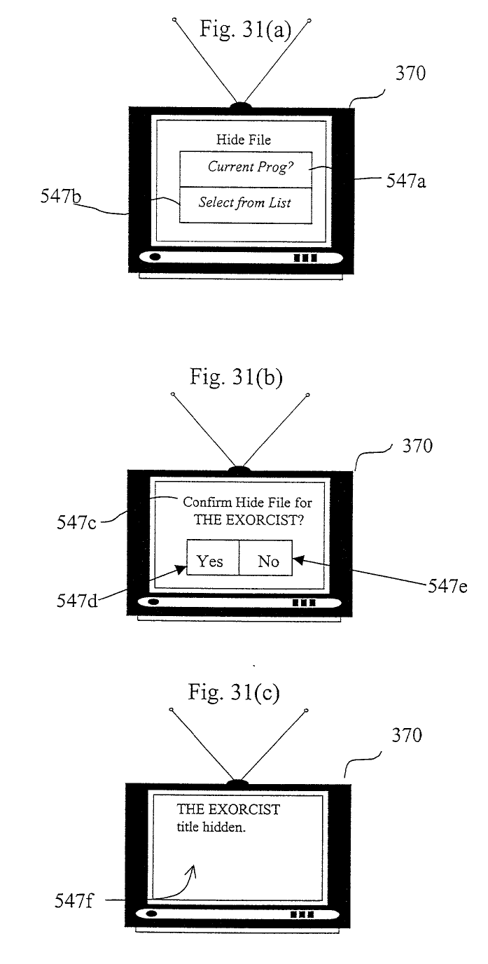

FIGS. 31(a)-(c) illustrate the information that may be displayed upon selection of cell 547 in FIG. 24. Similar to the above, if cell 547 is selected, the user is prompted for program title information, as shown in cells 547a and 547b of FIG. 31(a). As shown in FIG. 31(b), the user selects the desired program to hide, and a confirmation message 545c will be displayed, prompting to user to verify that the title of the selected program (the title shown here is “THE EXORCIST” ) is hidden from a program guide list that is viewed by a user. The user simply highlights the “YES” subcell 547de or “NO” subcell 547e. Thereafter, an icon or test message 547f may be displayed indicating that “THE EXORCIST” will be hidden. This is shown in FIG. 29(c).

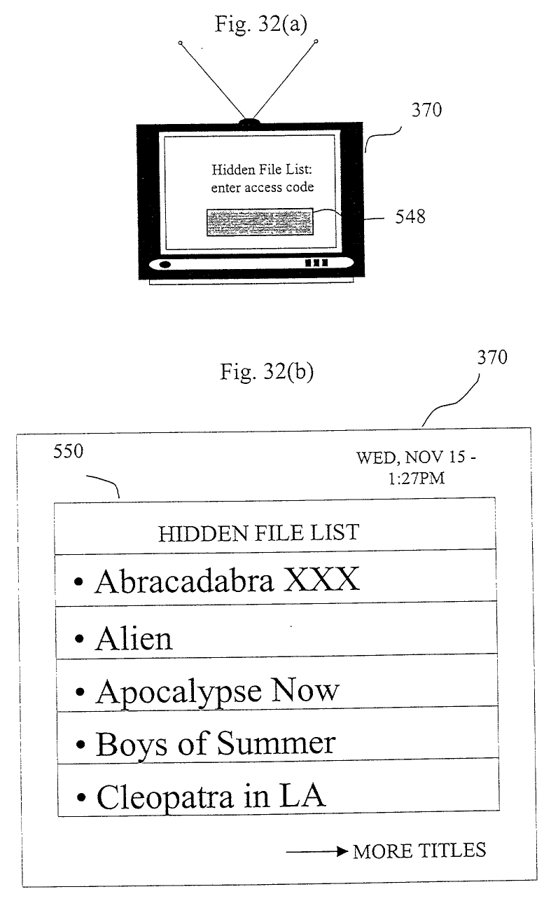

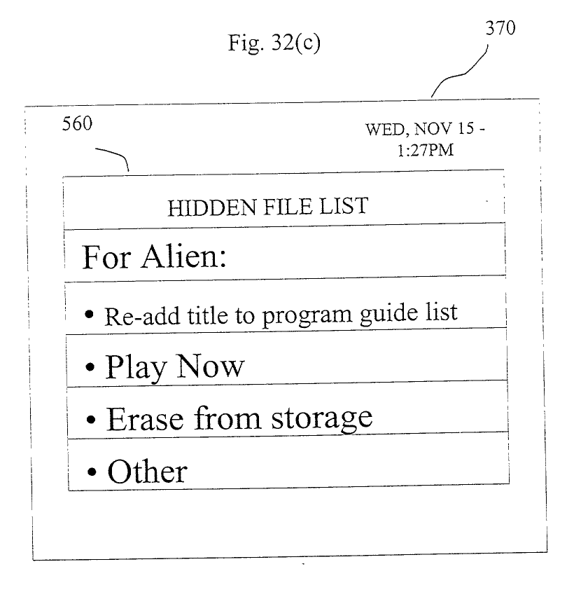

FIGS. 32(a) to 32(c) illustrates how the user may display a list of hidden files for selection. To access this hidden title, a user may have to enter a security code to view all “hidden titles”. This feature provides the ability to hide titles of programs in the program guide list that may be explicit in nature and unsuitable for minors to view. This feature may be provided on the Main Menu 500 of FIG. 18 for example, or may be displayed on display device 370 via a direct command from remote control 400.

For example, if a user manipulates a particular key or function button on remote control 400, a text message such as “Hidden File List: enter access code:” may be displayed, as shown in FIG. 32(a). The user keys in the code in the highlighted window 548 and presses an execute button on the remote control 400. Thereafter, a menu 550 entitled Hidden File List may appear with a listing of all titles in the program guide that have been hidden, as shown in FIG. 32(b). The user may scroll down and select a desired title. After selection, a message or submenu 560 may then be displayed for enabling a user to perform functions such as adding the title back to the main program guide list, playing the selected program, erasing the selected program, etc. This is shown in FIG. 32(c).

Therefore, the status display apparatus in accordance with the present invention requires an interface such as a remote control 400, to send commands to a processor (host processor 310) which in turn retrieves a selected status parameter from a memory (SDRAM 315) for display on a display device 370, for example. Conveniently, the host processor 310 and SDRAM 315 are contained within STB 300 so as to monitor, update where necessary, and store status parameters of the STB 300, with the display device 370 operatively connected to STB 300 to display the desired status parameters or features.

Further, since a viewer may be provided with a display of the aforementioned status parameters of his or her own STB equipped with DVR, he or she may more easily decide what programs to record, or may be alerted that some of the previously recorded material may have to be erased in order to provide room for recording a desired event, program or broadcast that exceeds the current storage capacity of a mass storage device such as HDD 320.

The invention being thus described, it will be obvious that the same may be varied in many ways. For example, the functional blocks in FIGS. 6-9 and 16-17 may be implemented in hardware and/or software. The hardware/software implementations may include a combination of processor(s) and article(s) of manufacture. The article(s) of manufacture may further include storage media and executable computer program(s). The executable computer program(s) may include the instructions to perform the described operations. The computer executable program(s) may also be provided as part of externally supplied propagated signal(s). Such variations are not to be regarded as departure from the spirit and scope of the invention, and all such modifications as would be obvious to one skilled in the art are intended to be included within the scope of the following claims.

In accordance with the present invention, there is a system and method that provides the ability to maintain a digital telephone answering device on a STB-equipped with DVR utilizing the audio and video features of the STB-equipped with DVR and associated display device(s) connected thereto. The DVR TAD utilizes the same telephone line as the STB-equipped with DVR, and may use memories that are integrated within the STB with DVR architecture, and/or an external mass storage device or memory.

Memory devices within the DVR are used by the DVR TAD for storing a plurality of parameters and data typically associated with a DVR TAD. A microprocessor within the DVR controls DVR TAD functionality and display of parameters associated with the DVR TAD. Control is based on receiving user commands to access the memory and to display at least a selected one of the DVR TAD associated parameters for review and/or manipulation by the viewer on a display device operatively connected to the STB-equipped with DVR. A suitable interface such as a remote control may be used in order to transmit a command to display desired DVR TAD parameter(s) or associated data.

A DVR TAD main menu or guide may be depicted on a TV or other display device, effected via a user command interface to the DVR, such as by operation of a remote control device to send commands to a processor within the DVR, for example, and manipulated via a graphical user interface (GUI) controlled by the processor.

Parameters, data or features related to the DVR TAD functionality or operability may be accessed, displayed for viewing and/or manipulated by the user or viewer. These features may include a main DVR TAD menu listing of messages received which include a menu display providing the identity of the caller with number and a short text synopsis of the corresponding stored voice message adjacent thereto; a submenu displaying a “catalog” or “phone book” for data entry to access stored caller information, which may include name, phone number and other identifying criteria that may be entered by the user. Additional features include a means to enable the user to choose between a text display or voice playback of a recorded message; menu features enabling the user to send a stored voice and/or text message to another person via a medium such as the internet (i.e., transmitting an e-mail message with text file or sound file attached thereto) and other attributes associated with the functionality and operation of the DVR TAD.

Also, if a user wishes to phone to the caller back after confirming a message recorded by the caller, a phone call can be automatically made to the caller via an interface in accordance with the control of a microprocessor of the STB equipped with DVR, by selecting a phone message from the list displayed on a display device and actuating a specific key. If the DVR TAD according to the invention is employed by a plurality of users or as a private voice box, a secret number such as a password may be assigned to each of the users so that a message can only be accessed by a corresponding user.

Therefore, the present invention enables a viewer to be provided with a DVR TAD that has enhanced functionality as compared to conventional DTADs, since it utilizes existing hardware and software architecture of a STB equipped with DVR to which it is operatively connected. As will be explained in further detail later in this disclosure, the DVR TAD is capable of storing an enormous amount of telephone messages as compared to current DTADs. Moreover, various menu screens associated with DVR TAD features, data or parameters may be displayed and manipulated by the user operating a simple graphical user interface such as a remote control, providing even greater flexibility.

However, before describing the above features in greater detail, the inventors initially offer a general discussion on a set-top box (STB) equipped with a digital video recorder (DVR) within a direct broadcast satellite or digital video broadcast (DVB) system. Additionally, the basic architecture and operation of the STB-equipped with DVR is explained in order to provide a context for the DVR TAD that is operatively attached thereto, such that a viewer can monitor various functions or parameters of the DVR TAD on a display device operatively connected thereto.

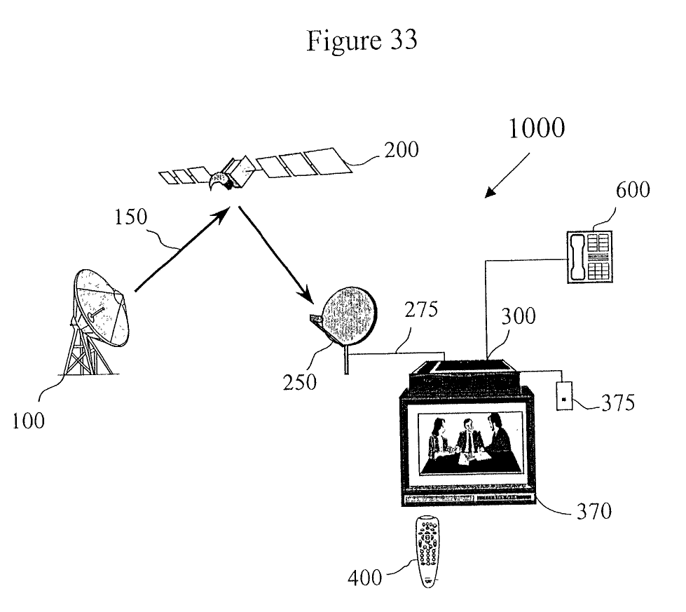

FIG. 33 is an exemplary arrangement of a STB 300 equipped with a DVR and DVR TAD within a direct broadcast satellite or digital video broadcast (DVB) system, in accordance with the present invention. In the exemplary embodiment of FIG. 33, the system 1000 may comprise a transmit antenna station (hereinafter referred to as uplink facility 100 for clarity), satellite 200, receive antenna 250, STB 300 equipped with DVR (within STB 300) and DVR TAD 600 operatively attached thereto.

The transmit antenna station may be a DIRECTV satellite uplink facility, for example, or any other earth station as described above and which is well known in the art. The bitstream or airlink 150 is a suitable content signal such as a digital audio and video television data signal (A/V signal), the medium is a satellite 200, and the receive antenna 250 is preferably an outdoor unit (ODU). As illustrated in FIG. 33, the ODU is connected to STB 300 via coaxial cable 275.

In this exemplary embodiment, the DVR of the present invention is included in, or subsumed within STB 300. However, the invention is applicable to any STB having a multiple-processor configuration. STB 300 may further be connected to a display 370, such as a standard definition television, a high definition television or a PC monitor and also may be connected to a telephone line 375. The DVR-equipped STB 300 may be controlled via a remote control 400 as is well known in art, using known RF and/or IR transmission and reception techniques.

The user command interface in the present invention however is not limited to a remote control device. Alternatively, any of function buttons residing on the STB or DVR structure itself, a keyboard operatively connected thereto and/or connected to a PC that is in communication with the STB, USB serial ports, voice-activation software devices within or operatively connected to the STB, or command and/or instructions by remote call-in using DTMF (Dual Tone Multifrequency) tones for example, may be substituted as the user command interface to the STB or DVR, and/or to control designated functions of the TAD connected thereto, as will be explained in detail hereinafter.

As described above, FIG. 12 provides a general understanding of the overall system organization, by illustrating the general data flow in a direct broadcast satellite or digital video broadcast system. In operation, the uplink facility 100 can receive video and audio programming from a number of sources, including satellites, terrestrial fiber optics, cable, or tape. Preferably, the received programming signals, along with data signals such as electronic scheduling data and conditional access data, are sent from some commercial source 105 to a video/audio/data encoding system 10 within uplink facility 100. Here, they are digitally encoded and multiplexed into a packetized data stream using a number of conventional algorithms, including convolution error correction and compression, for example.

In a conventional manner, the encoded data stream is modulated and sent through an uplink frequency converter 115 that converts the modulated encoded data stream to a frequency band suitable for reception by the satellite 200. Preferably, the satellite frequency is K-band such as in the Ku-band; however the frequency may be in the Ka band as well. The modulated, encoded data stream is then routed from the uplink frequency converter 115 to an uplink satellite antenna/dish 120, where it is broadcast toward the satellite 200 over the airlink 150. The encoded data stream may be encrypted and encoded, by a suitable encryption engine 112 (dotted lines), or not encrypted and encoded.

The satellite 200 receives the modulated, encoded Ku-band data stream via airlink 150, and re-broadcasts it downward via downlink 155 toward an area on earth that includes the various receiver stations (STB 300, for example). In this embodiment, the satellite dish (ODU 250) of STB 300 shifts the Ku-band signal down to an L-band signal which is transmitted via a LNB downconverter 160 to STB 300, for eventual reproduction on display monitor 370.

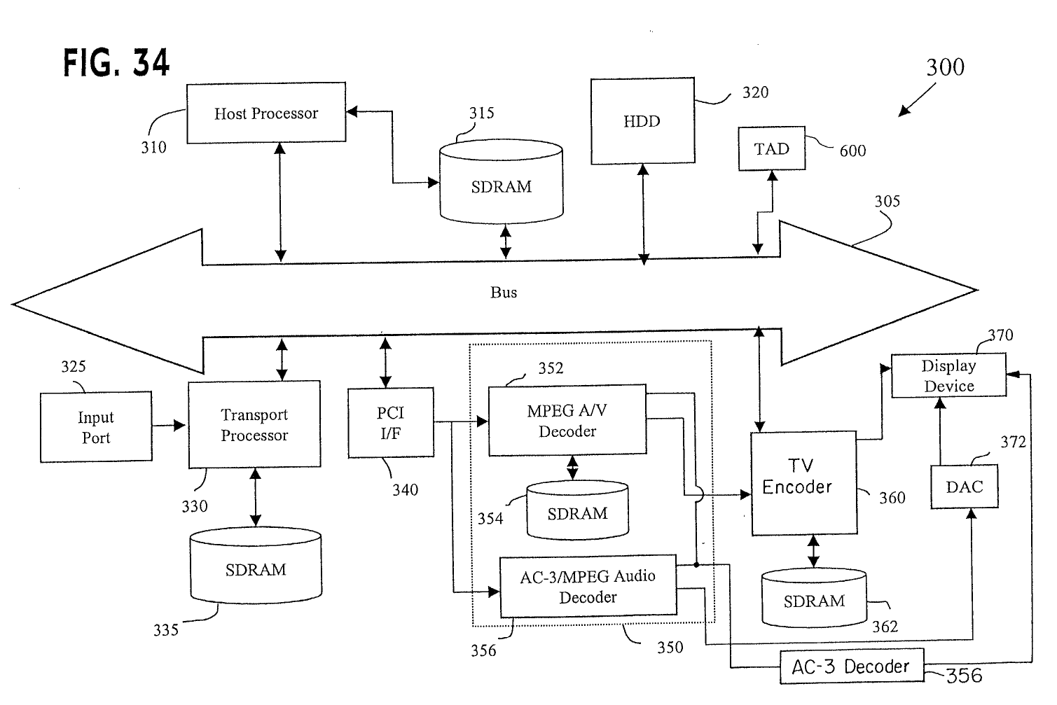

Front-end circuitry, which may or may not be part of STB 300, receives the L-band RF signals from the LNB downconverter 160 and converts them back into the original digital data stream. The front-end circuitry may include a tuner. Circuitry (shown and explained in more detail in FIG. 34) receives the original data streams via an input port and performs video/audio processing operations such as de-multiplexing and decompression. The overall operation of STB 300, including the selection of parameters, the set-up and control of components, channel selection, a user's access to different program packages, and many other functions, both real time and non-real time, are controlled by one or more processors within STB 300, as will be further explained below.

FIG. 34 illustrates an exemplary architecture of the STB 300 with TAD 600 connected thereto in accordance with the present invention. The STB 300 utilizes a bus 305 to interconnect various components and to provide a pathway for data and control signals.

FIG. 34 illustrates a host processor 310, a memory device 315 (in an exemplary configuration embodied as an SDRAM 315) a hard disc drive (HDD) 320 and a TAD 600 connected to the bus 305. In this embodiment, the host processor 310 may also have a direct connection to SDRAM 315 as shown in FIG. 34 (i.e., such that SDRAM 315 is associated as the memory for host processor 310). Although memory device 315 is described as SDRAM 315 hereinafter in the present application, memory devices of EDO RAM (extended data output DRAM), BEDO RAM (Burst EDO RAM), RLDRAM by Rambus, Inc., SLDRAM by the SyncLink Consortium, VRAM (video RAM), or any other known or developing memory that is writeable may be sufficient as memory device 315.

As further shown in FIG. 34, a transport processor 330 and PCI I/F 340 (peripheral component interconnect interface) are connected to the bus 305. The transport processor 330 also has a connection to input port 325 and SDRAM 335. SDRAM 335 has the same attributes as SDRAM 315 and may be replaced with any of the other above-noted alternative memory devices. Furthermore, the PCI I/F 340 is connected to a decoder 350. The decoder 350 is connected to a video encoder 360. The output of video encoder 360 is in turn sent to a display device 370. Decoder 350 may include both an MPEG A/V decoder 352 and an AC-3/MPEG audio decoder 356, the output of the latter being sent to display device 370 after conversion in a digital-to-analog converter (DAC) 372.

The host processor 310 may be constructed with conventional microprocessors such as the currently available PENTIUM processors from Intel. Host processor 310 performs non real-time functions in the STB 300 and TAD 600, such as control of attached components, graphical-user interface and browser functions. A browser is a software engine that presents the interface to, and interacts with, a user of the STB 300. The browser is responsible for formatting and displaying user-interface components and pictures. Typically, the user interface is displayed as a Graphical User Interface (GUI).

Browsers are often controlled and commanded by the standard HTML language, which is used to position and format the GUI. Additionally, or in the alternative, any decisions and control flow of the GUI that requires more detailed user interaction may be implemented using JavaScript™. Both of these languages may be customized or adapted for the specific details of a given STB 300 implementation, and images may be displayed in the browser using well known JPG, GIF and other standardized compression schemes. It is noted that other non-standardized languages and compression schemes may be used for the browser and GUI, such as XML, “home-brew” languages or other known non-standardized languages and schemes.

In addition to performing the aforementioned non-real time functions, host processor 310 also contains a voice recognition engine, which may be embodied as any of an algorithm, software or program that is well known in the art to be used to convert digital voice into digital text. For example, a suitable algorithm may be similar to well known software developed in order to translate voice data into a visual text display for the deaf, closed caption systems, reverse text-to-speech (TTS) synthesis processing systems, and automatic speech recognition (ASR) engines such as is described in U.S. Pat. No. 6,138,095 to Gupta et al. entitled “Speech Recognition”.

HDD 320 is actually a specific example of a mass storage device. In other words, the HDD 320 may be replaced with other mass storage devices as is generally known in the art, such as known magnetic and/or optical storage devices, (i.e., embodied as RAM, a recordable CD, a flash card, memory stick, etc.). In an exemplary configuration, HDD 320 may have a capacity of at least about 25 Gbytes, where preferably about at least 20 Gbytes is available for various recording applications, and the remainder flexibly allocated for pause (live cache) recording applications in STB 300.

HDD 320 thus provides enormous storage capacity for the storing of telephone messages and associated caller-ID information that may be stored in a suitable directory database of names. For example, assuming only one (1) Gbyte of the HDD 320's memory is allocated for DVR TAD 600 operation, this translates (at 32 kbits/sec) to in excess of 70 hours of recording time available for DVR TAD 600 recording operations. Moreover, with the amount of memory dedicated for DVR TAD 600 operations, it is conceivable that telephone directory-sized databases can be stored and managed by a user without significantly burdening the overall processing capability of STB 300.

The bus 305 may be implemented with conventional bus architectures such as a peripheral component interconnect (PCI) bus that is standard in many computer architectures. Alternative bus architectures such as VMEBUS from Motorola, NUBUS, address data bus, RAM bus, DDR (double data rate) bus, etc., could of course be utilized to implement bus 305.

The transport processor 330 performs real-time functions and operations such as control of the A/V data flow, conditional access, program guide control, etc., and may be constructed with an ASIC (application specific integrated circuit) that contains, for example, a general purpose R3000A MIPS RISC core, with sufficient on-chip instruction cache and data cache memory. Furthermore, the transport processor 330 may integrate system peripherals such as interrupt, timer, and memory controllers on-chip, including ROM, SDRAM, DMA controllers; a packet processor, crypto-logic, PCI compliant PC port, and parallel inputs and outputs. The implementation shown in FIG. 34 actually shows the SDRAM 335 as being separate from the transport processor 330, it being understood that the SDRAM 335 may be dispensed with altogether or consolidated with SDRAM 315. In other words, the SDRAMs 315 and 335 need not be separate devices and can be consolidated into a single SDRAM or other memory device.

Input port 325 receives audiovisual bitstreams that may include, for example, MPEG-1 and MPEG-2 video bitstreams, MPEG-1 layer II audio bitstreams and DOLBY DIGITAL (AC-3) audio bitstreams. Exemplary A/V bitrates may range from about 60 Kbps to 15 Mbps for MPEG video, from about 56-384 Kbps for MPEG audio, and between about 32-640 Kbps for AC-3 audio. The single-stream maximum bitrate for STB 300 may correspond to the maximum bitrate of the input programming, for example 16 Mbps or 2 MBps, which corresponds to the maximum MPEG-2 video bitrate of 15 Mbps, maximum MPEG-1 Layer-2 audio bitrate of 384 kbps, and maximum AC-3 bitrate of 640 kbps.

Any audio or video formats known to one of ordinary skill in the art could be utilized. Although FIG. 34 has been described in conjunction with digital television, the signal supplied could be any type of television signal, any type of audio or video data, including of course analog voice data over a telephone line, or any downloadable digital information. Of course, various other audiovisual bitstream formats and encoding techniques may be utilized in recording. For example, STB 300 may record an AC-3 bitstream, if AC-3 broadcast is present, along with MPEG-1 digital audio. Still further, the received audiovisual data may be encrypted and encoded or not encrypted and encoded. If the audiovisual data input via the input port 325 to the transport processor 330 is encrypted, then the transport processor 330 may perform decryption. Moreover, the host processor 310 may perform the decryption instead.

Alternatively, the host processor 310 and transport processor 330 may be integrated or otherwise replaced with a single processor. As mentioned above, the SDRAMs (315 and 335) may be consolidated or replaced with a single SDRAM or single memory device.

The PCI I/F 340 may be constructed with an ASIC that controls data reads from memory. Audiovisual (A/V) data may be sent to the host processor 310's memory (SDRAM 315) while simultaneously being sent to an MPEG A/V decoder 352, as further discussed below.

Decoder 350 may be constructed as shown in FIG. 34 by including the MPEG A/V decoder 352 connected to the PCI I/F 340, as well as an AC-3/MPEG audio decoder 356 that are also connected to the PCI I/F 340. In this way, decoders 352 and 356 can separately decode the video and audio bitstreams from the PCI I/F 340, respectively. Alternatively, a consolidated decoder may be utilized that decodes both video and audio bitstreams together. The encoding techniques are not limited to MPEG and AC-3, of course, and can include any known or future developed encoding technique. In a corresponding manner, the decoder 350 could be constructed to process the selected encoding technique(s) utilized by the particular implementation desired.

In order to more efficiently decode the MPEG bitstream, the MPEG A/V decoder 352 may also include a memory device such as SDRAM 354 connected thereto. This SDRAM 354 may be eliminated, consolidated with decoder 352 or consolidated with the other SDRAMs 315 and/or 335. SDRAM 354 has the same attributes as SDRAM 315 and 335, and may be replaced with any of the other above-noted alternative memory devices.

A graphics accelerator (GA) 360 includes processing circuitry for performing graphics processing of a decoded input video stream, and encoding circuitry for encoding and converting the processed video to analog prior to outputting it to display device 370. GA 360 also includes a memory interface that communicates with an SDRAM 362 in order to direct the incoming video bit stream to a specific storage location in SDRAM 362, and also selects the frames and frame order for display.

Display device 370 may be an analog or digital output device capable of handling a digital, decoded output from the GA 360. If analog output device(s) are desired, to listen to the output of the AC-3/MPEG audio decoder 356, a digital-to-analog converter (DAC) 372 is connected to the decoder 350. The output from DAC 372 is an analog sound output to display device 370, which may be a conventional television, computer monitor screen, portable display device or other display devices that are known and used in the art. If the output of the AC-3/MPEG audio decoder 356 is to be decoded by an external audio component, a digital audio output interface (not shown) may be included between the AC-3/MPEG audio decoder 356 and display device 370. The interface may be a standard interface known in the art such as a SPDIF audio output interface, for example, and may be used with, or in place of DAC 372, depending on whether the output devices are analog and/or digital display devices.

The video output from GA 360 and/or audio output from audio decoder 356 or DAC 372 does not necessarily have to be sent to display device 370. Alternatively, encoded A/V data may be output to external devices or systems operatively connected to the STB 300, such an off-broadcast system, cable TV system or other known systems that can reproduce the encoded audio and/or video signals for reproduction and/or display. This may also include a PC that can play video or audio files containing the encoded A/V data sent from the STB 300, for example. In such an embodiment, text or voice files could be sent from the STB 300 to the PC in the form of an e-mail message with text or sound file as an attachment thereto, as will be explained in more detail hereinafter

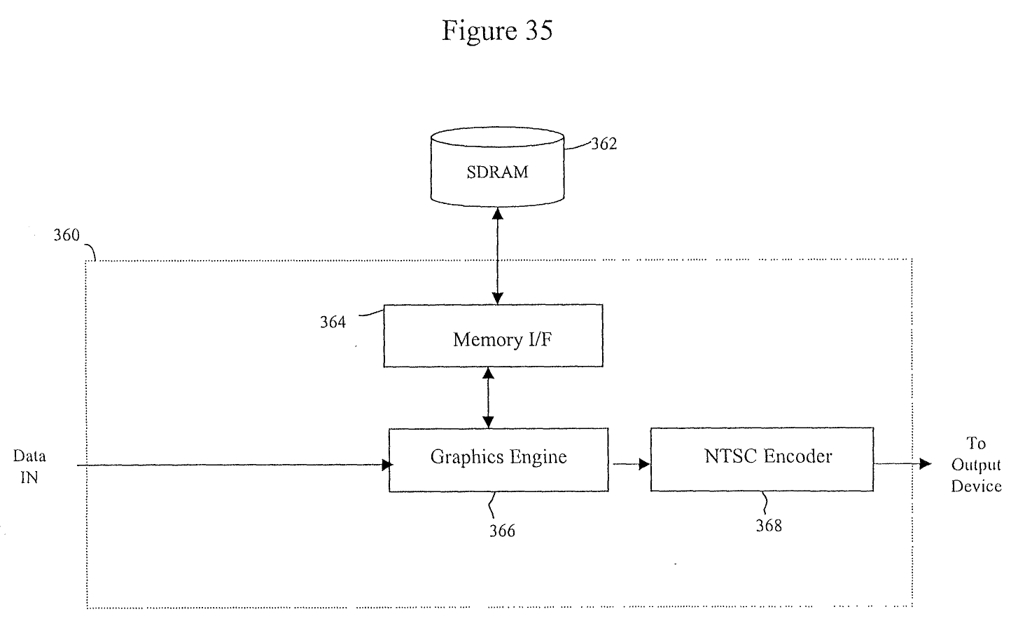

FIG. 35 is a block diagram showing an exemplary construction of the graphics accelerator according to the invention. The GA 360 preferably is a graphics chip that includes a memory interface (I/F) 364 to SDRAM 362, a graphics engine 366 and a TV encoder 368. The memory interface 364 and TV encoder 368 are shown embedded in GA 360; however, these components may be separate or external from GA 360.

Memory I/F 364 is preferably an industry standard SDRAM interface, but may also be one of a PCI bus, RAM bus, DDR (double data rate) and EDO RAM (Extended Data Output DRAM) interface used in the art. Memory I/F 364 controls access to a display memory portion in SDRAM 362. In particular, memory interface 364 informs the incoming video data where it is to be stored in SDRAM 362. Additionally, memory I/F 364 selects the decoded data (which are being stored in SDRAM 362) that are going to be displayed on display device 370.

Graphics engine 366 may preferably be a 64-bit DRAM based XVGA controller with hardware accelerated BitBLT (bit block transfer), video playback and video capture to a frame buffer (SDRAM 362 for example). However, graphics engine 366 should not be limited to this specific implementation. In other words, the graphic engine 366 may be implemented with other controller technologies.

TV encoder 368 is preferably an NTSC encoder that encodes, or converts the digital video output from graphics engine 366 into a coded analog signal for display. Regarding the specifications of the NTSC (National Television Standards Committee) encoder 368, the NTSC is responsible for setting television and video standards in the United States. The NTSC standard for television defines a composite video signal with a refresh rate of 60 half-frames (interlaced) per second. Each frame contains 525 lines and can contain 16 million different colors.

In Europe and the rest of the world, the dominant television standards are PAL (Phase Alternating Line) and SECAM (Sequential Color with Memory). Whereas NTSC delivers 525 lines of resolution at 60 half-frames per second, PAL delivers 625 lines at 50 half-frames per second. Many video adapters or encoders that enable computer monitors to be used as television screens support both NTSC and PAL signals. The SECAM standard was introduced in the early 1960's and implemented in France. SECAM uses the same bandwidth as PAL but transmits the color information sequentially. SECAM runs on 625 lines/frame.

Thus, although use of an NTSC encoder for TV encoder 368 is envisioned to encode the processed video for display on display device 370, the present invention is not limited to this standard encoder. PAL and SECAM encoders may also be utilized. Further, developing HDTV encoders may also be viable to encode the processed video for display on a HDTV, for example.

SDRAM 362 is similar in its construction to SDRAM 315. SDRAM 362 provides the extra frame buffers (sufficient memory, preferably at least 2 Mbyte or greater) necessary to temporarily store the decoded data prior to being output for display on display device 370.

As seen in FIG. 35, the decoded video data is input into graphics engine 366, whereby it is subject to graphics processing to prepare the data for system to display transfer. Memory interface 364 instructs SDRAM 362 to output the selected data for playback to graphics engine 366. Thereafter, the data for display can be encoded and converted to analog at TV encoder 368 before being sent to display device 370.

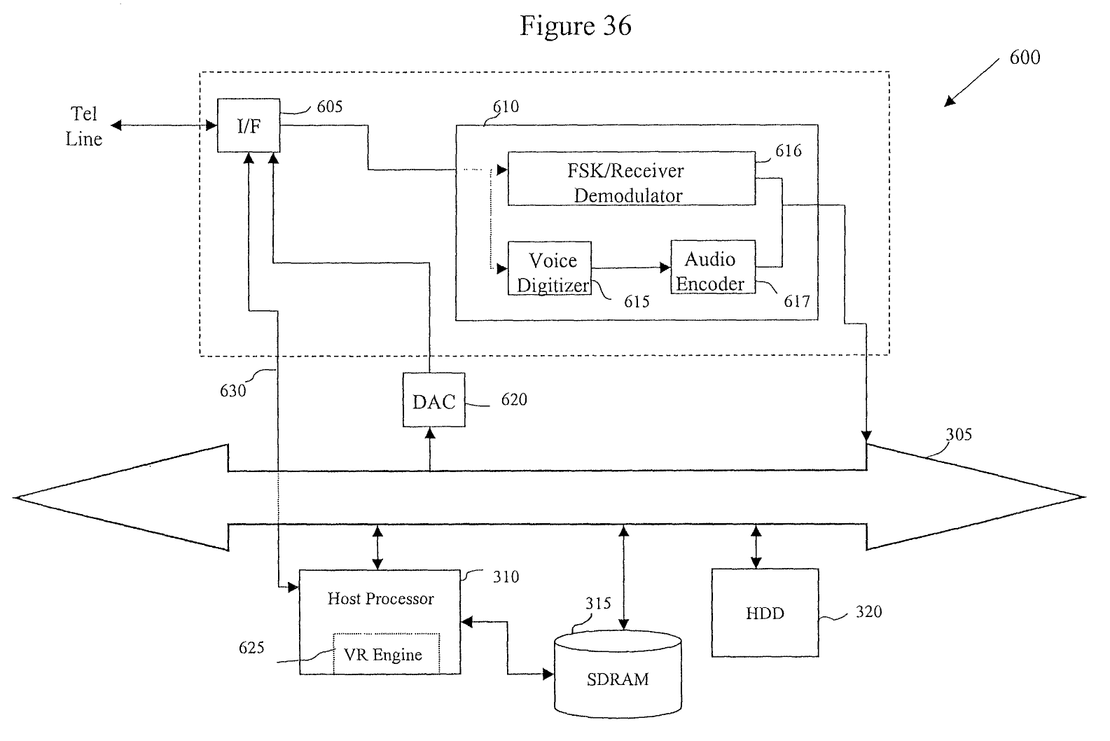

Up to this point, the overall architecture of the STB with DVR has been illustrated and briefly described in connection with the present invention. FIG. 36 illustrates a partial block diagram of FIG. 34 to show the components associated with the DVR TAD 600 portion of the STB equipped with DVR and TAD.

Circuitry of the DVR TAD 600 illustrated in FIG. 36 is physically located within a separate DVR TAD body (not shown) that includes a handset and local function keys thereon that are similar to well known DTADs. Thus, although a detailed description thereof is omitted, an exemplary DTAD body and keyboard may resemble the example illustrated in FIG. 34 of U.S. Pat. No. 5,400,393 to Knuth et al., entitled “Voice Mail Digital Telephone Answering Device”. Additionally, although many of the features of the DVR TAD 600 described in accordance with the invention are illustrated as a user sending commands to a microprocessor via a remote control, commands or functions may of course be initiated locally be manipulation of keys or button of a keyboard on the DVR TAD 600.

Referring now to FIG. 36, DVR TAD 600 includes a high impedance telephone line interface 605 that receives analog voice signals along with the Caller ID signals that are generated by the telephone network or service provider. Additionally, interface 605 is configured to receive DTMF signals in addition to analog voice signals. The Caller ID and analog voice signals are sent from telephone line interface 605 to be received by a TELCO modem 610. TELCO modem 610 includes an FSK/receiver demodulator 616 and a Voice Digitizer 615. FSK/receiver demodulator 616 demodulates the Caller ID signals to provide a digital representation of the received telephone number, and Voice Digitizer 615 converts the received analog voice to a digital voice signal.

The digital voice signal output from Voice Digitizer 615 is then encoded in an audio encoder 617 before being routed to STB 300. Audio encoder 617 may be an MPEG encoder for example, but is not limited to MPEG encoding, as other techniques or encoders known in the art like a WINDOWS media encoder may be used. Alternatively, instead of providing a hard-wired audio encoder 617 in DVR TAD 600, host processor 310 may effect encoding of the input digital voice signal using embedded encoding algorithms or software.

Although the DVR TAD 600 interface between the phone line and STB 300 is described as a TELCO modem 610, the present invention is not limited to such. Alternatively, the interface between STB 300 and an external device (such as a caller, PC, etc.) could be any of DSL, Home LAN, cable modem, satellite or optical interface, and any other known communication interface which would enable communication between STB 300 and an external device. Such an interface could enable the communication of text or sound files to be passed digitally, under control of host processor 310 from HDD 320 through the suitable interface (via a serial port in STB 300 for example) to an external device such as a PC.

The TELCO modem 610 then outputs the collective digital representation of voice and phone number via PCI bus 305 to be processed by host processor 310, then temporarily stored in buffer 315 for ultimate storage in HDD 320. Within host processor 310 is the previously discussed voice recognition engine 625 that converts, under the control of the host processor 310, the digital voice received (and stored in HDD 320) to a text representation that may be displayed after decoding and encoding on a suitable display device 370.

As will be explained further below, there is also a DAC 620 operatively connected between 305 and telephone line interface 605. DAC 620 is a digital to analog converter, and outputs an analog signal to be transmitted to the telephone network or service provider. This signal may be an out going message (OGM) sent to a caller by the DVR TAD 600. Additionally, there is a signal line 630 between telephone line interface 605 and host processor 310 that represents a communication path for detection of OFF-hook and ON-hook signals. These OFF-hook and ON-hook signals are sent to host processor 310 to determine whether or not DVR TAD 600 will be placed in some active state (answering or recording a message) or an idle state. Line 630 also enables the transmission of a digital auto callback dialing signal from the STB 300 to a desired caller, via interface 605 and the telephone line. This auto callback dialing signal may be embodied as DTMF tones.

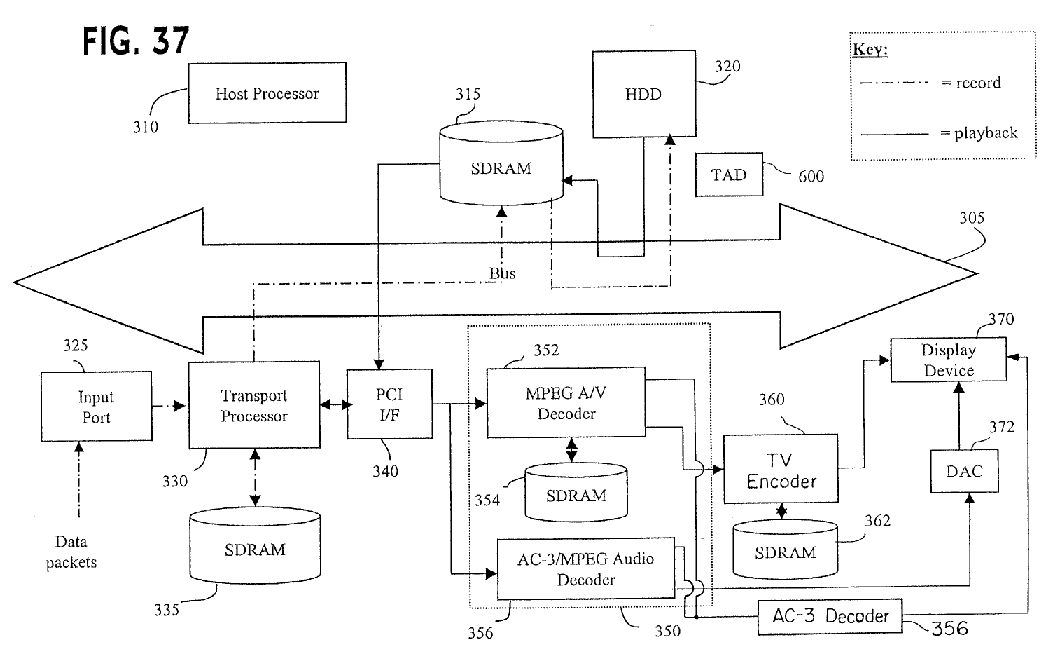

General recording and playback paths of the STB 300 are described in accordance with FIG. 37. FIG. 37 shows the recording and playback data flows among the various components of the STB 300, and is background for the recording and playback paths for DVR TAD 600 operations that are discussed later below. Some of the connections between components, and associated reference numerals from FIG. 34 may have been eliminated in FIG. 37 in order to highlight the data flow that is shown using dashed lines (see Key).

As shown in FIG. 37, A/V data of a selected or desired event, program and/or broadcast is received by input port 325 (typically the data is received in packetized and encrypted form) and fed to the transport processor 330. The transport processor 330 then transfers the received A/V data to SDRAM 315. Digital recording is accomplished by the host processor 310, which transfers the A/V data buffered by SDRAM 315 to the HDD 320. In other words, the SDRAM 315 serves as a buffer that buffers data sent by transport processor 330. This allows the host processor 310 to control the recording onto the HDD 320 when host processor 310 time is available. When a sufficient amount of programming data has been accumulated in the SDRAM 315, the host processor 310 transfers the data from the SDRAM 315 to the HDD 320 for recording therein.

In an alternative record path, A/V data is fed from the input port 325 to the transport processor 330. The transport processor 330 then transfers the received audiovisual data to the PCI I/F 340. The PCI I/F 340 receives audiovisual data from the transport processor 330 via bus 305, and sends this data to host processor 310, more particularly to SDRAM 315.

Digital recording is accomplished similarly, with SDRAM 315 serving as a buffer that temporarily stores data sent by the PCI I/F 340. This allows the host processor 310 to control the recording onto the HDD 320 when processor time is available. When a sufficient amount of A/V data has been accumulated in the SDRAM 315, the host processor 310 transfers the data from the SDRAM 315 to the HDD 320 for recording therein. To record data, the host processor 310 may also inform the PCI I/F 340 of available start addresses in the SDRAM buffer space 315 to which data may be buffered for eventual recording in HDD 320.

The operation of playing back the recorded A/V data that represents a stored event, program, broadcast, etc. in STB 300 is now described. Referring again to FIG. 37, when the viewer turns the STB 300 on, the viewer is given the option to playback any of the previously recorded programs, events, broadcast, phone messages, etc. This may be done, for example, by using a remote control or other suitable user command interface (not shown) to access a menu on display device 370. If the viewer selects a desired event, the corresponding A/V data (which typically may also include system time and conditional access packets) are retrieved from HDD 320.

In particular, when the user selects the playback option, the selected A/V data recorded on HDD 320 is sent via bus 305 to a queue in SDRAM 315. Next, the buffered data is sent from SDRAM 315 via bus 305 PCI I/F 340, which in turn sends the selected A/V data to decoder 350. More specifically, the video portion of the bitstream is sent to MPEG A/V decoder 352, with the audio portion being sent to AC-3/MPEG audio decoder 356.

Within decoder 350, MPEG A/V decoder 352 may be provided with an SDRAM 354 in order to more efficiently decode the MPEG bitstream received from PCI I/F 340. SDRAM 354 is similar to SDRAM 315 discussed above in its construction. SDRAM 354 temporarily holds the encoded video bitstream data, and also provides the three frame buffers required for MPEG decoding, as is known in the art. Thereafter, the decoded A/V data is output to GA 360 for conversion to an analog format, so that it may be displayed on display device 370. From this point on, the playback data looks, for all intents and purposes, identical to the originally recorded event, program, broadcast, etc.

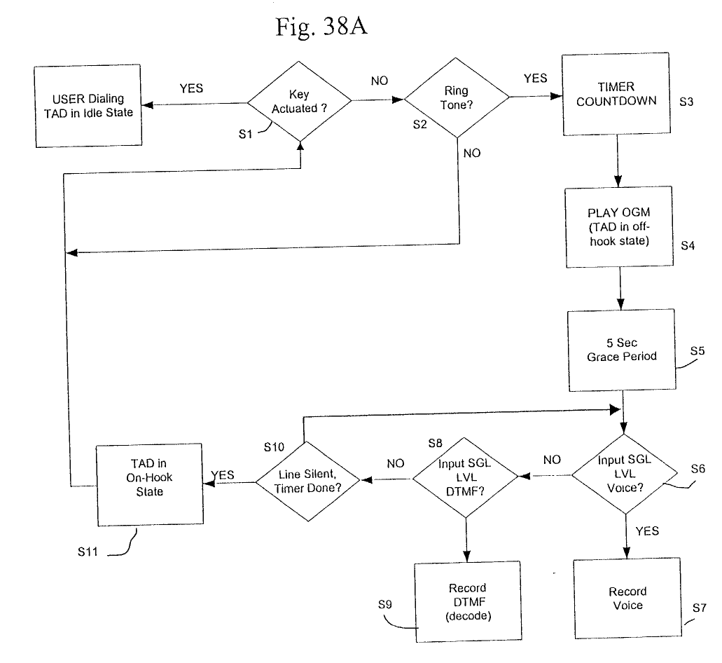

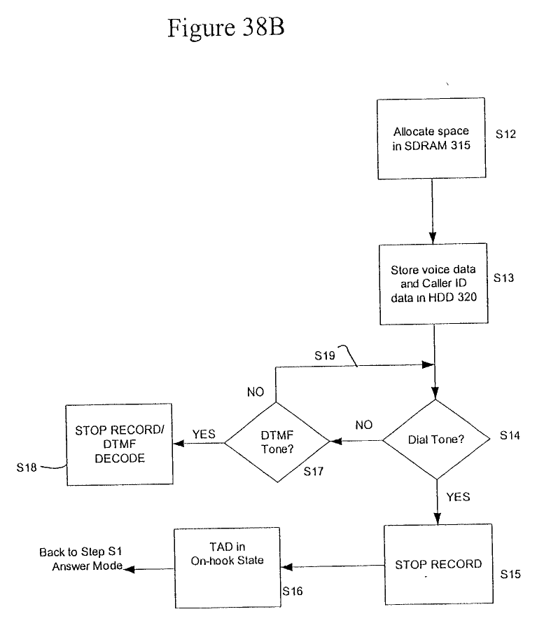

The architecture of the STB 300 and the operations of general recording and playback having been described, exemplary answer and record modes of the DVR TAD 600 are now explained in reference to FIGS. 38A and 38B.

Referring to FIG. 38A, the DVR TAD 600 first determines (Step S1) if the user has pressed a number key on the TAD keyboard (not shown). This is done under the control of the host processor 310 so as to read data at telephone line interface 605. If the user has pressed a number key, this is an indication that a user is calling out and DVR TAD 600 will remain in an idle state. If no key has been pressed, DVR TAD 600 detects if a ring signal is present (Step S2). Since any ring detection is immediately transmitted to host processor 310 via line 630, host processor 310 will initiate a timed countdown (Step S3), in which it reads a predetermined variable out of SDRAM 315 indicating the number of rings to wait before answering. For example, this could be set to answer immediately, at two, four, eight rings, etc. The finite time duration corresponds to the number of rings, after which host processor 310 accesses an outgoing message (OGM) pre-stored in SDRAM 315 to be sent out to the caller (Step S4) via DAC 620 and interface 605. DVR TAD 600 is thus placed in an off-hook state while the OGM is played back to the caller

When the playing of the OGM is completed, host processor 310 preferably waits 5 seconds (Step S5). This 5-second grace period prevents malfunction of the DVR TAD 600 due to silence by the natural pause or hesitation of a caller before or during enunciation of a message. The host processor 310 then determines if voice signals, or DTMF signals are being transmitted. The host processor 310 can distinguish three states during a call—voice signals, DTMF signals, or dial tone/silence—by reading the level and modulation of the signals on the telephone line. The host processor 310 distinguishes between the tones of DTMF signals and the signal level ranges associated with human speech detected on the telephone line. If voice signals are detected (Step S6), the host processor 310 immediately executes a voice record routine (Step S7) already outlined with reference to FIG. 37. If no voice

is present on the line, but DTMF signals are being transmitted (Step S8), the host processor 310 executes a DTMF decode routine (Step S9) that is well known in the art and therefore only generally explained herebelow.

If, however, there is determined a dial tone or silence (Step S10) lasting for 5 seconds, the host processor 310 causes the DVR TAD 600 to go into an on-hook mode (Step S11) which hangs up the phone and terminates the call, otherwise returns to Step S6 again. (Modify FIG. 38A, show No for arrow going back to Step 6.) The DVR TAD 600 now returns to its initial state in the answer mode routine of looping and checking for a user key touch and waiting for a ring signal.

A DTMF routine preferably would be initiated by host processor 310 and decodes the DTMF signals keyed into the telephone by the caller and stores the code in SDRAM 315 and links it to the HDD 320 if a voice message is recorded. This process sets up data memory areas in SDRAM 315 for receiving the DTMF signaling and links the data memory to voice message memory areas in HDD 320 if a voice message has already been recorded. If a voice message has not yet been recorded it allocates an available message number in case a voice message is left later. This allows the system to be flexible and will allow the caller to key in a DTMF I.D. code anytime during the message sequence.

FIG. 38B illustrates an exemplary record mode for DVR TAD 600 in accordance with the invention. Initially, temporary space in SDRAM 315 is allocated (Step S12) for storing the received digitized signals, in order to allow time for the host processor 310 to prepare HDD 320 for storage. This step points to a data memory position for the caller ID signal, and a voice memory position for the message in SDRAM 315. When HDD 320 is ready, it is accessed by host processor 310 in order to store the caller ID and voice data together (Step S13) (i.e., they are linked and associated within HDD 320).

These digital signals are being stored in parallel with a task of determining the line status. This is where host processor 310 first checks for a dial tone via line 630. If it is found (Step S14), recording is stopped (Step S15) and the DVR TAD 600 is placed in an ON-Hook state and returns to the answer mode (Step S16). If no dial tone is found, the line is checked for a DTMF tone and if that is found (Step S17), the aforementioned DTMF routine is performed (Step S18). On the other hand, when a DTMF tone is not detected, a dial tone is re-checked (Step S19), and once the dial tone is present, DVR TAD 600 is placed in an ON-Hook state and returns to the answer mode.

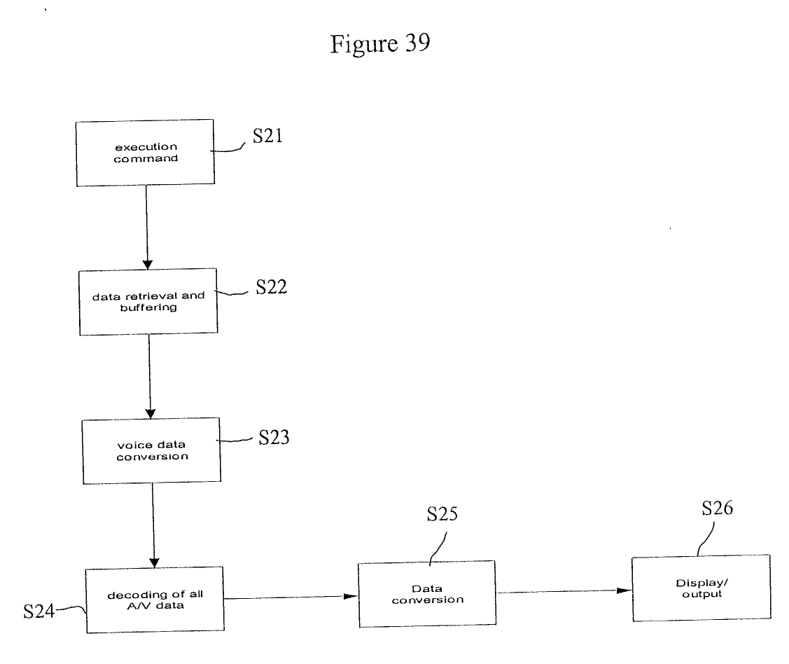

FIG. 39 illustrates a general playback flow diagram for a stored voice message in accordance with an exemplary embodiment of the invention. By utilizing a suitable interface, a user or viewer may elect the option to playback any of the previously recorded telephone messages on a display device 370 operatively attached to STB 300. This may be done, for example, by using a remote control or other suitable user command interface (not shown) to access a menu on a screen of the display device 370. If the viewer selects a desired message for playback on the screen, the corresponding A/V data (hereinafter “DVR TAD data” for clarity, which in an exemplary case could be requested as text only or voice only) is retrieved from HDD 320. In general, DVR TAD data could be digital voice, text and/or Called ID data.

In particular, when the user desires to playback a recorded phone message, he/she sends a command (Step S21) to host processor 310 directing that the corresponding DVR TAD data recorded on HDD 320 be retrieved from HDD 320, via bus 305 to a queue in SDRAM 315 (Step S22). In the event the user desires to read a text representation of the voice message, the digital voice data portion of the DVR TAD data is subject to processing by voice recognition engine 625, which converts the digital audio voice data (Step S23) to text. However, and as will be illustrated hereafter, the voice data will be recognized and converted to text and temporarily stored in SDRAM 315 regardless if the user desired text or a voice reproduction. This is because at least a “header portion” or start of message text representation will be displayed on display device 370, such that the user may at least visually review at least part of the message. This format may be similar to formats in electronic mail systems that can be configured to show a partial message in a sub-window when the user highlights the message sender name in an inbox.

Next, the buffered text data along with the original digital voice data and caller ID data of the message is sent as a DVR TAD data stream from SDRAM 315 via bus 305 to PCI I/F 340, which in turn sends the selected DVR TAD data to decoder 350 (Step S24). More specifically, digital caller ID and text data are sent to GA 360 through MPEG A/V decoder 352, with the audio portion (digital voice) being sent to AC-3/MPEG audio decoder 356. Alternatively, the DVR TAD data can be conveyed to MPEG A/V decoder 352 since decoder 352 is capable of decoding audiovisual data. Thereafter, the text and caller ID data portions of the DVR TAD data stream are displayed on display device 370, and the digital audio data portion of the DVR TAD stream is fed to DAC 372 to convert it to analog sound, for emission from a speaker of display device 370, if desired.

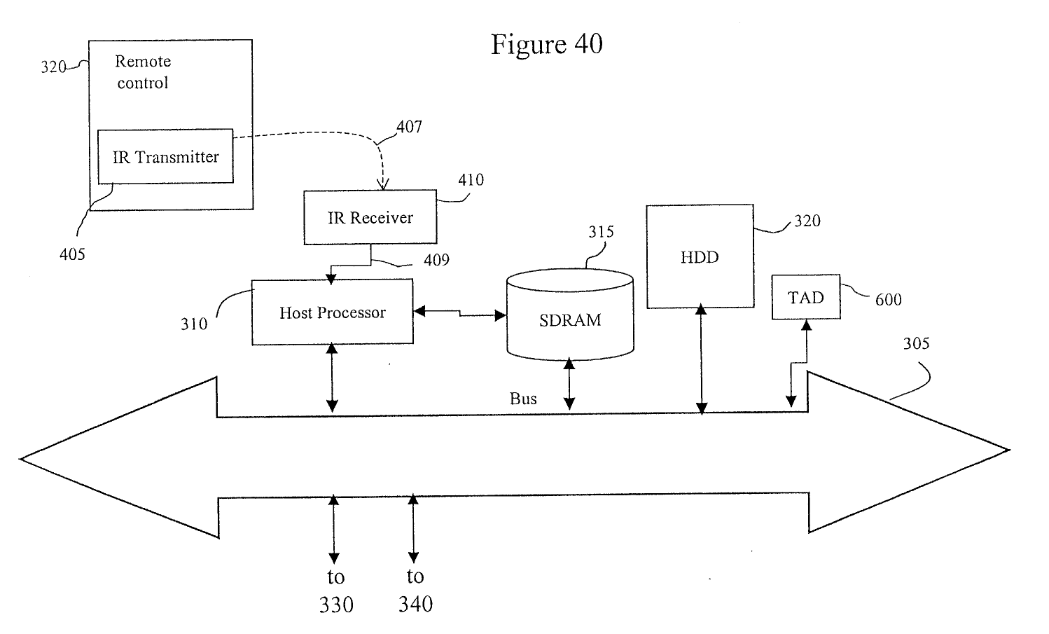

FIG. 40 illustrates a partial block diagram of FIG. 34, so as to show an exemplary communication path between a remote control device 400 (not shown in FIG. 39) and the host processor 310 of STB 300. In FIG. 40, there is illustrated a remote control device 400 which is in communication with the host processor 310 in order to send commands for operating features or functions of the DVR TAD 600 and/or to display menus associated with DVR TAD 600 operation and functionality on display device 370 for example. The remote control device may be a device that is specific to the STB 300 or TAD DVR 600, and/or may be a universal remote control device which controls various individual components connected within a home entertainment system (TV, stereo, tape deck, DVD player, CD player, STB, TAD, etc.)

As is well known in the art, the remote control device 400 may include a remote control transmitter 405 therein for transmitting various key or pushbutton-associated signals (commands) selected by the viewer or user to perform certain DVR TAD functions, to display certain parameters or data associated with the STB 300 and/or DVR TAD 600. These are sent in the form of an infrared (IR) ray signal 407 for example, to the STB 300, and in particular to an IR receiver 410 that may be operatively connected to host processor 310. IR receiver 410 decodes the received infrared ray signal 407, such as by photoelectric conversion for example, and sends a system drive signal 409 (which is preferably a digital signal) to host processor 310. The host processor 310 thus analyzes the composed code information (i.e., the command data generated by the user) corresponding to the received system drive signal 409. This may be a command to display a desired parameter, menu or user-interface feature of the DVR TAD 600, for example.

Although the above communication path and interface to the STB 300 and DVR TAD 600 are explained with regard to using a remote control device, commands and/or processing necessary to display DVR TAD 600 parameters may also be initiated by a user actuating buttons, switches and/or keys that may be provided on, and integral with STB 300 and/or DVR TAD 600. Moreover, these buttons, switches and/or keys may interact with software or package programs within STB 300 (i.e., provided within SDRAM 315, HDD 320 or as part of host processor 310) in order to effect display of a status parameter on a screen of a device. These alternative interfaces provide redundancy for the viewer, as well as alternative means to display parameters, menus or functions of STB 300 and/or DVR TAD 600 on a display device 370.

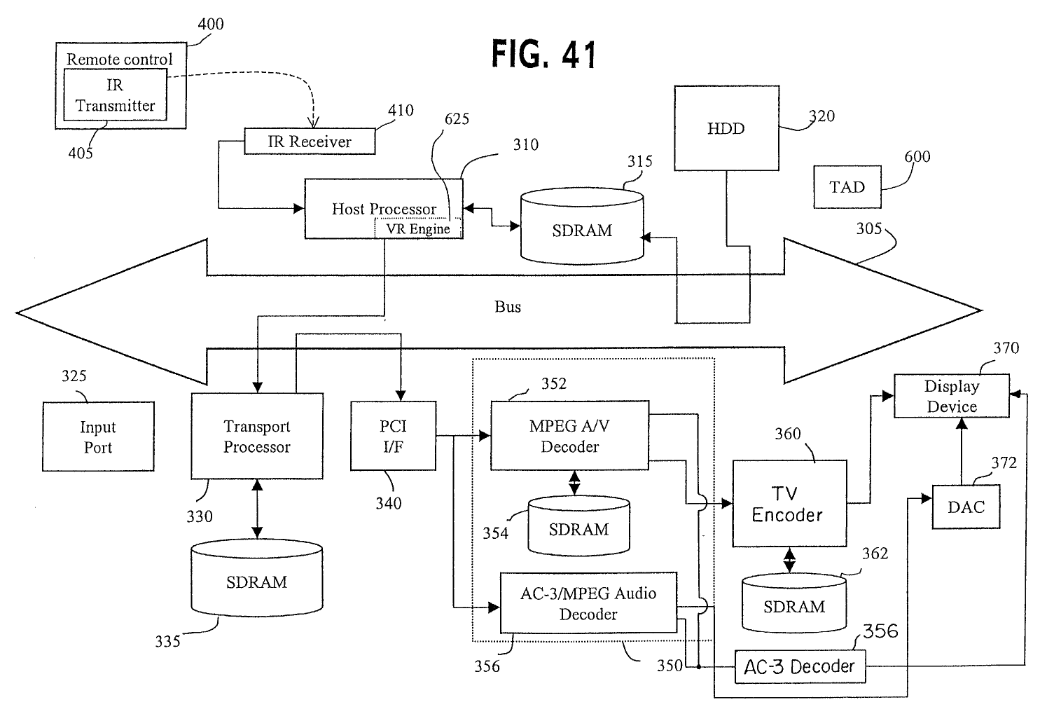

FIG. 41 illustrates the data flow from command signal to display, for a parameter, data or menu associated with DVR TAD 600 in accordance with the present invention. A plurality of parameters or data, such as recently received phone messages, data for specific DVR TAD-related menus, etc., are stored in HDD 320. Additionally, certain ones of these stored parameters may be updated to reflect current status of the DVR TAD 600; for example, TAD off-line, number of messages received today, etc. This may be done, for example, by using designated software programs or predetermined algorithms within host processor 310.

The host processor 310 receives an IR ray signal (i.e., a command) from remote control device 400 that is converted into a digital signal. This signal may be a command directing that a certain parameter, menu or data associated with the DVR TAD 600 be displayed. Thus, host processor 310 retrieves the ordered DVR TAD data (this may be any or all of the digital audio, text or caller ID data, depending on the selected parameter and/or feature) from HDD 320 via SDRAM 315, where it is buffered temporarily after being sent from HDD 320, so that the voice data may be processed by voice recognition engine 625. Host processor 310 sends the selected data (i.e., digitized voice, digital text and caller ID signals) corresponding to the desired parameter, menu of function via bus 305 as a DVR TAD stream to PCI I/F 340, which in turn sends the selected data to decoder 350. From this point, the flow path is identical to that for playback described initially in FIG. 37. The decoded DVR TAD data is output to GA 360 for conversion to an analog format as required, so that the desired parameter may be displayed on display device 370.

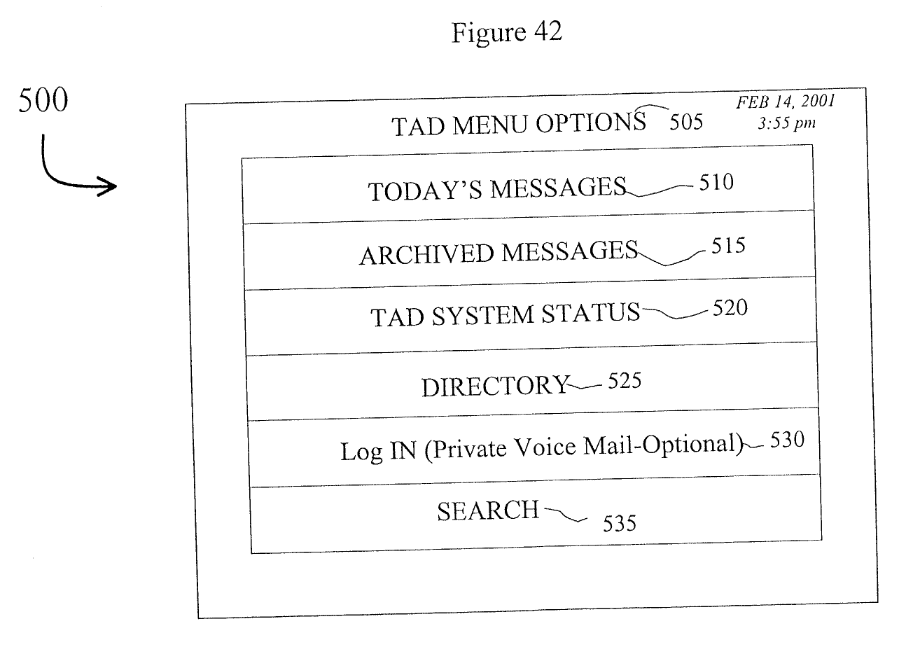

FIG. 42 illustrates an exemplary DVR TAD 600 main menu screen according to the invention. When a user or viewer sends a command to display a TAD main menu, an exemplary menu 500 or status guide such as is depicted in FIG. 41 may be displayed on the screen of a display device 370. In an exemplary embodiment, various status parameters or features may be displayed in stacked cells or rows of the menu 500, each cell being assigned to a particular status parameter.

As shown in FIG. 42, a title line 505 such as “TAD Menu Options” may be provided, along with various DVR TAD 600 parameters or functions such as a “Today's Messages” cell 510, “Archived Messages” cell 515, “TAD System Status” cell 520, “Directory” cell 525, “LOG-IN to access private voice mail” (optional) cell, 530, and a Search cell 535 to quickly access caller information. These features are only exemplary of the many other possible features or parameters of the DVR TAD 600 that a user may display in order to review.

To view the desired parameter, and/or to manipulate or display additional information such as sub menus, specified callers, etc., the viewer simply presses a designated key either on remote control 400, or locally at STB 300 or DVR TAD 600. In the exemplary embodiment this may be a scroll down key, left/right or up/down arrow button, for example, in order to highlight a specific cell. The parameter of the highlighted cell may then be actuated or implemented on the display by pressing an execution key, button, etc. on the remote control 400 or STB 300/DVR TAD 600, such as an “action”, “enter” or “execution” key as is known in the art. The present invention is not limited to these user command interfaces, of course, as any of the other exemplary user command interfaces may be implemented as well (i.e., in the event a PC is connected to STB 300, an input device such as a mouse may serve as the command interface).

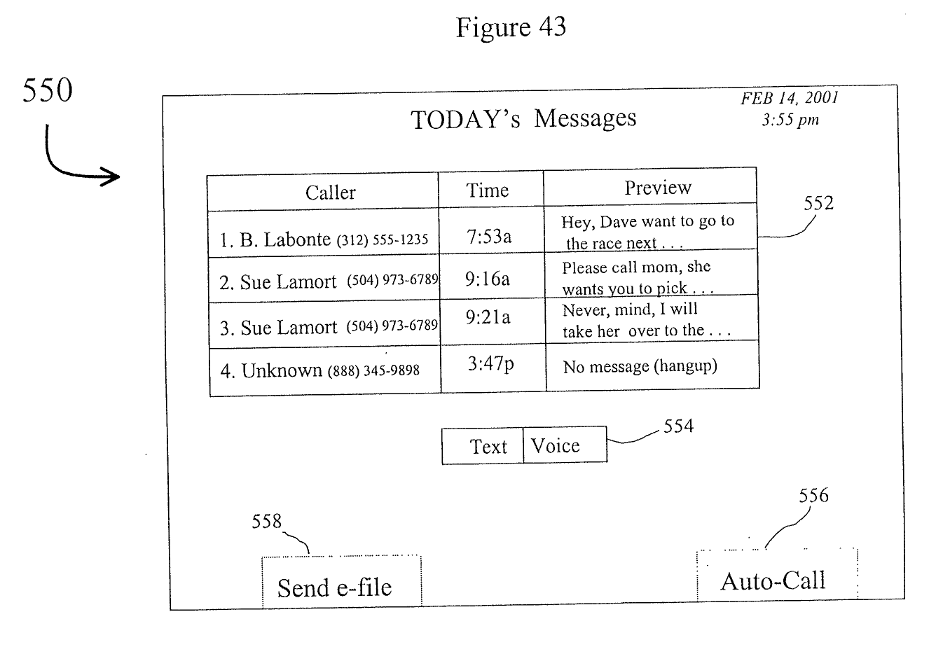

FIG. 43 illustrates a submenu associated with message management, including auto callback and external transmission of messages in accordance with the invention. Should the user select the “Today's Messages” cell 510, a submenu entitled “Today's Messages” may be displayed on the display device 370. Submenu 550 includes a cell or window 552 listing the messages received that day. Each message includes the caller name and phone number, and may be identified by the caller ID information received from the telephone network provider. Alternatively, in the case that the user does not subscribe to a Caller ID service, the caller may be identified from the recorded dial or DTMF tones that are identified by host processor 310 as matching a DTMF tone signature that corresponds to a name stored in a stored caller database in HDD 320.

Additionally, a short “text header”, or starting portion or snippet of the complete text representation is displayed. The header display is set as a default, and will be displayed regardless if the user elects to read the entire text message or simply elects to hear the recorded voice message at display device 370. As shown in FIG. 42, the user may highlight a particular caller using remote control 400. Then the user has a variety of options. The user may select the “Text” or “Voice” icon 554 to initiate the corresponding playback of a telephone message. Alternatively, the user may simply highlight the header text in the preview area of cell 552 in order to read the full text message. In an exemplary case, this may be embodied as a pull down window that displays the entire message, or a completely separate display containing only the text of the message. However, the display format is not limited to the above, as any suitable and known display implementation in the art is applicable.

Further in FIG. 43, a user may desire to automatically call back the caller selected or highlighted on submenu 550. To do so, a user would highlight the desired caller in cell 552 and then initiate the auto-call cell 556. For example, if B. Labonte was highlighted and the auto-call feature was enabled, host processor 310 would access B. Labonte's phone number stored in HDD 320, so as to produce the DTMF tones that are then sent to DVR TAD 600 (via line 630 through interface 605) for dialing out on the telephone line. Optionally, a confirmation block may be displayed upon selecting a desired caller for auto call back. This may be embodied as pop-up window or sub-screen, or any other display implementation known in the art.

Yet still further, a user may desire to send a text or sound file corresponding to the message of a selected caller to an external medium such as e-mail via the internet. To do so, a user would highlight the desired caller in cell 552 and then initiate the send e-file cell 558. As will be further explained below, this initiates a pop-up window or sub-screen interrogating the user to determine whether a text file of the telephone message, sound (voice) file, or both are to be sent, and asking the user to input the address to send the file to. After selecting the desired parameters, the user simply actuates a send icon in order to direct the host processor 310 to send the specified file via an interface over a suitable telecommunications line to the receiving location. This may be embodied as any of a dial-up modem, cable modem, ISDN, Home LAN, DSL, satellite, etc.

Should the user select the “Archived Messages” cell 515, a submenu entitled “Archived Messages” may be displayed on the display device 370. This menu is essentially identical to that illustrated in FIG. 43, with the exception that the user may set a specified archived period by selecting one of several stored defaults (i.e., 1 week, 1 month, 3 months up to 1 year), or by entering a specified time period using remote control 400, for example.

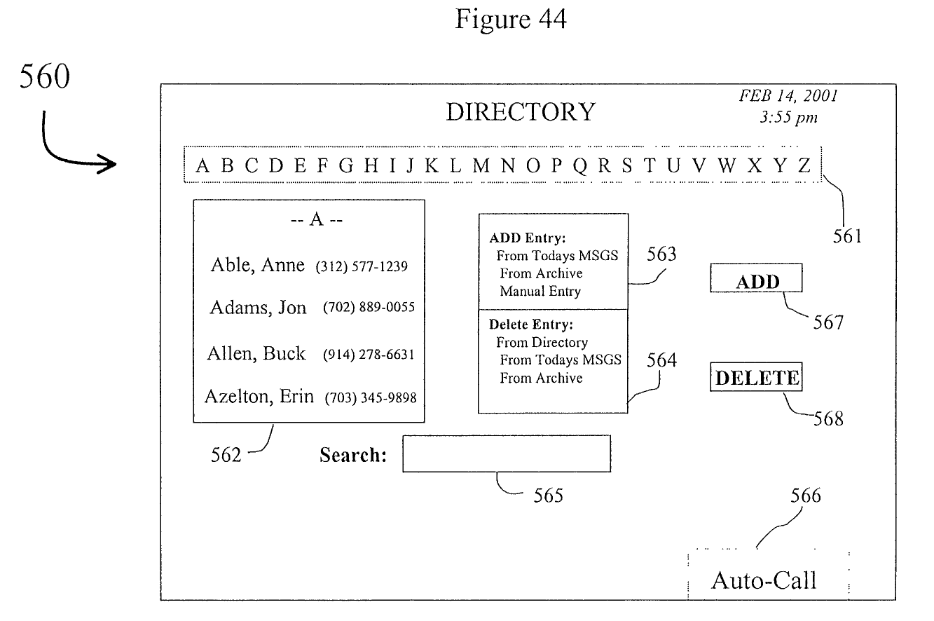

FIG. 44 illustrates a submenu associated with a displayed directory, including entering caller information and accessing stored caller data. Directory submenu 560 includes an alphabetical A-Z list cell 561, address list 562 cell that as a default lists the first few names of A, and can be scrolled down if desired, an add entry cell 563, a delete entry cell 564, search cell 565, and an auto call back cell 566.

A user may access submenu 560 from TAD menu 500 by actuating “Directory” cell 525. Alternatively, actuating Search Cell 535 from TAD menu 500 will highlight the corresponding search cell 565 in submenu 560 to prompt the user the enter the first few letter of the last name of a desired caller. In doing so, address list 562 will simultaneously scroll down to the letters corresponding to the search, similar to what is available in e-mail contact search applications. This provides a quick and easy means of obtaining stored caller identification.

Over time, the user may build up the address list 562 by manually entering caller information. This can be done by actuating the manual option in the add entry cell 563. However, the system of the present invention automatically stores, temporarily in SDRAM 315, incoming caller information that is detected by DVR TAD 600. More preferably, the user will actuate the “From today's messages sub-line or “From Archive” sub-line in add entry cell 563 in order to display a listing of current or archived messages and caller information. Then, the user can simply highlight those names that are desired to be permanently stored in the address list 562, which is embodied as a directory database that is stored on HDD 320, and then actuate an ADD icon 567 displayed on submenu 560, which could also be embodied as a pop-out or pull-down window (not shown) from add entry cell 563. Similarly, the user may periodically review address list cell 562 to delete names from the database, by highlighting the appropriate names using a suitable interface such as remote control 400, mouse, keyboard etc., and then by actuating a delete icon 568 displayed on submenu 560, which could also be embodied as a pop-out or pull-down window (not shown) from delete entry cell 564.

Still further, the present invention envisions the ability to set defaults as to when temporarily stored information residing in SDRAM 315 is to be erased, so as not to overly burden the processing capability of the system. For example, the system could be configured to permanently store (in HDD 320), or erase, caller identification information of the archived messages or most recent (Today's Messages) after a set period of time. Alternatively, and depending on the available storage capacity, caller identification information of all received messages could be permanently stored and organized in HDD 320 by setting a particular default. Such defaults could be set by the user actuating the TAD System Status cell 520, which would display a corresponding sub cell (not shown) of specified system parameters and defaults to be reviewed, set and/or adjusted by the user regarding the management of received message traffic.

A user may also desire to automatically call back a caller selected or highlighted on submenu 560. To do so, a user would highlight the desired caller in address list cell 562 and then initiate the auto-call cell 566. As explained in FIG. 43 host processor 310 would access the phone number of the selected name from HDD 320, so as to produce the DTMF tones that are then sent to the DVR TAD 600 for dialing out on the telephone line. As noted also above, a confirmation block may be displayed upon selecting a desired caller for auto call back. This may be embodied as pop-up window or sub-screen, or any other display implementation known in the art.

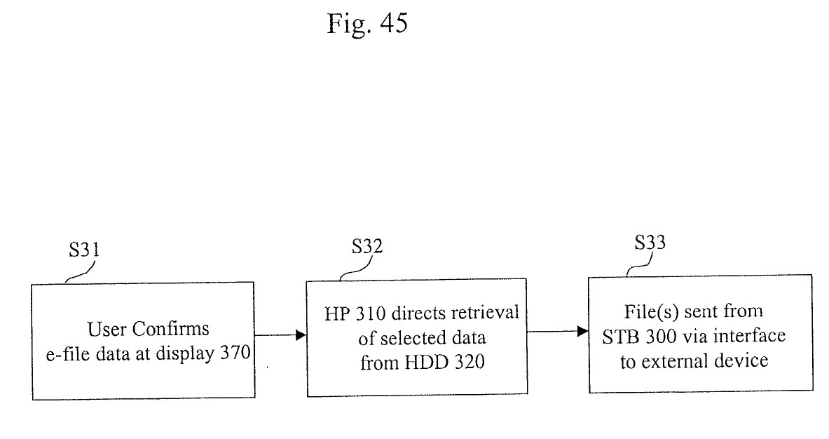

FIG. 45 illustrates how caller information in text and/or sound file format is sent to a remote destination in accordance with the “send e-file” cell 558 of FIG. 43. As noted above, the interface between STB 300 and an external device (such as a caller, PC, etc.) could be any of a TELCO modem DSL, Home LAN, cable modem, satellite or optical interface, and any other known communication interface which would enable communication between STB 300 and an external device. Such interfaces enable the communication of text or sound files to be passed digitally, under control of host processor 310 from HDD 320 through the suitable interface (via a serial port in STB 300 for example) to an external device such as a PC.

For example in FIG. 45, once the user actuates the send e-file cell 558 of FIG. 43, the user may get a confirmation message in pop-up graphical form or on a separate screen of display device 370 to verify (Step S31) that the desired sound and/or text file to be sent to the external device (a PC of another user or the user's PC at work in this exemplary embodiment). Once confirmed, the host processor 310 directs the retrieval (Step S32) of the selected file(s) from HDD 320, for transmission (Step S33) from a serial port of the STB 300 via a suitable interface to the desired location. Preferably, the user could receive a visual prompt on the screen of display device 370 indicating that the file has been successfully sent, or noting errors in transmission.

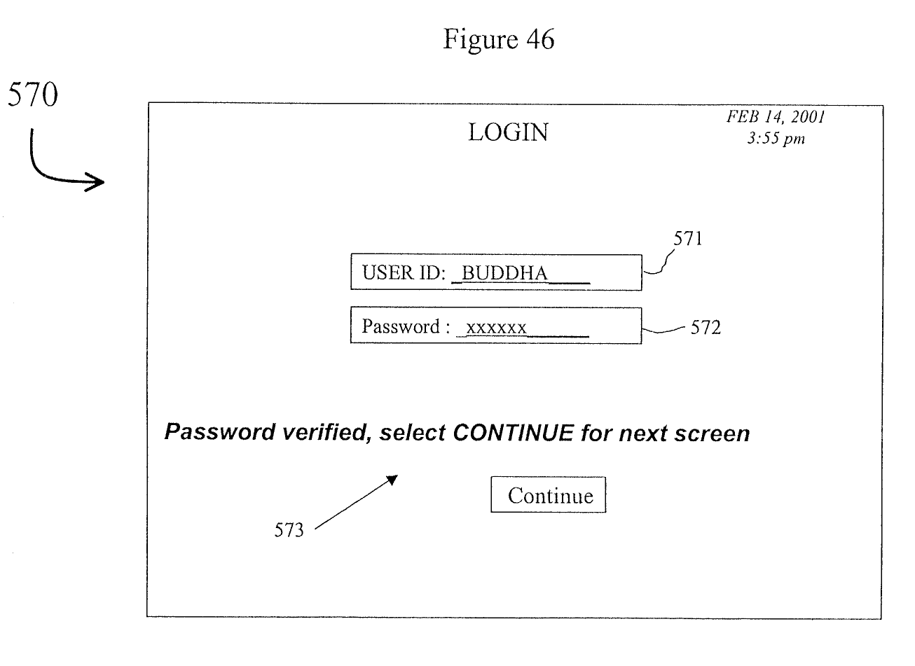

FIG. 46 illustrates a submenu of an exemplary private box arrangement requiring password entry. This feature envisions the case where the DVR TAD 600 has multiple users maintaining their own separate voice mails or private databases of caller information on HDD 320. Preferably, the “LOG-IN to access private voice mail” cell, 530 in TAD menu 500 of FIG. 42 may be optionally set to require a secret code or password to be entered by a user before he/she can access their messages and personal directory.

A user accesses a pass code or password verification screen 570, entitled “LOG IN” for example, from TAD menu 500 by actuating “LOG-IN to access private voice mail” cell, 530. As shown in FIG. 46, the user is prompted for their ID at cell 571 (a last name for example) and a password (cell 572). Once entered, a suitable confirmation or rejection message 573 may be displayed or scrolled beneath the (as shown in FIG. 46, “Password verified, select CONTINUE for next screen” is just one example, this could also be a separate screen display), with the display immediately thereafter shifting back to any of TAD menu 500, Today's Messages submenu 560, or another submenu.

The system default could be set to display the TAD menu 500 again after verification; or alternatively the user can select a desired menu or submenu for the default display after password verification by accessing submenus corresponding to the TAD System Status cell 530 in order to set the desired configuration. Since methods of implementing password protection for voice mail databases and personal messaging are well known in the art, any suitable password protection algorithm or software configuration is acceptable and can be integrated within host processor 310 or accessed from SDRAM 315 by host processor 310.

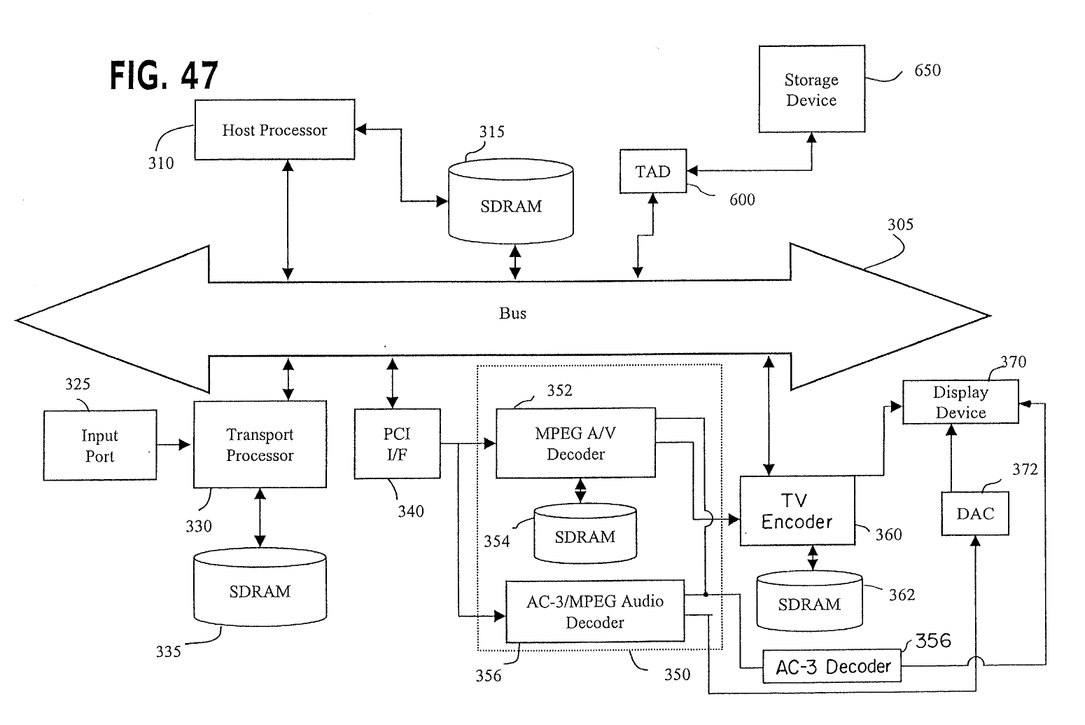

FIG. 47 illustrates an alternate embodiment of a DVR TAD connected to an external mass storage device and the host processor of the STB equipped with DVR in accordance with the invention. The structure and operation of this figure is substantially similar to that of FIG. 34 with the exception that the DVR TAD 600 has its own dedicated mass storage device 650 that is thus external to the STB 300. Similar to FIG. 34, host processor 310 remains the center of operations, but directs all telephone line/network related data received by the TAD 600 to the external storage device 650.

External storage device 650 may be any of known magnetic and/or optical storage devices, (i.e., embodied as RAM, a recordable CD, a flash card, memory stick, etc.). In an exemplary configuration, external storage device 650 may have a capacity of at least several Gbytes, where preferably about at least one (1) Gbyte is available for various DVR TAD 600-dedicated applications. Such a configuration may provide even more storage for the DVR TAD 600 while not burdening the processing capability of STB 300, so that the STB 300 may maximize is storage capacity for its primary purpose of recording and manipulating live programming.

Therefore, the system and method of the present invention provides the ability to maintain a digital telephone answering device on a STB-equipped with DVR utilizing the audio and video features of the STB-equipped with DVR and associated display device(s) connected thereto. The DVR TAD 600 utilizes the same telephone line as the STB-equipped with DVR, and may use memories that are integrated within the STB with DVR architecture, and/or an external mass storage device or memory.

Moreover, the present invention enables a viewer to be provided with a DVR TAD that has enhanced functionality as compared to conventional DTADs, since it utilizes existing hardware and software architecture of a STB equipped with DVR to which it is operatively connected. The DVR TAD 600 is capable of storing an enormous amount of telephone messages as compared to current DTADs. Further, various menu screens associated with DVR TAD 600 features, data or parameters may be displayed and manipulated by the user operating a simple graphical user interface such as a remote control, providing even greater flexibility

The invention being thus described, it will be obvious that the same may be varied in many ways. For example, the functional blocks in FIGS. 34-41 and 14-16 may be implemented in hardware and/or software. The hardware/software implementations may include a combination of processor(s) and article(s) of manufacture. The article(s) of manufacture may further include storage media and executable computer program(s). The executable computer program(s) may include the instructions to perform the described operations. The computer executable program(s) may also be provided as part of externally supplied propagated signal(s).

Additionally, the inventive system may be embodied in a variety of ways; a STB 300 is just one example. Other examples include a personal computer (PC), TV or hardware card that is added to an existing apparatus such as a conventional STB, PC or TV. Still further, the inventive functionality may be downloaded or otherwise programmed into a STB, PC or TV. Moreover, the present invention is not limited to receiving only voice messages, as pager numbers and/or e-mail messages may be received by the DVR TAD 600 via suitable interfaces.

Alternatively in FIGS. 34 and 46, and instead of encoding the digitized audio message via encoder 617 at DVR TAD 600, the analog incoming message may be digitized into Pulse Coded Modulation (PCM) data without further encoding in DVR TAD 600. In this scenario, digital voice data need not go through the AC-3/MPEG Audio decoder 356. Instead, the PCM data may be directly routed from DVR TAD 600 to DAC 372 for analog conversion prior to display at display device 370.

Further, although the DVR TAD of invention has been described as processing analog voice and/or DTMF signals, it is easily recognized and within the purview of this invention that the system may process pulse signals or pulse tones as well. Such variations are not to be regarded as departure from the spirit and scope of the invention, and all such modifications as would be obvious to one skilled in the art are intended to be included within the scope of the following claims.

It is noted that although the present invention describes several embodiments of the DVR system and method if the present invention, the various features described above may be used in any combination including those not specifically described above. Such combinations would evident to one ordinary skill in the art upon reading the above specifications and corresponding FIGS. 1-47.

What is claimed is:

1. A digital video recorder, comprising:
at least one tuner for receiving available content;
a memory for storing a plurality of selectable status parameters indicating functionality of said digital video recorder;
a telephone answering device for receiving voice signals and caller ID signals representing a telephone message from a caller and converting the voice signals and caller ID signals into digital signals;
at least one processor for performing at least one of a plurality of operations on the available content received from said at least one tuner, for
directing storage of the digital signals to a storage device and controlling playback of the stored digital signals of the telephone message to be output at a display device operatively connected to the digital video recorder, and controlling a display of said plurality of status parameters based on received commands to access said memory, so as display at least a selected one of the plurality of status parameters.

2. The digital video recorder of claim 1, wherein said at least one tuner includes one tuner.

3. The digital video recorder of claim 1, wherein said at least one tuner includes multiple tuners.

4. The digital video recorder of claim 1, wherein said at least one processor includes one processor.

5. The digital video recorder of claim 1, wherein said at least one processor includes multiple processors, at least one for realtime functions and at least one for non-realtime functions.

6. The digital video recorder of claim 1, wherein said at least one processor permits selection of at least one recorded event from the available content, based on actor, actress, director, program title, key word, key phrase, tag information, synopsis, release date, critical review, related program, sequel, thumbnail, preview, or snippet.

7. The digital video recorder of claim 1, wherein said at least one processor displays a status of a program from the available content the user is watching.

8. The digital video recorder of claim 1, wherein said at least one processor clears paused programming from the available content or converts paused programming to recorded programming during a channel change.

9. The digital video recorder of claim 1, wherein said at least one processor allows a user to record an entire program from the available content after viewing the program for a period of time.

10. The digital video recorder of claim 1, wherein said at least one processor permits a user to capture a snippet of digital audio/video from the available content.

11. The digital video recorder of claim 1, wherein said at least one processor permits a user to rewind recording in an increment for playback of a portion of the available content.

12. The digital video recorder of claim 1, wherein said at least one processor enables a user to jump back from a live broadcast to a last paused video segment.

13. The digital video recorder of claim 1, wherein a user manipulates designated keys or buttons of a remote control device, each designated key or button corresponding to each of said selectable plurality of status parameters, and wherein the manipulated key or button causes the correspondingly selected status parameter to be displayed on a display device operatively connected to the digital video recorder.

14. The digital video recorder of claim 1, wherein one of said plurality of selectable status parameters is a live/recorded status feature that displays whether a program being viewed is either live or recorded.

15. The digital video recorder of claim 1, wherein one of said plurality of selectable status parameters is a disk gas gage feature indicating how much of a mass storage device operatively connected to the digital video recorder is consumed by recorded material.

16. The digital video recorder of claim 1, wherein one of said plurality of selectable status parameters is a notification indicating the approximate minutes of recording time still available while recording is in progress.

17. The digital video recorder of claim 1, wherein one of said plurality of selectable status parameters is a notification indicating the program length of a desired program to record and the approximate minutes of recording time still available while for recording.

18. The digital video recorder of claim 1, wherein one of said plurality of selectable status parameters is an attributes list which directs the user to other status parameters for display and manipulation, said other status parameters including at least one of a date a program is recorded, a latest date that a stored program has been accessed, size of a recorded or live program, length of a live or recorded program, protect feature to prevent erasure of a recorded program, save options designating how much of a program is to be recorded and/or how long of a time a program is to be stored before being erased, and implementation of a hidden file feature to prevent titles of certain programs from being displayed on a program guide list.

19. The digital video recorder of claim 1, wherein the received telephone message is displayed as a text message on a display device.

20. The digital video recorder of claim 1, wherein said at least one processor controls display of a telephone answering device main menu for selection of at least one of a plurality of parameters of the telephone answering device based on reception of a command to display the telephone answering device main menu by a user.
